(19) United States
(12) Patent Application Publication
(10) Pub. No.: US 2025/0245880 A1
(43) Pub. Date: Jul. 31, 2025

(54) Devices, Methods, and Graphical User Interfaces for Interacting with Audio Output Device Cases

(71) Applicant: Apple Inc., Cupertino, CA (US)

(72) Inventors: Darius A. Satongar, Staffordshire (GB); Jonathan A. Topf, London (GB); Dana F. Segler, JR., Gilroy, CA (US); Geng Luo, Santa Clara, CA (US); Anne-Marie Heck, San Francisco, CA (US)

(21) Appl. No.: 19/019,088

(22) Filed: Jan. 13, 2025

Related U.S. Application Data
(60) Provisional application No. 63/621,545, filed on Jan. 16, 2024.
(60) Provisional application No. 63/662,547, filed on Jun. 21, 2024.

(51) Int. Cl. G06T 11/00; G06F 3/01; G06T 11/60; H04N 23/63

(52) U.S. Cl. CPC G06T 11/001; G06F 3/016; G06T 11/60; H04N 23/632

(57) ABSTRACT

An audio output device case includes a display device. While the display device is disabled, the display device and an exterior of the audio output device case meet similarity criteria. The audio output device case detects an occurrence of a first event. In response to detecting the occurrence of the first event and in accordance with a determination that the display device is disabled, the display device is enabled. A dynamic visual element corresponding to the first event is displayed via a first portion of the display device. The dynamic visual element changes over time. While the display device is enabled, a second portion of the display device, distinct from the first portion of the display device, and the exterior of the audio output device case meet the similarity criteria.

### RELATED APPLICATIONS

This application is claims priority to U.S. Provisional Patent Application No. 63/621,545, filed Jan. 16, 2024, and U.S. Provisional Patent Application No. 63/662,547, filed Jun. 21, 2024, each of which is hereby incorporated by reference in its entirety.

### TECHNICAL FIELD

This relates generally to electronic accessories such as wearable audio output devices, audio output device cases, and accessory charging cases, including but not limited to audio output devices cases with displays and touch-sensitive surfaces that are visually indistinguishable from a casing of the audio output device case and to audio routing using audio output device cases.

### BACKGROUND

Electronic accessories, including wearable audio output devices such as headphones, earbuds, and earphones, as well as charging cases, watches, and styluses are widely used to receive inputs from and provide outputs to a user. But conventional methods of controlling and interacting with such devices are cumbersome, inefficient, and limited. For example, accessory cases for electronic accessories (e.g., audio output device cases) have typically been configured only to charge and/or store the electronic accessories. Accessory cases traditionally do not include means for communicatively coupling the corresponding electronic accessories with audio sources or other electronic accessories. In some cases, electronic accessory cases include display screens. However, using the display screens traditionally requires lighting the entire display screen in order to display a single dynamic visual element, thereby wasting energy. This latter consideration is particularly important in battery-operated devices.

The use of touch-sensitive surfaces as input devices for computers and other electronic computing devices has increased significantly in recent years. Example touch-sensitive surfaces include touchpads and touch-screen displays. Such surfaces are widely used to manipulate user interfaces and objects therein on a display. Example manipulations include adjusting the position and/or size of one or more user interface objects or activating buttons or opening files/applications represented by user interface objects, as well as associating metadata with one or more user interface objects or otherwise manipulating user interfaces.

In some cases, limited control over audio outputs is given to inputs provided at the audio output device cases; for example, an input may be limited to having control over a single predefined feature, such as toggling power or a feature on or off. In some cases, limited control over audio outputs interferes with a user's ability to control the volume of audio content being played back by the wearable audio output devices and/or control the amount of conversational sound that the user is able to hear from the surrounding physical environment while wearing the wearable audio output devices.

In addition, conventional methods for performing these manipulations are cumbersome and inefficient. For example, requiring use of a companion device or navigation of nested menus to perform a desired operation. Such methods take longer and require more user interaction than necessary to operate the electronic accessories, thereby wasting energy. This latter consideration is particularly important in battery-operated devices.

### SUMMARY

Accordingly, there is a need for electronic accessories (e.g., wearable audio output devices and charging cases) and associated electronic devices with improved methods and interfaces for controlling and interacting with, such as adjusting audio routing, selecting between different audio sources, adjusting relative output volume levels, and providing feedback to aid a user in operating such devices. Such methods and interfaces optionally complement or replace conventional methods for controlling operation of electronic accessories. Such methods and interfaces reduce the number, extent, and/or nature of the inputs from a user and produce a more efficient human-machine interface. For battery-operated systems and devices, such methods and interfaces conserve power and increase the time between battery charges.

The above deficiencies and other problems associated with user interfaces for electronic devices and accessories are reduced or eliminated by the disclosed computer systems and electronic accessories. In some embodiments, the computer system includes a desktop computer. In some embodiments, the computer system is portable (e.g., a notebook computer, tablet computer, or handheld device). In some embodiments, the computer system includes a personal electronic device (e.g., a wearable electronic device, such as a watch). In some embodiments, the computer system includes (and/or is in communication with) the wearable audio output devices (e.g., in-ear earphones, earbuds, over-ear headphones, etc.). In some embodiments, the computer system has (and/or is in communication with) a touch-sensitive surface (also known as a “touchpad”). In some embodiments, the computer system has (and/or is in communication with) a display device, which in some embodiments is a touch-sensitive display (also known as a “touch screen” or “touch-screen display”). In some embodiments, the computer system has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, spreadsheet making, game playing, telephoning, video conferencing, e-mailing, instant messaging, workout support, digital photographing, digital videoing, web browsing, audio output device pairing and calibration, digital music/audio playing, note taking, and/or digital video playing. Executable instructions for performing these functions are, optionally, included in a non-transitory computer readable storage medium or other computer program product configured for execution by one or more processors.

In accordance with some embodiments, a method is performed at an audio output device case that includes a wired connection port. The method includes, while in wireless communication with one or more wearable audio output devices, receiving an audio signal from an audio source via the wired connection port. The method also includes transmitting audio data corresponding to the audio signal from the audio source to the one or more wearable audio output devices for playback to a user.

In accordance with some embodiments, a method is performed at a first audio output device case that is in communication with a first set of one or more audio output devices. The method includes detecting a physical interaction that involves the first audio output device case and a second audio output device case for a second set of one or more audio output devices. The method further includes, in response to detecting the physical interaction, in accordance with a determination that the physical interaction is a first type of physical interaction, communicatively coupling the first set of one or more audio output devices with the second set of one or more audio output devices for transmitting and receiving first audio signals between the first set of one or more audio output devices and the second set of one or more audio output devices.

In accordance with some embodiments, a method is performed at an audio output device case that includes a display device. The method includes detecting an occurrence of a first event and, in response to detecting the occurrence of the first event, in accordance with a determination that the display device is disabled, causing the display device to be enabled, wherein while the display device is disabled, the display device and an exterior of the audio output device case meet similarity criteria. The method also includes, in response to detecting the occurrence of the first event, displaying, via a first portion of the display device, a dynamic visual element corresponding to the first event. The dynamic visual element changes over time, and, while the display device is enabled, a second portion of the display device, distinct from the first portion of the display device, and the exterior of the audio output device case meet the similarity criteria.

In accordance with some embodiments, a method is performed at an audio output device case that is in communication with one or more audio output devices. The method includes, while a first audio source is active for the one or more audio output devices at a first volume level and a second audio source is active for the one or more audio output devices at a second volume level, detecting a first input at the audio output device case. The method further includes, in response to detecting the first input and in accordance with the first input being a first type of input, adjusting audio output for the one or more audio output devices by adjusting a volume of the first audio source relative to a volume of the second audio source.

In accordance with some embodiments, an electronic device (e.g., a multifunction device, an electronic accessory, or electronic accessory case (e.g., an audio output device case)) includes one or more processors, and memory storing one or more programs; the one or more programs are configured to be executed by the one or more processors and the one or more programs include instructions for performing or causing performance of the operations of any of the methods described herein. In accordance with some embodiments, a computer readable storage medium has stored therein instructions that, when executed by an electronic device cause the device to perform or cause performance of the operations of any of the methods described herein. In accordance with some embodiments, a graphical user interface on an electronic device with a display, a touch-sensitive surface, a memory, and one or more processors to execute one or more programs stored in the memory includes one or more of the elements displayed in any of the methods described herein, which are updated in response to inputs, as described in any of the methods described herein. In accordance with some embodiments, an electronic device includes means for performing or causing performance of the operations of any of the methods described herein. In accordance with some embodiments, an information processing apparatus, for use in an electronic device includes means for performing or causing performance of the operations of any of the methods described herein.

Thus, electronic devices that include or are in communication with one or more display devices, one or more input devices, one or more audio output devices, and/or one or more electronic accessories are provided with improved methods and interfaces for controlling operation of wearable audio output devices, thereby increasing the effectiveness, efficiency, and user satisfaction with such devices. Such methods and interfaces may complement or replace conventional methods for controlling operation of wearable audio output devices.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

Figure (“FIG.”) 1A is a block diagram illustrating a portable multifunction device with a touch-sensitive display in accordance with some embodiments.

FIG. 1B is a block diagram illustrating example components for event handling in accordance with some embodiments.

FIG. 2 illustrates a portable multifunction device having a touch screen in accordance with some embodiments.

FIG. 3A is a block diagram of an example multifunction device with a display and a touch-sensitive surface in accordance with some embodiments.

FIGS. 3B-3G illustrate the use of Application Programming Interfaces (APIs) to perform operations.

FIG. 3H illustrates physical features of an example audio output device case in accordance with some embodiments.

FIG. 3I is a block diagram of an example audio output device case in accordance with some embodiments.

FIG. 3J illustrates example audio control by a wearable audio output device in accordance with some embodiments.

FIGS. 3K and 3L illustrate an example display for an audio output device case in accordance with some embodiments.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 5A-5T illustrate example user interfaces and user interactions involving audio output devices and audio output device cases in accordance with some embodiments.

FIGS. 6A-6R illustrate example user interfaces and user interactions for communicatively coupling audio output devices in accordance with some embodiments.

FIGS. 7A-7F illustrate example user interfaces and user interactions with an audio output device case in accordance with some embodiments.

FIGS. 8A-8D illustrate example user interfaces and user interactions with a camera and an audio output device case in accordance with some embodiments.

FIGS. 9A-9O illustrate example user interfaces and user interactions with an audio output device case in accordance with some embodiments.

FIGS. 10A-10B are flow diagrams of a process of transmitting audio data in accordance with some embodiments.

FIGS. 11A-11C are flow diagrams of a process of communicatively coupling sets of audio output devices in accordance with some embodiments.

FIGS. 12A-12C are flow diagrams of a process of displaying dynamic visual elements at an audio output device case in accordance with some embodiments.

FIGS. 13A-13C are flow diagrams of a process of adjusting relative volume levels at an audio output device case in accordance with some embodiments.

### DESCRIPTION OF EMBODIMENTS

As also noted above, electronic accessory cases (such as audio output device cases) are commonly passive devices used to store and/or charge electronic accessories. Electronic accessory cases do not traditionally include means for connecting the electronic accessories to different audio sources and/or providing audio routing features. Additionally, electronic accessory cases do not traditionally include means for adjusting relative output volume levels at the electronic accessories for different audio sources. While some electronic accessory cases include output mechanisms (e.g., a speaker or display), electronic accessory cases traditionally do not include means of displaying dynamic visual elements via a display that is indistinguishable from a casing of the electronic accessory case. The methods, systems, and user interfaces described herein improve the functionality of electronic accessory cases and audio output devices. For example, embodiments disclosed herein describe improved ways of interacting with the functionality of electronic accessories and providing status information and/or feedback to a user at the electronic accessory case.

The processes described below enhance the operability of the devices and make the user-device interfaces more efficient (e.g., by helping the user to provide proper inputs and reducing user mistakes when operating/interacting with the device) through various techniques, including by providing improved visual, audio, and/or tactile feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

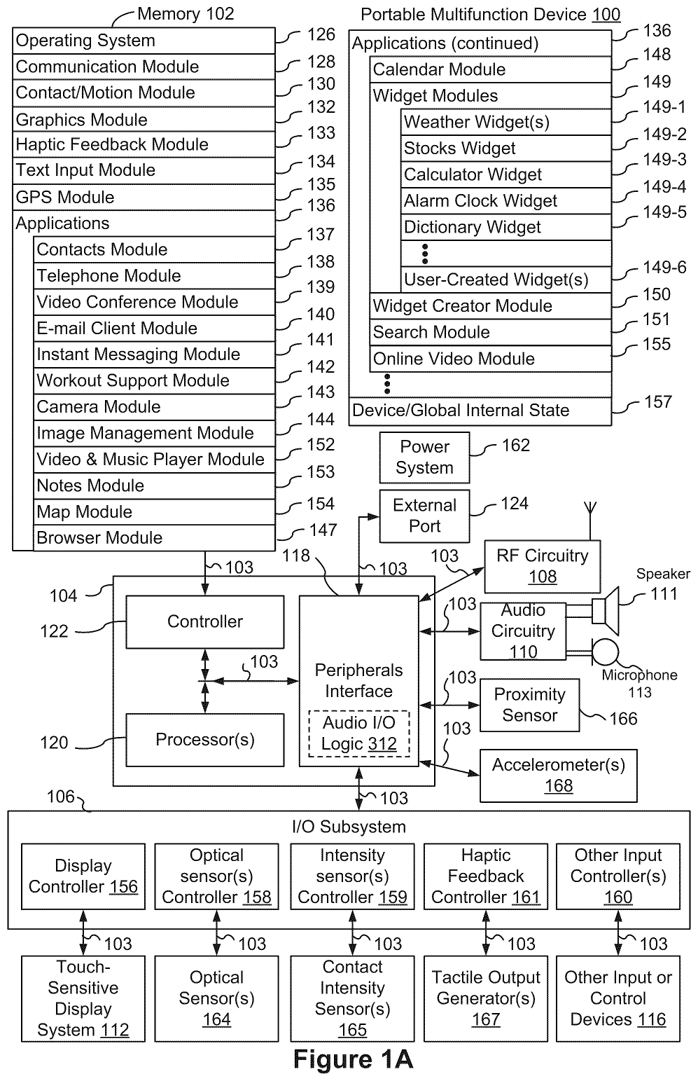

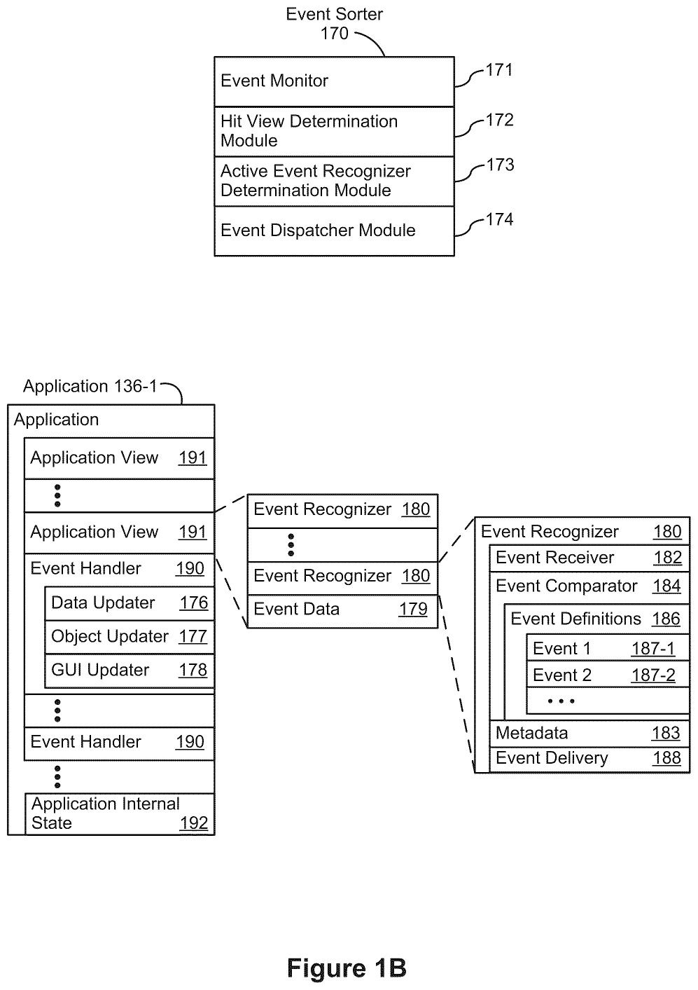

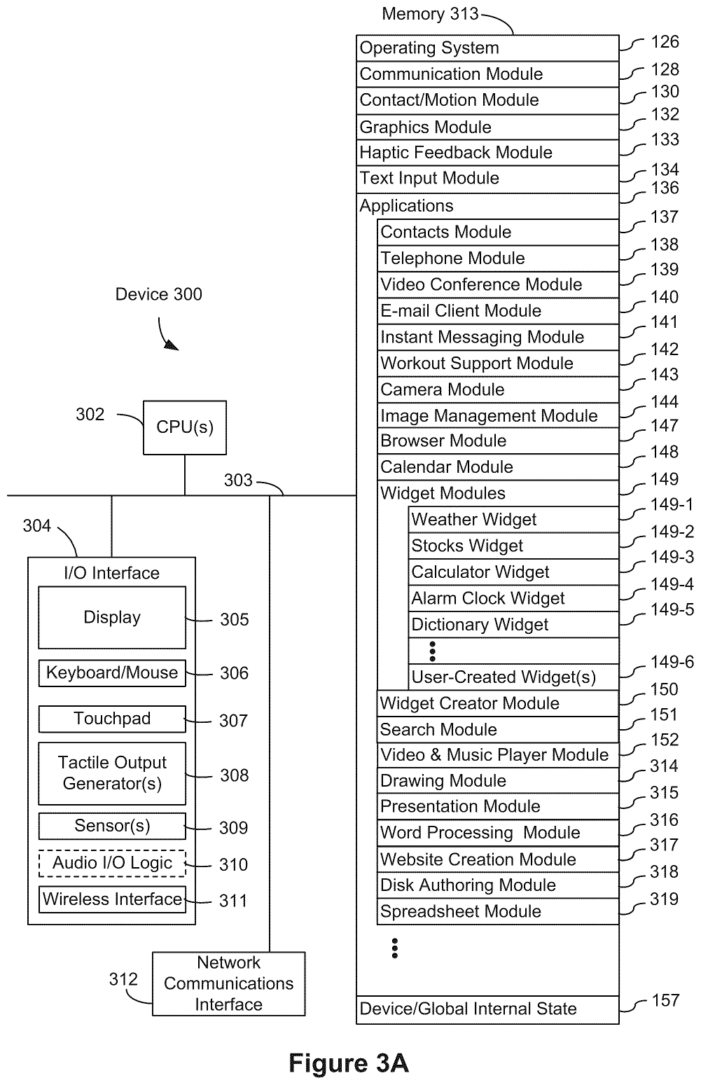

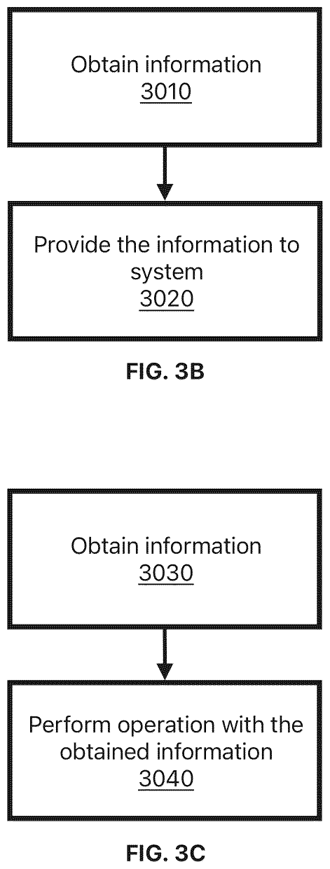

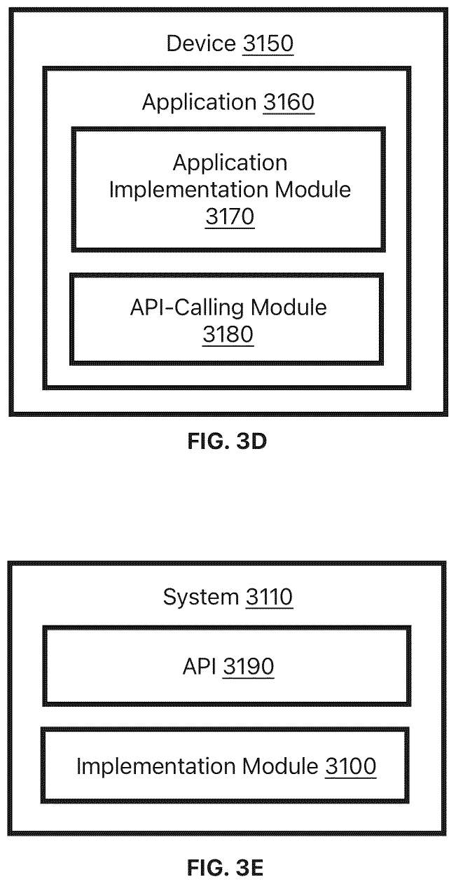

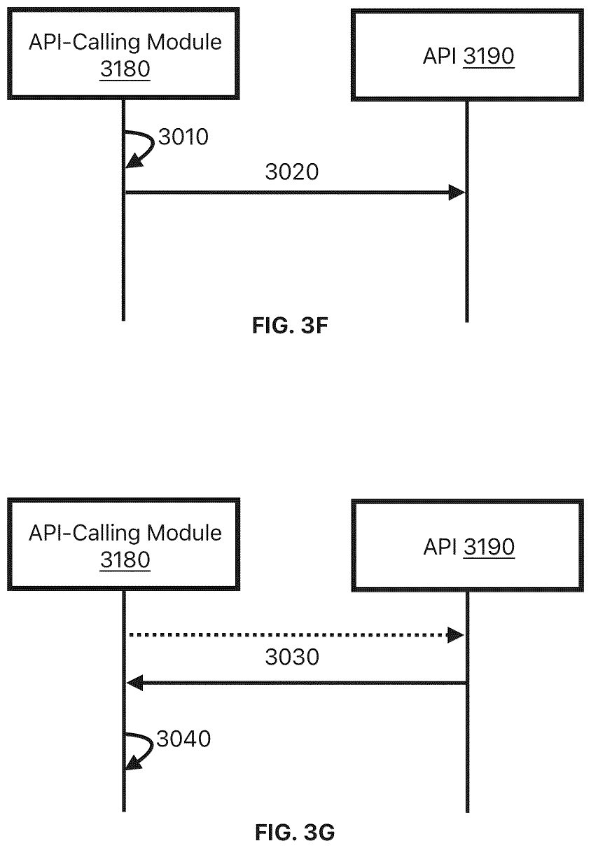

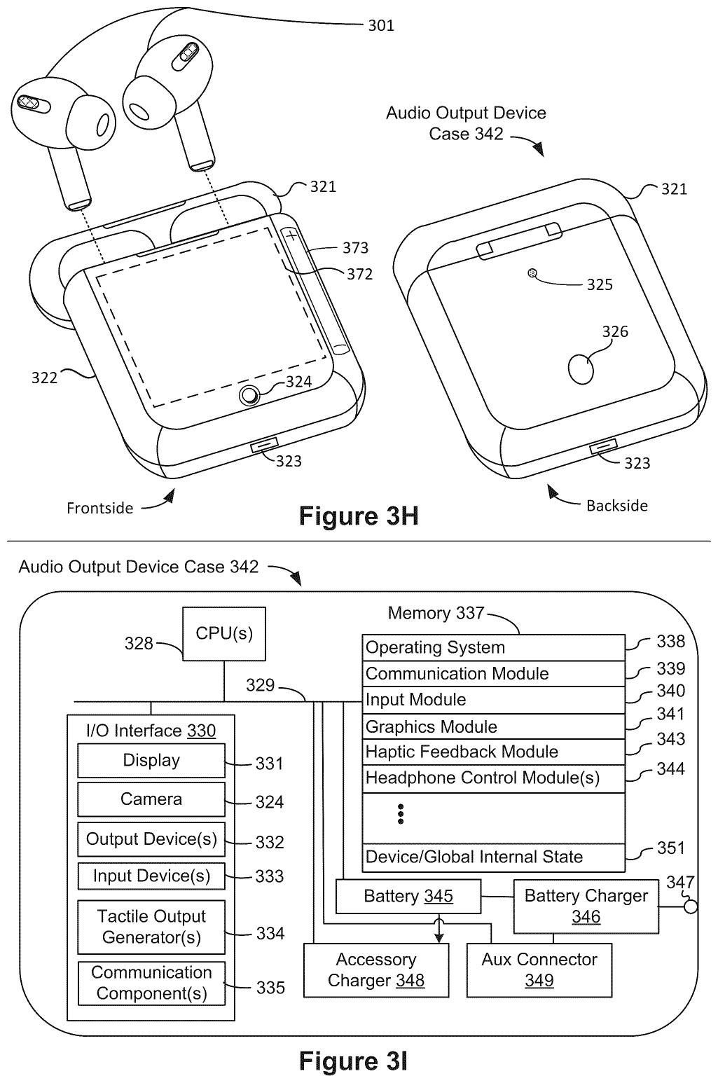

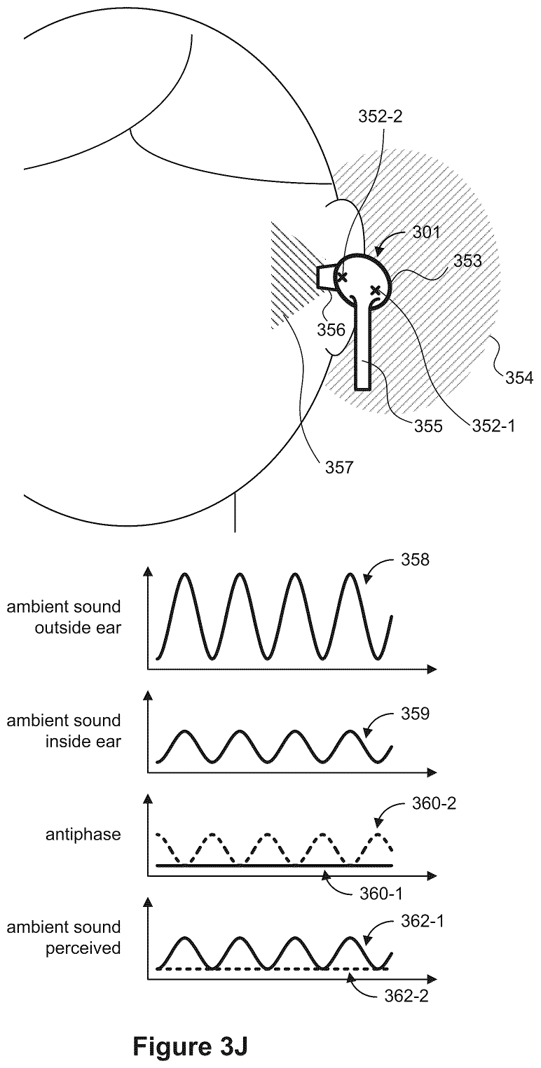

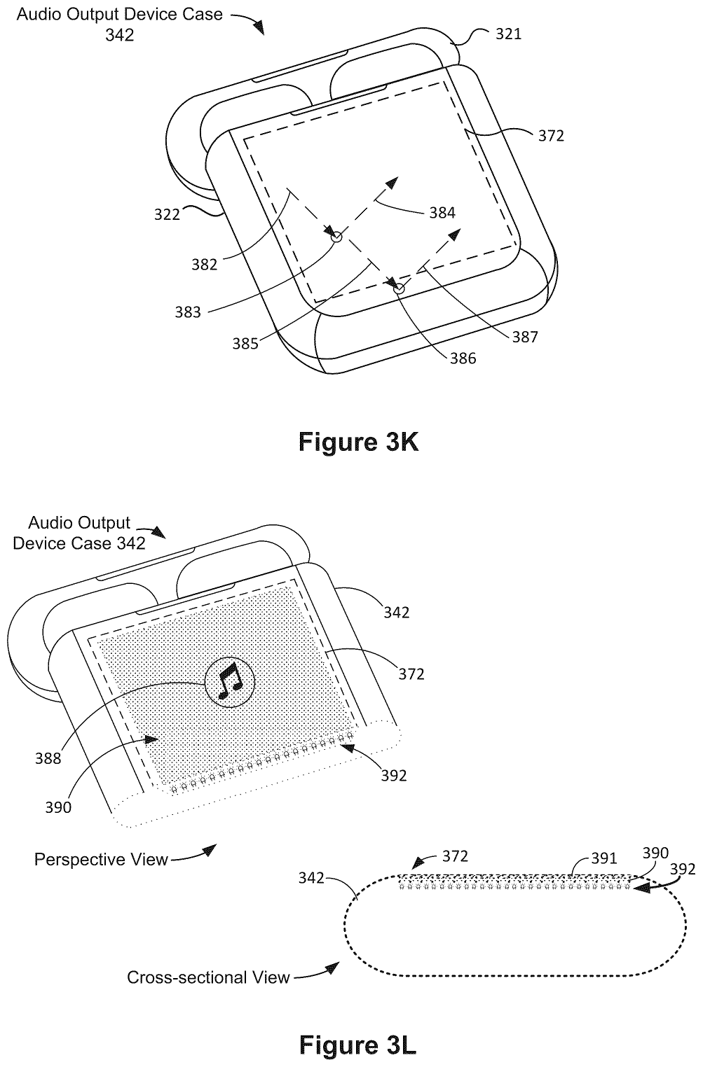

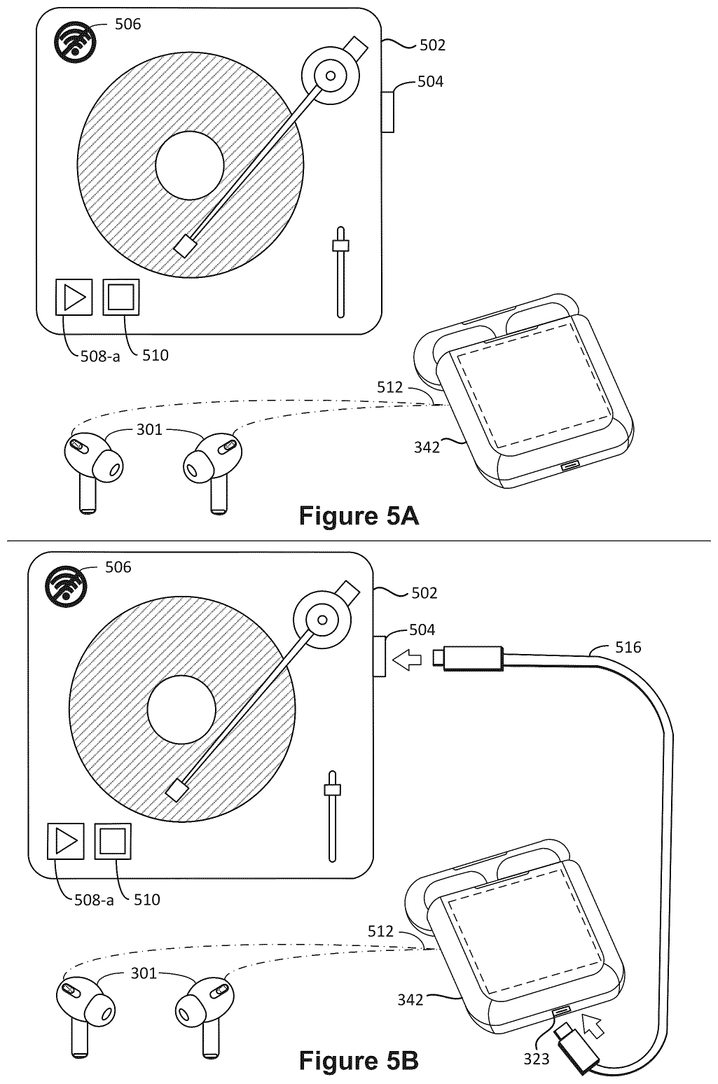

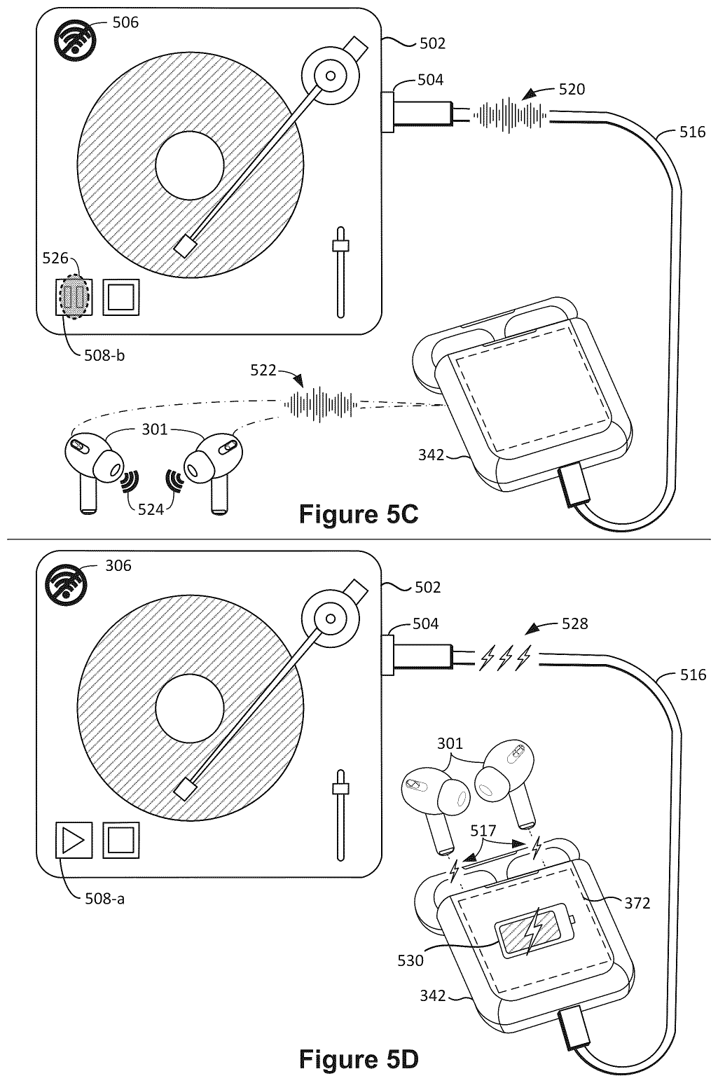

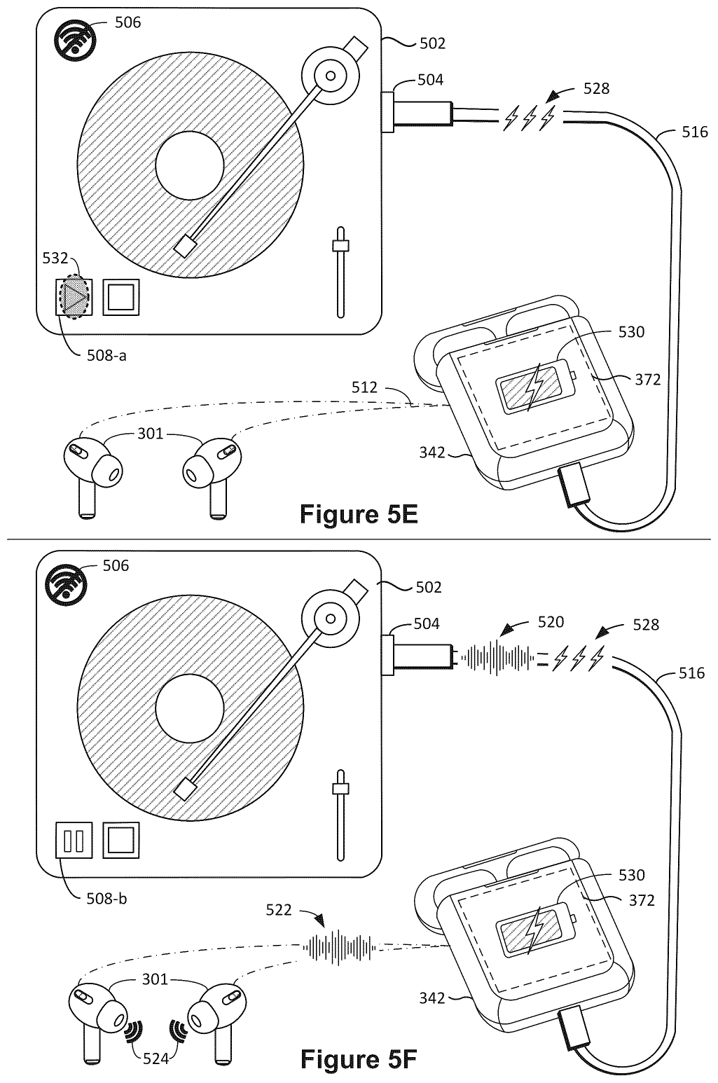

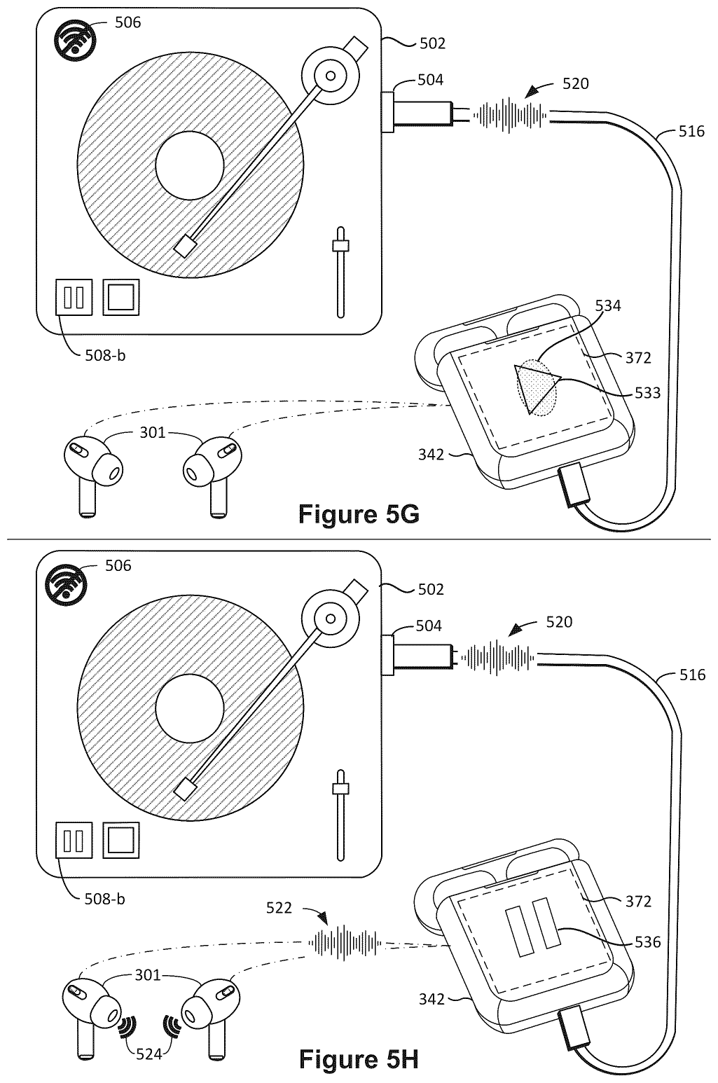

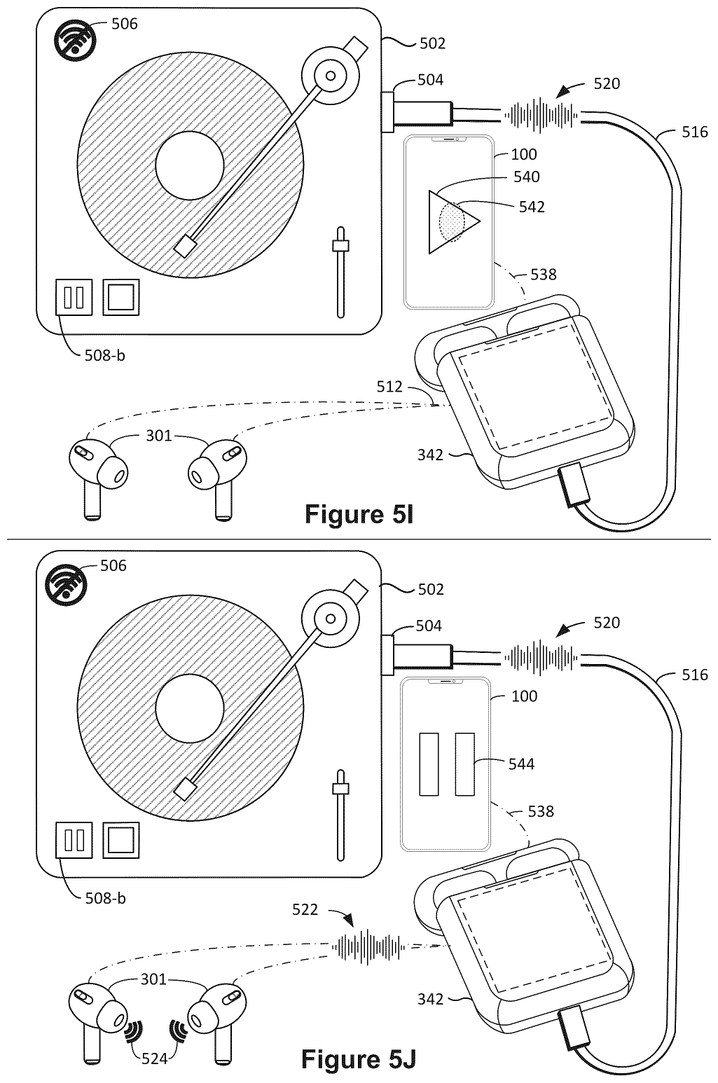

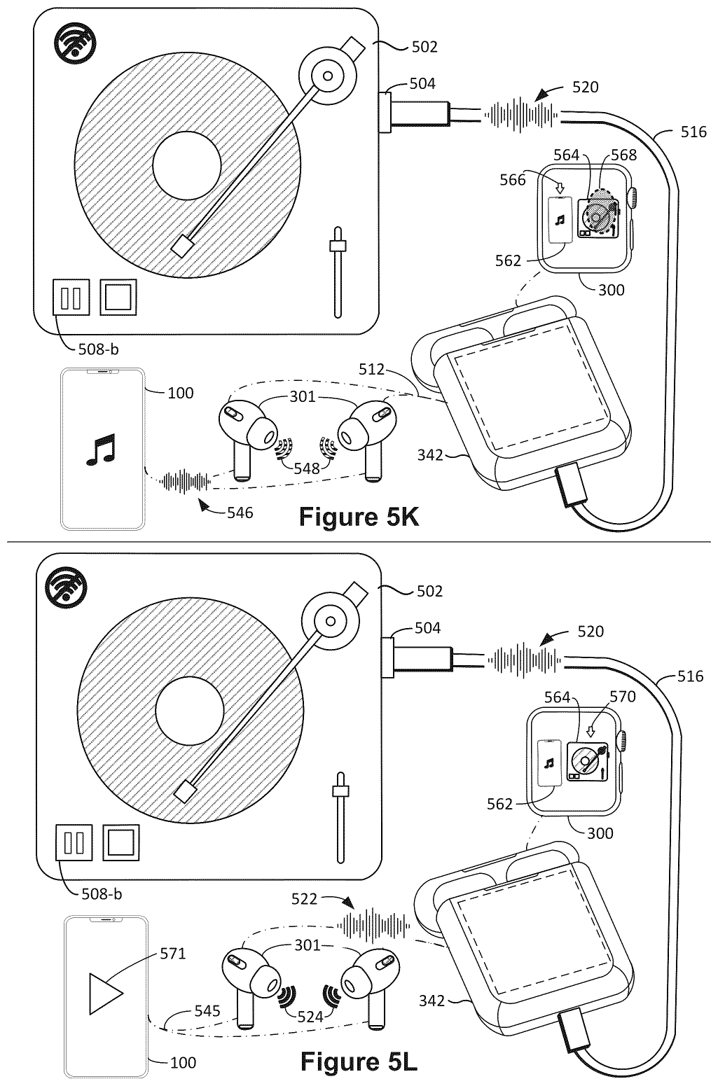

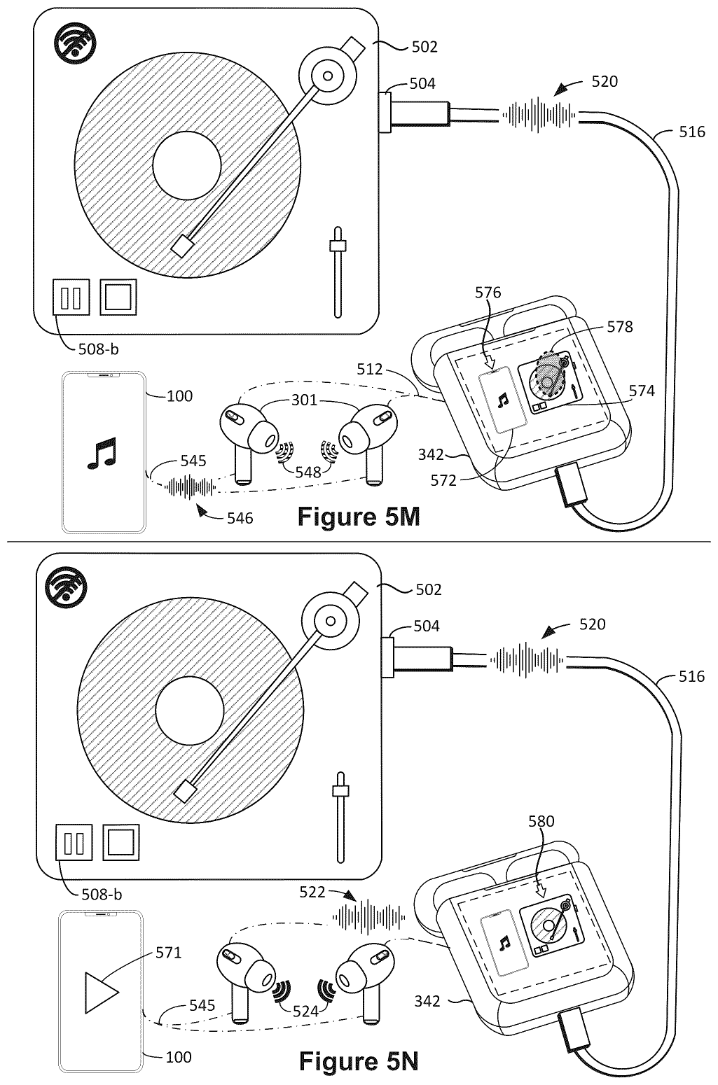

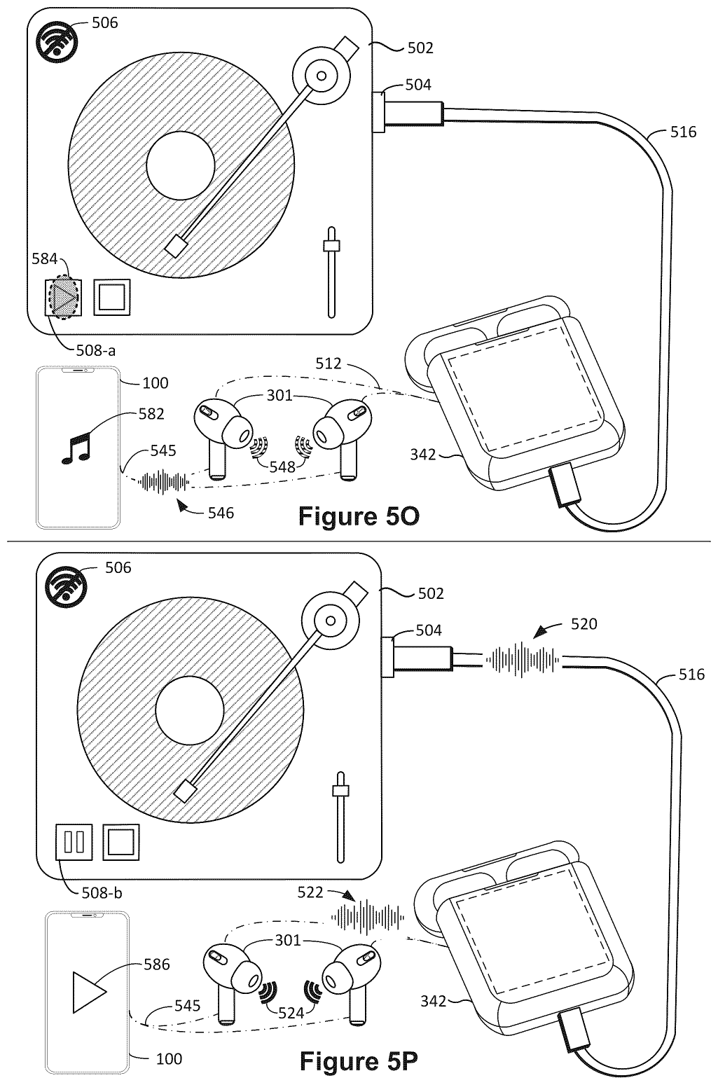

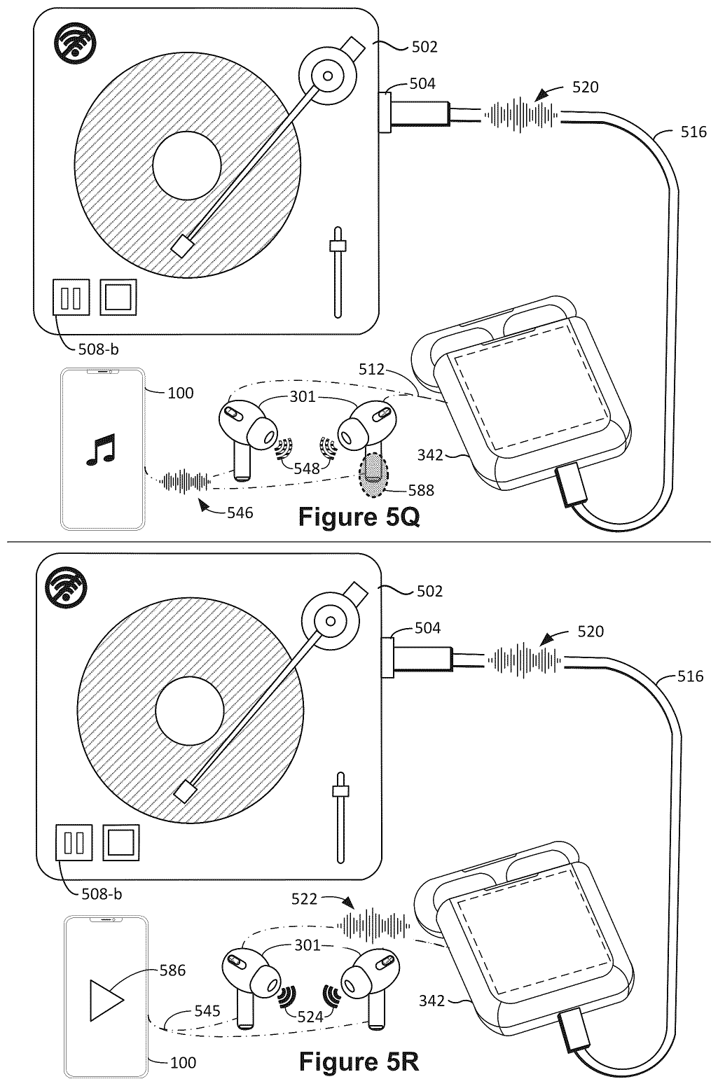

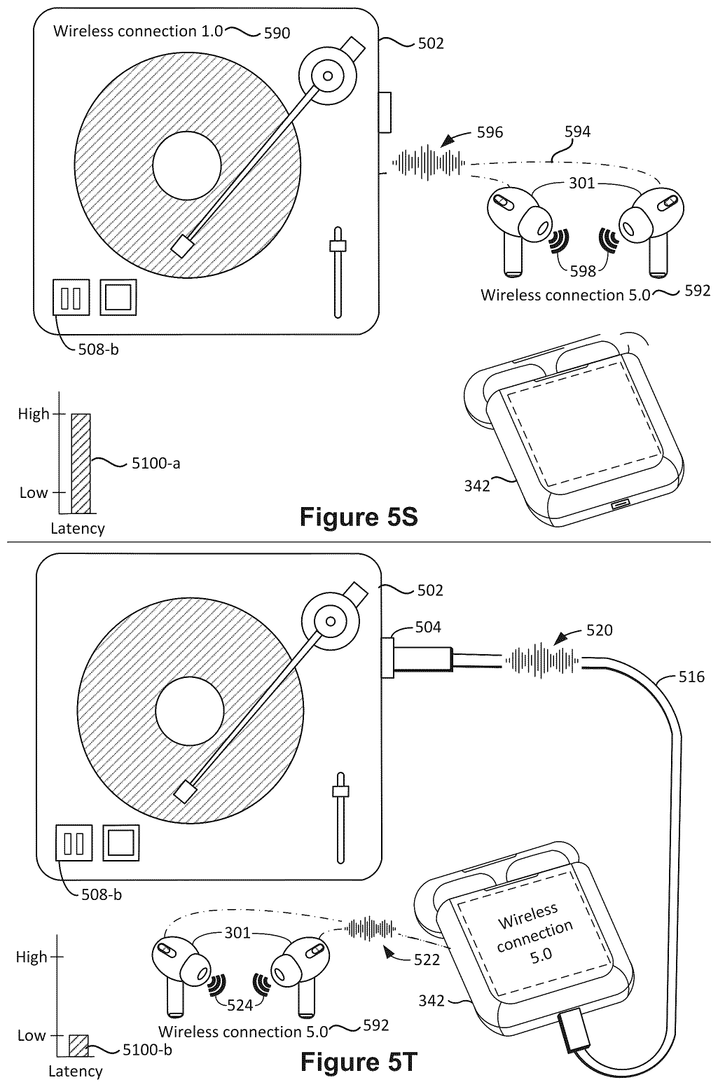

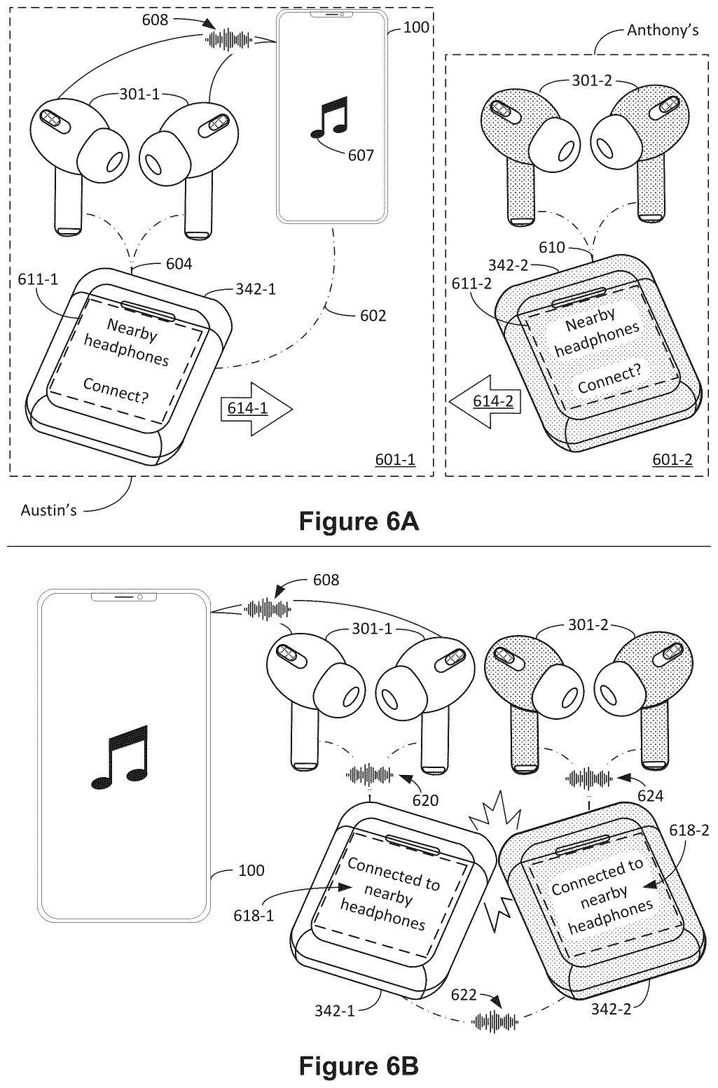

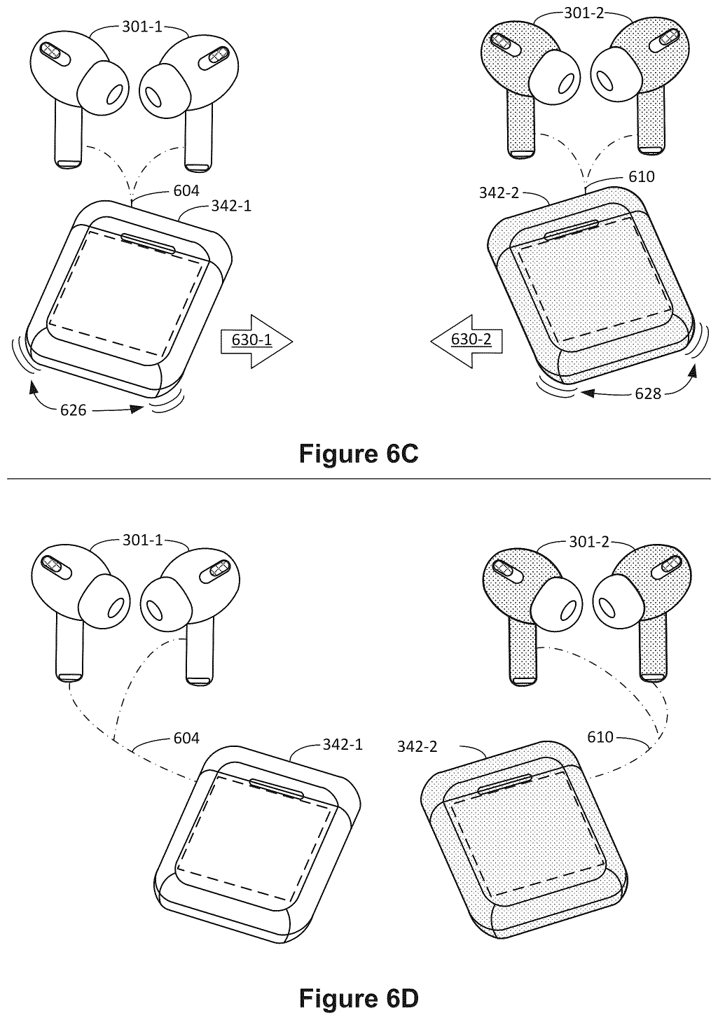

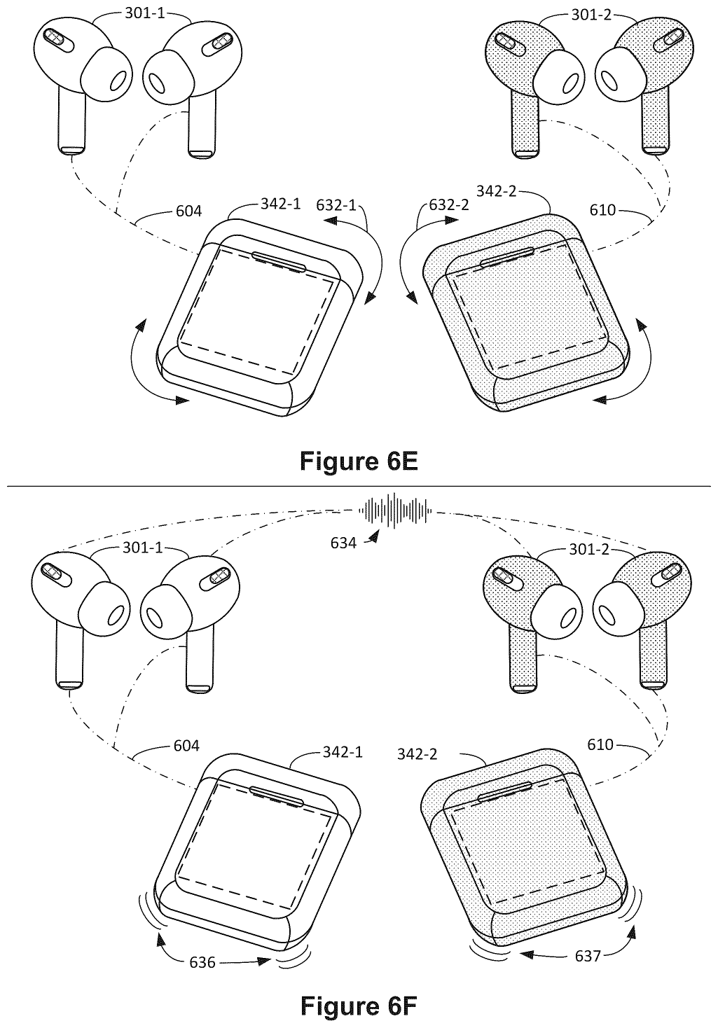

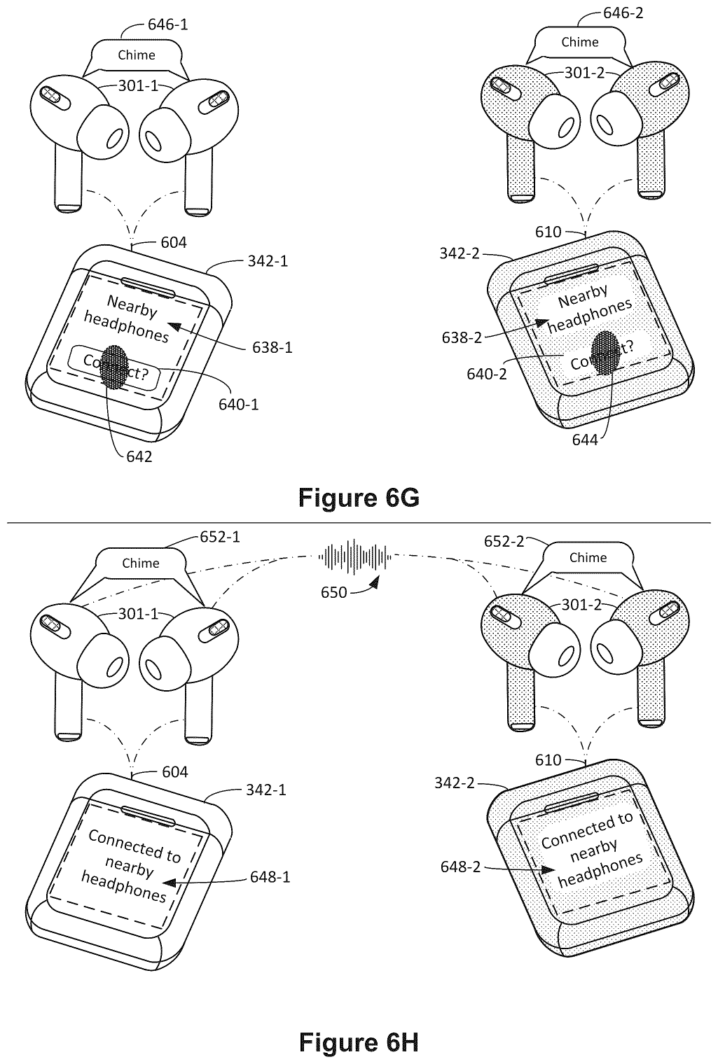

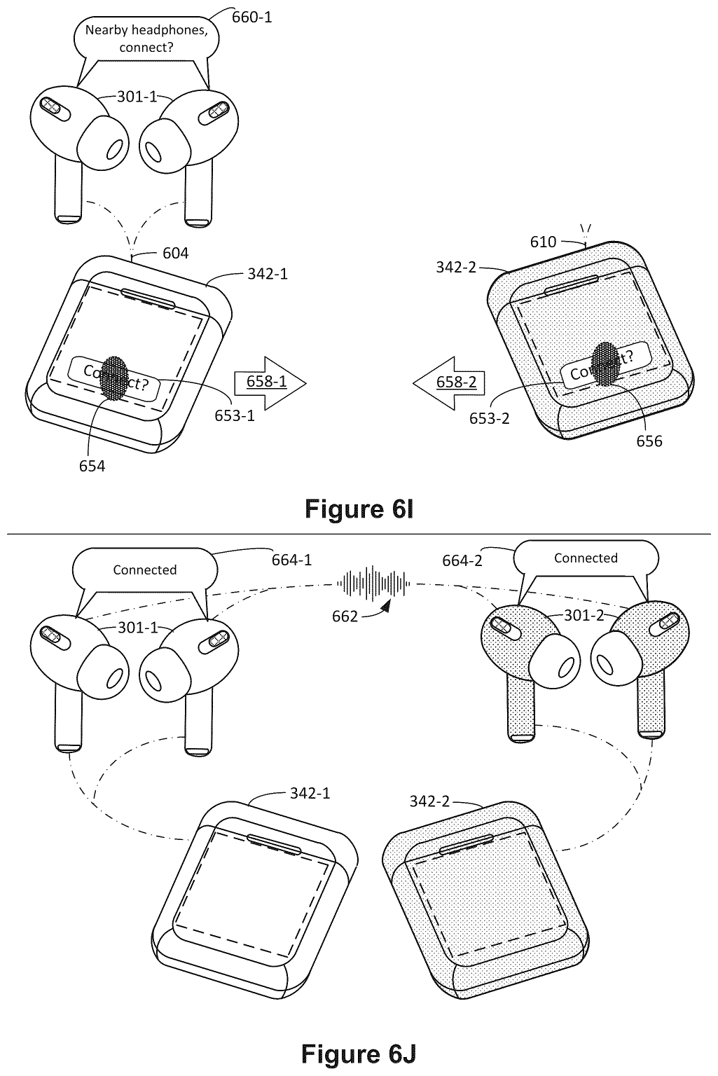

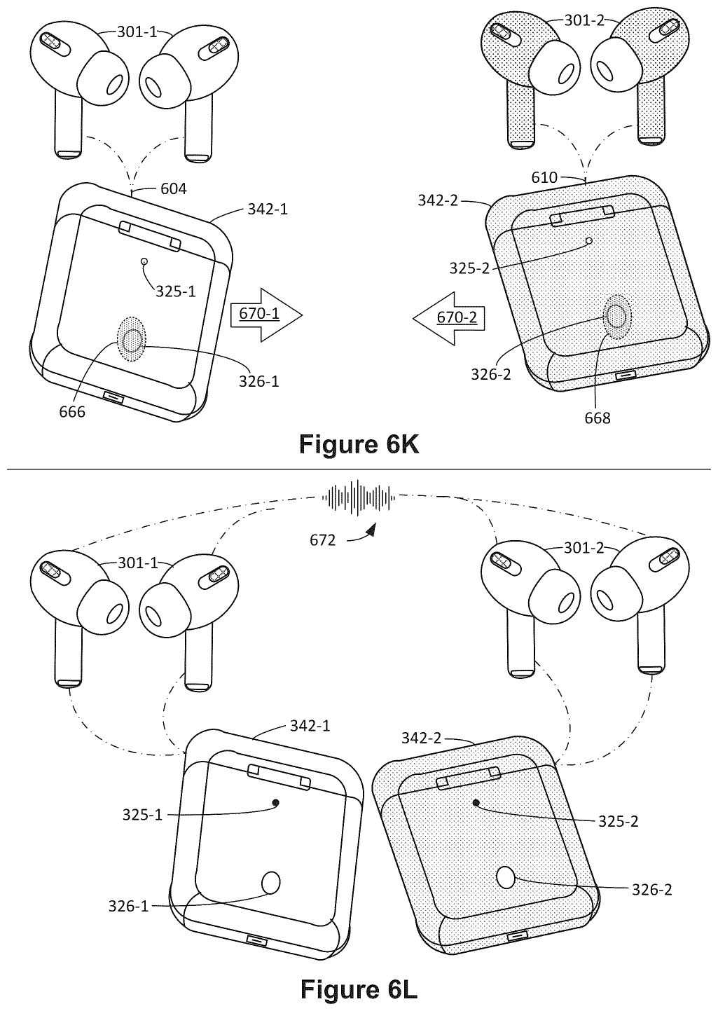

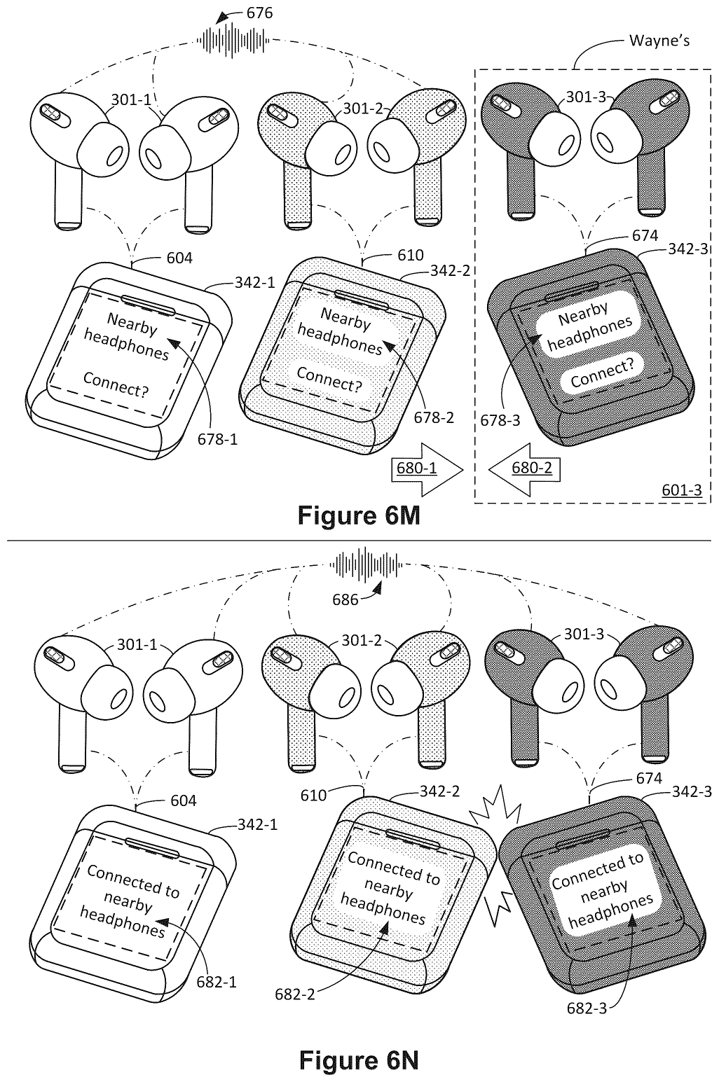

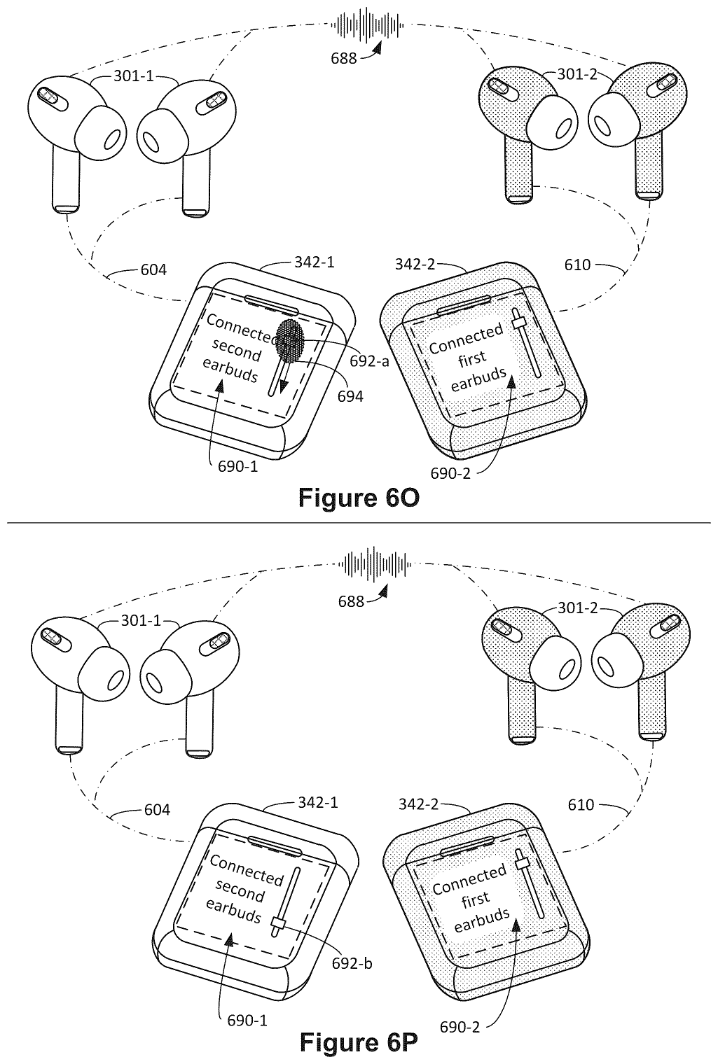

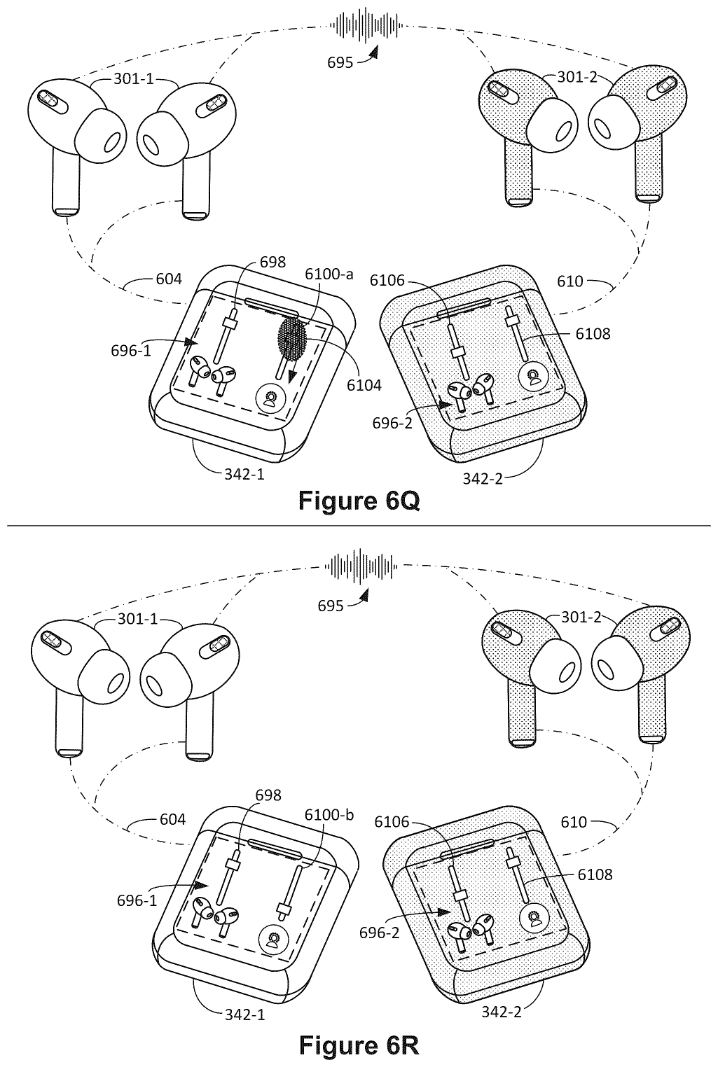

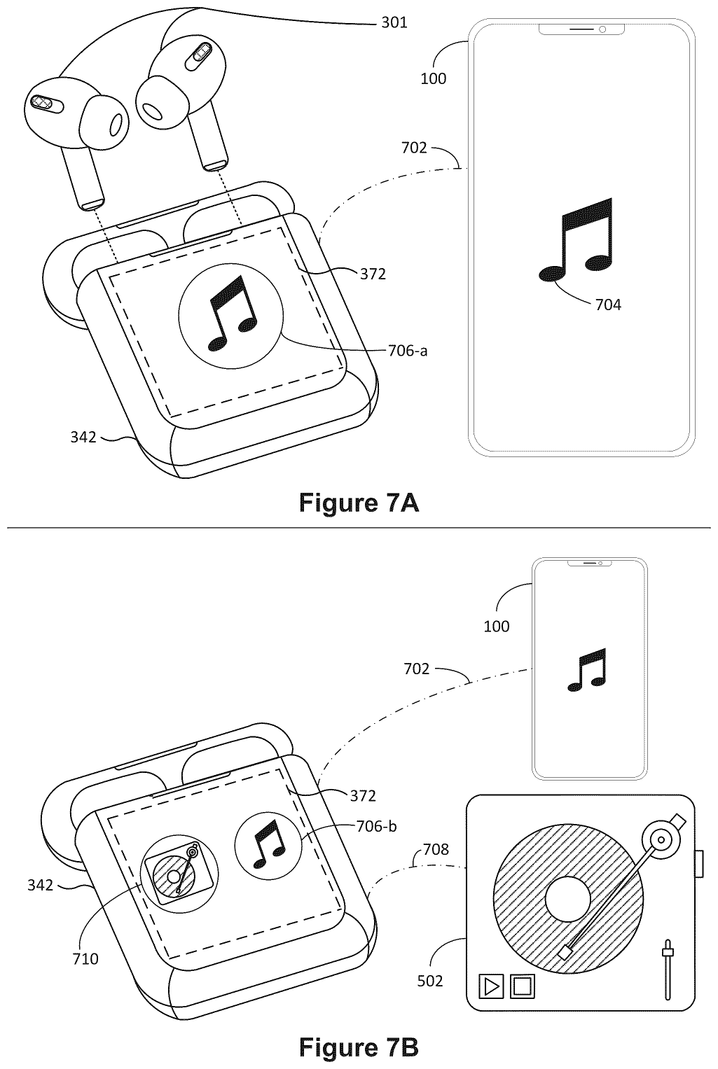

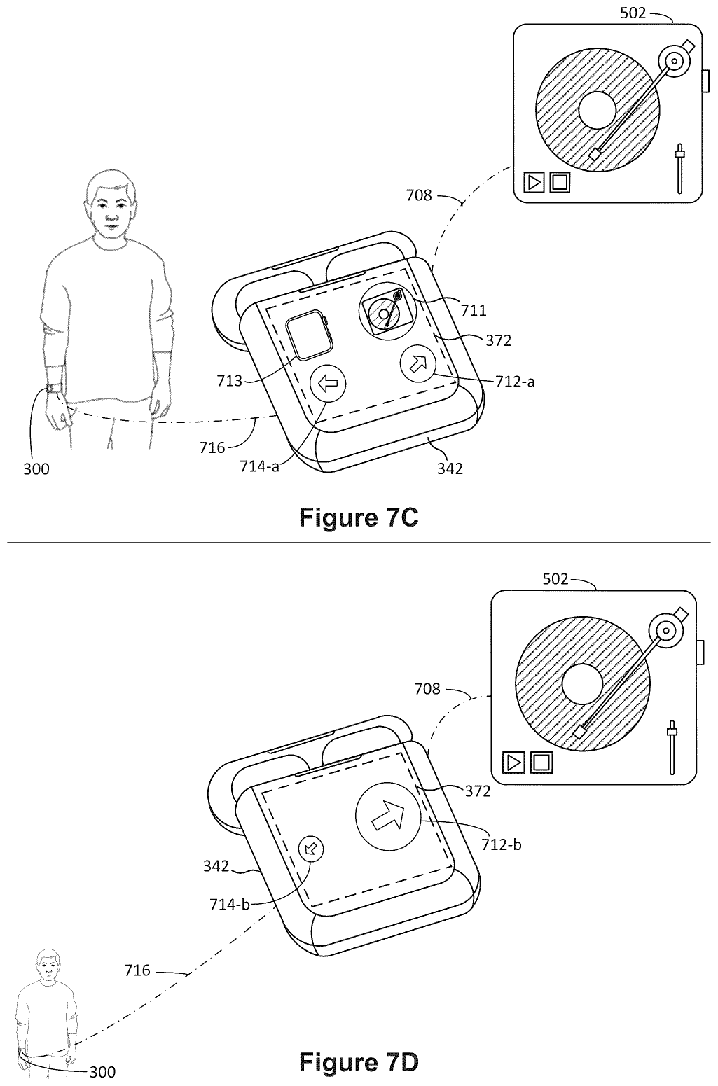

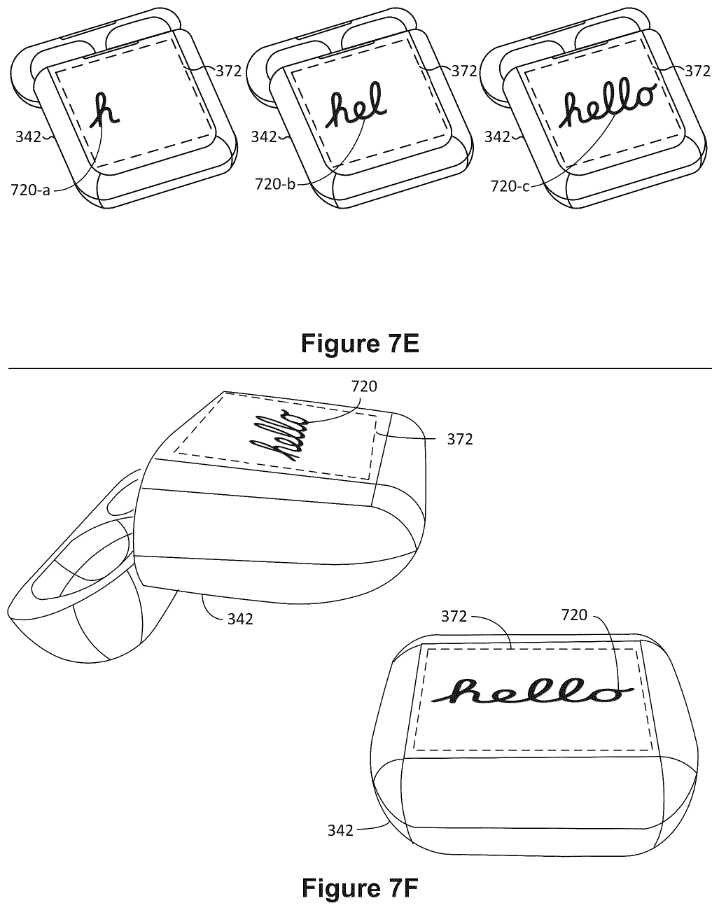

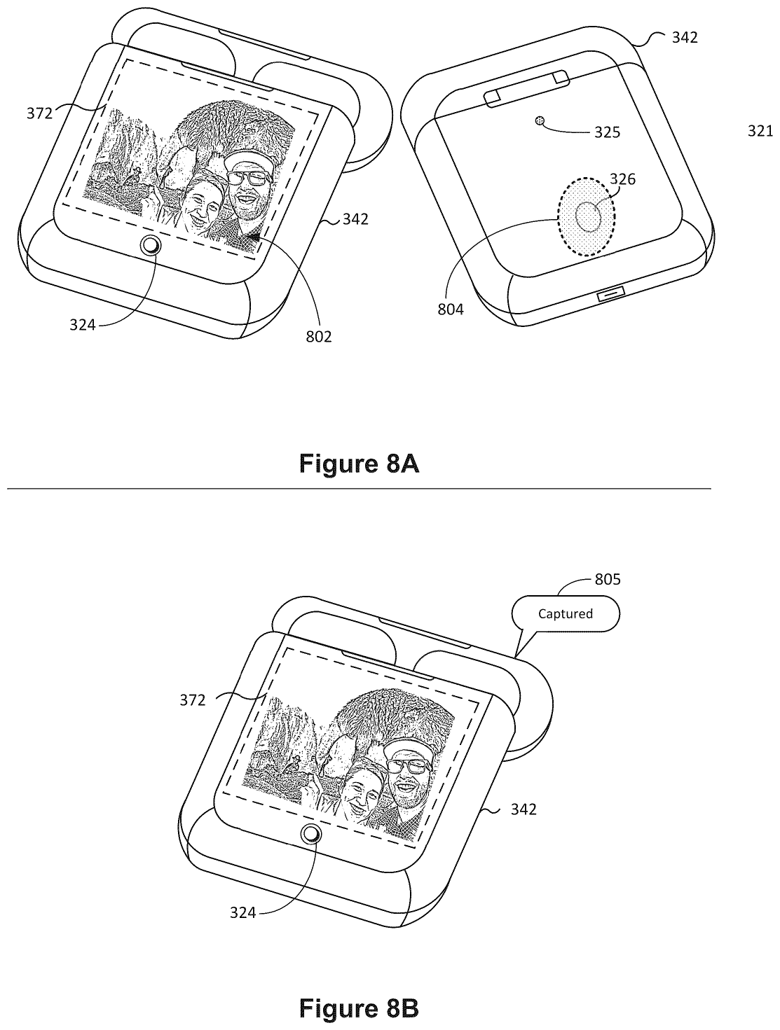

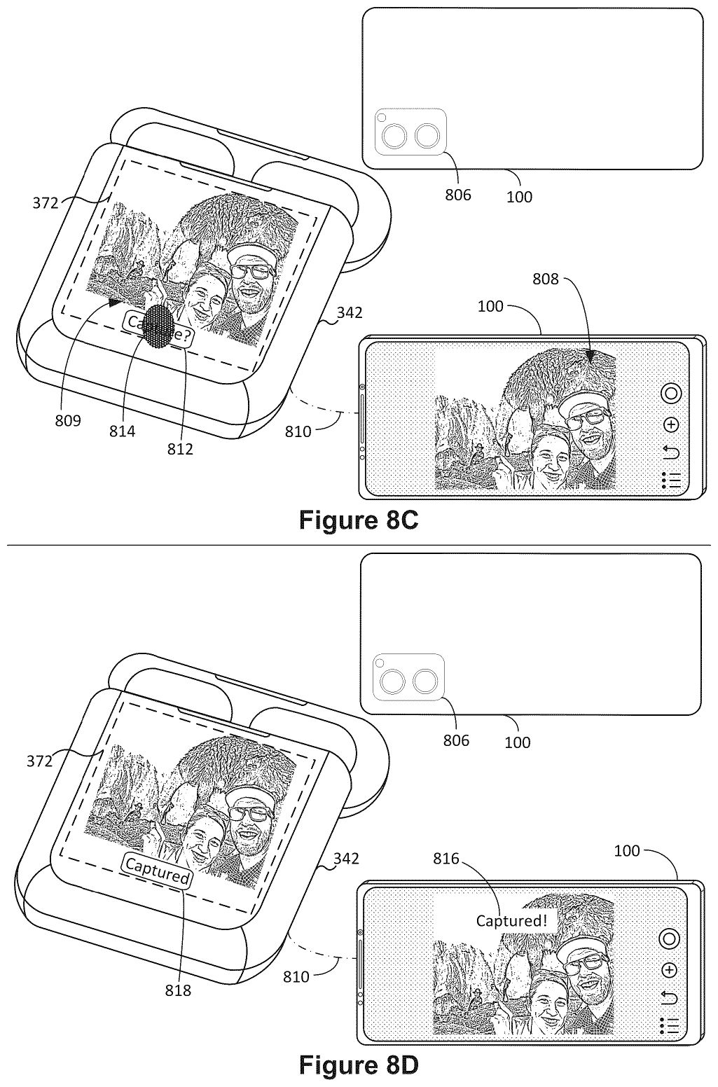

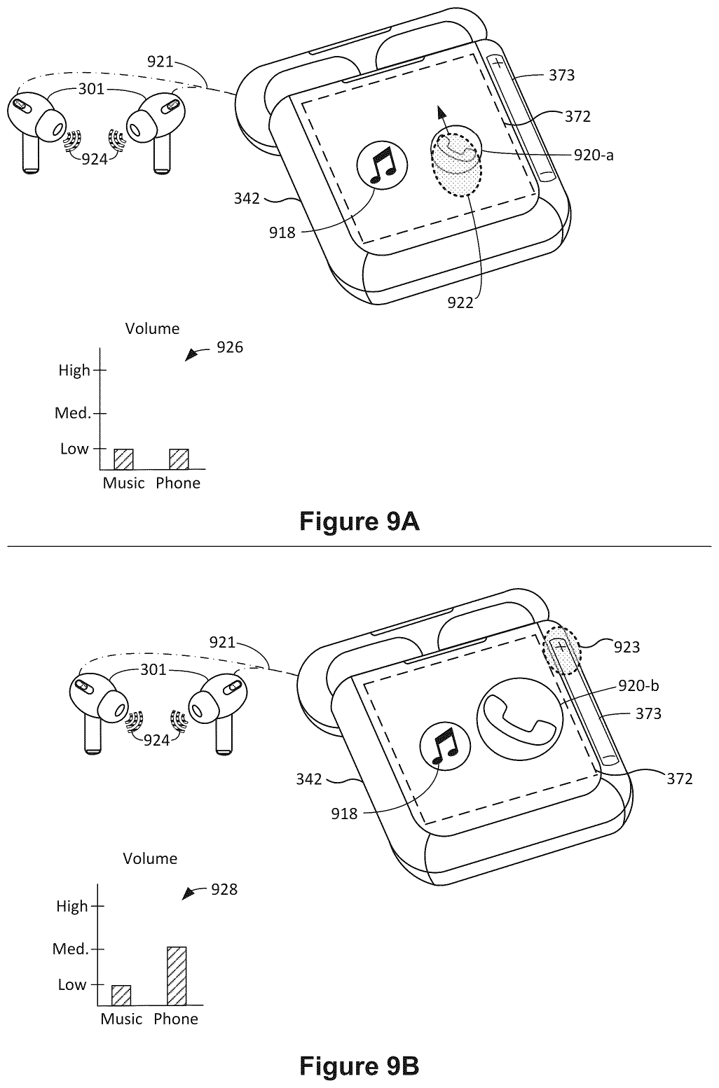

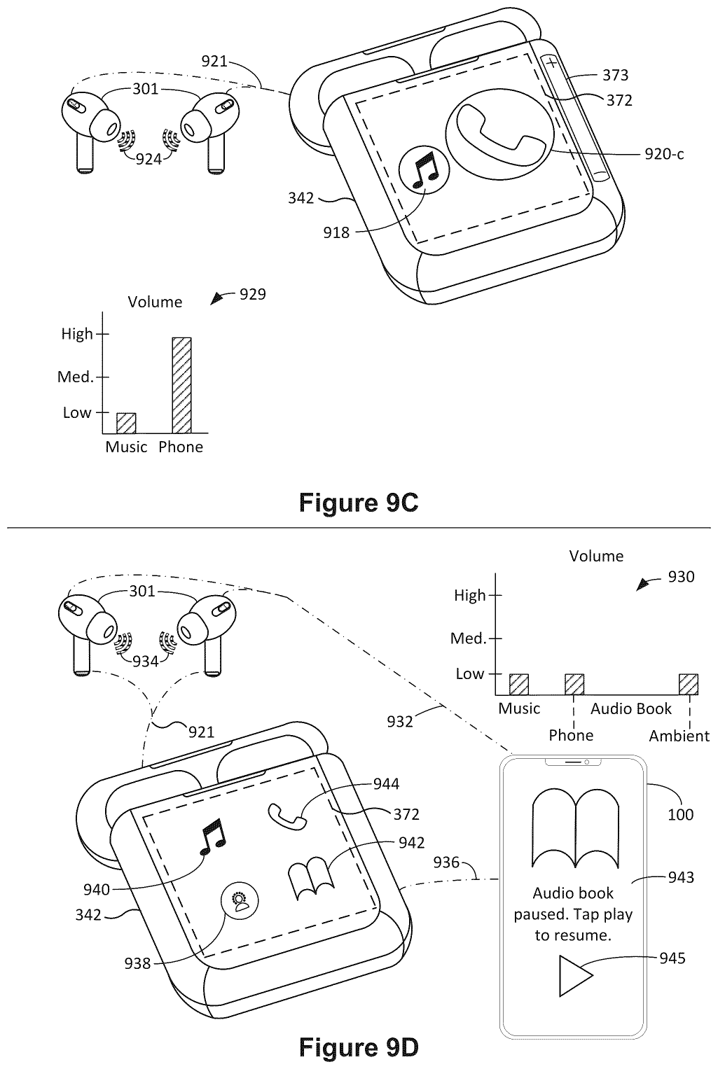

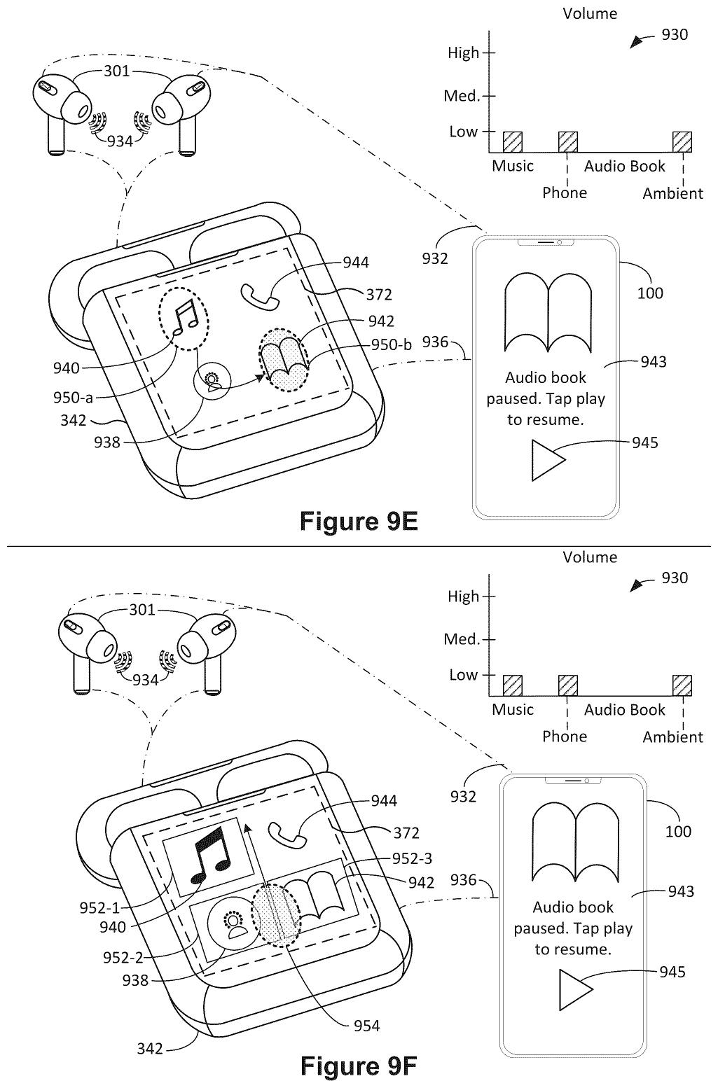

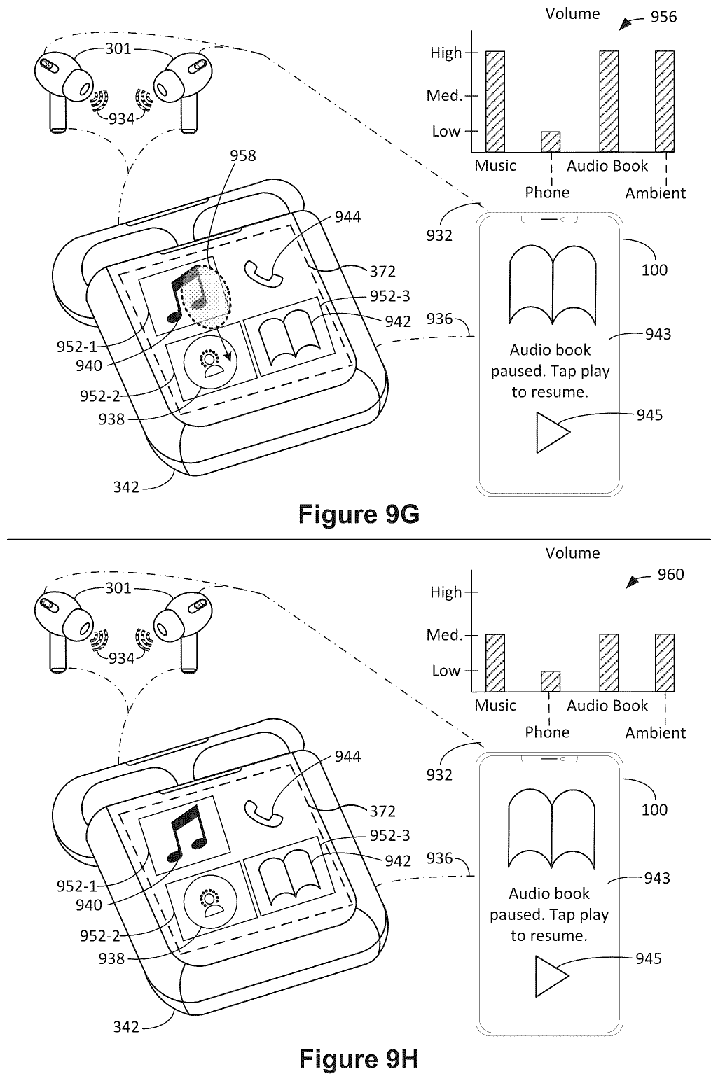

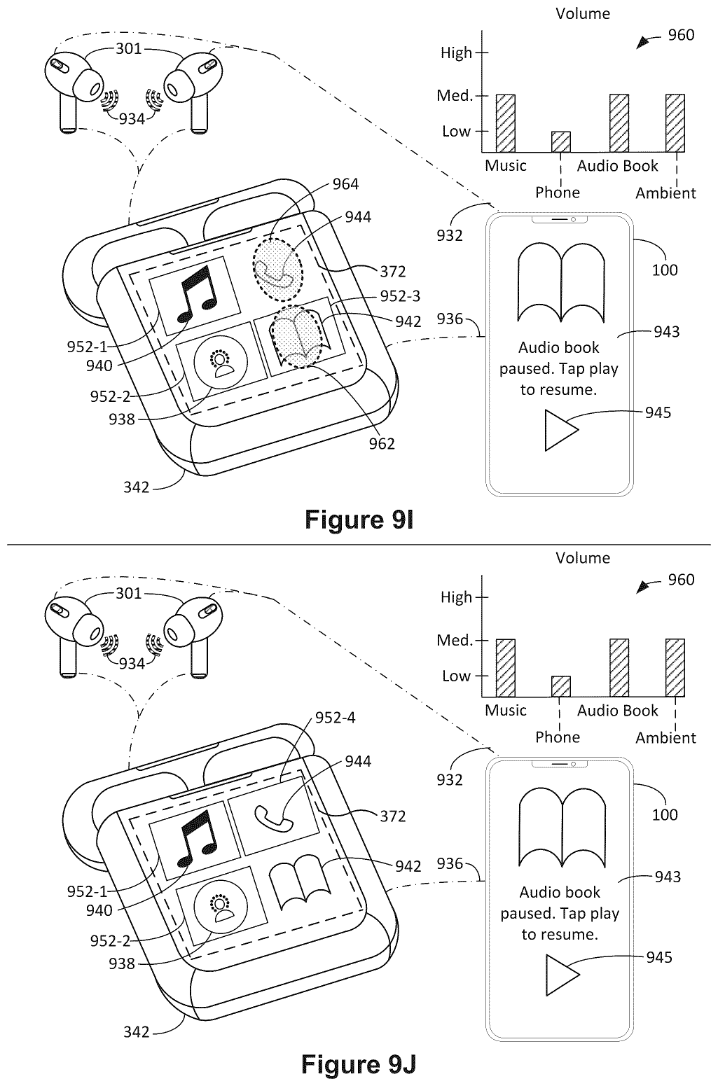

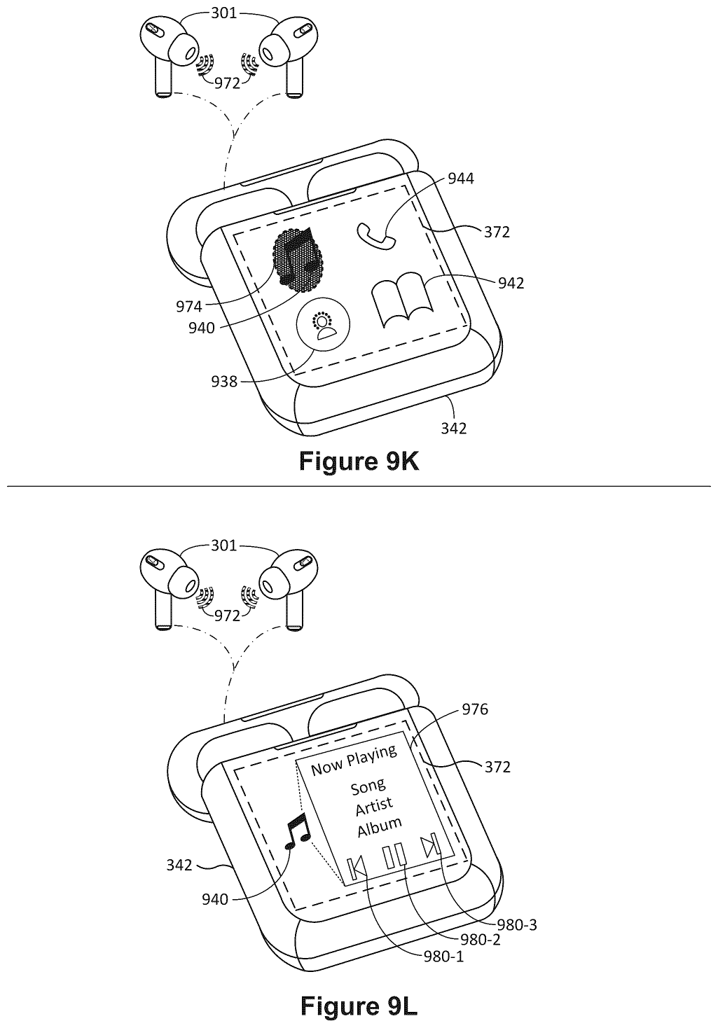

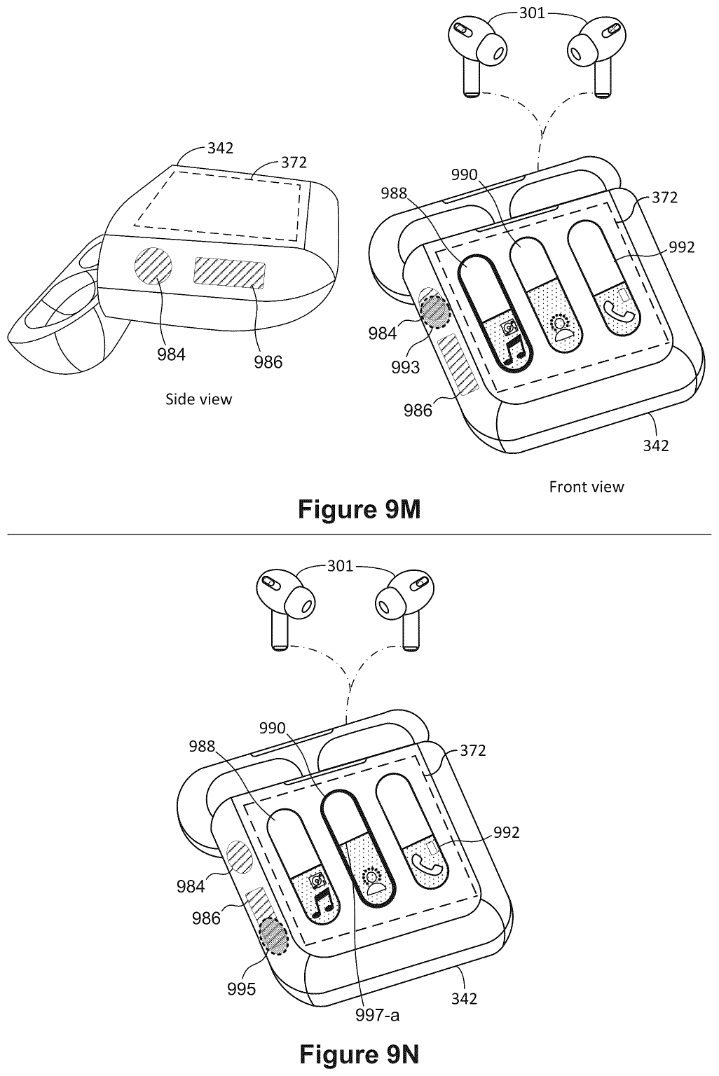

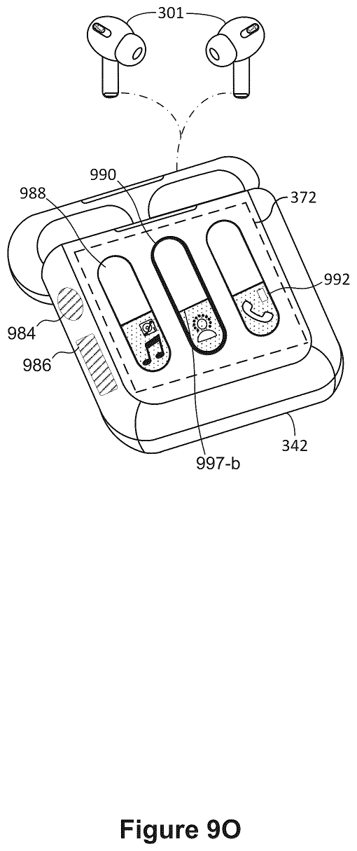

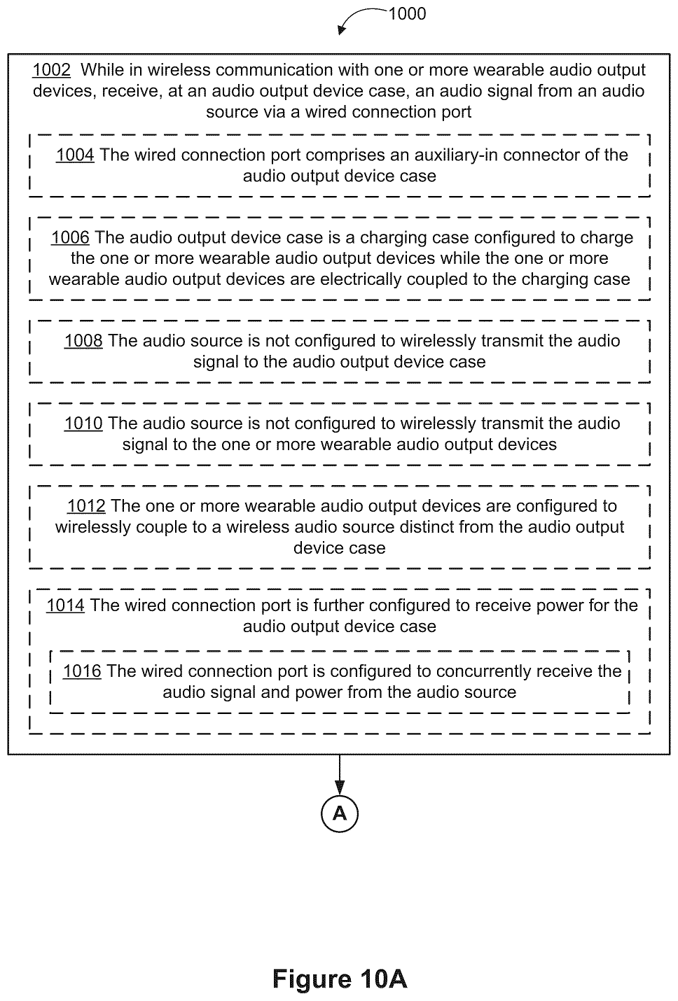

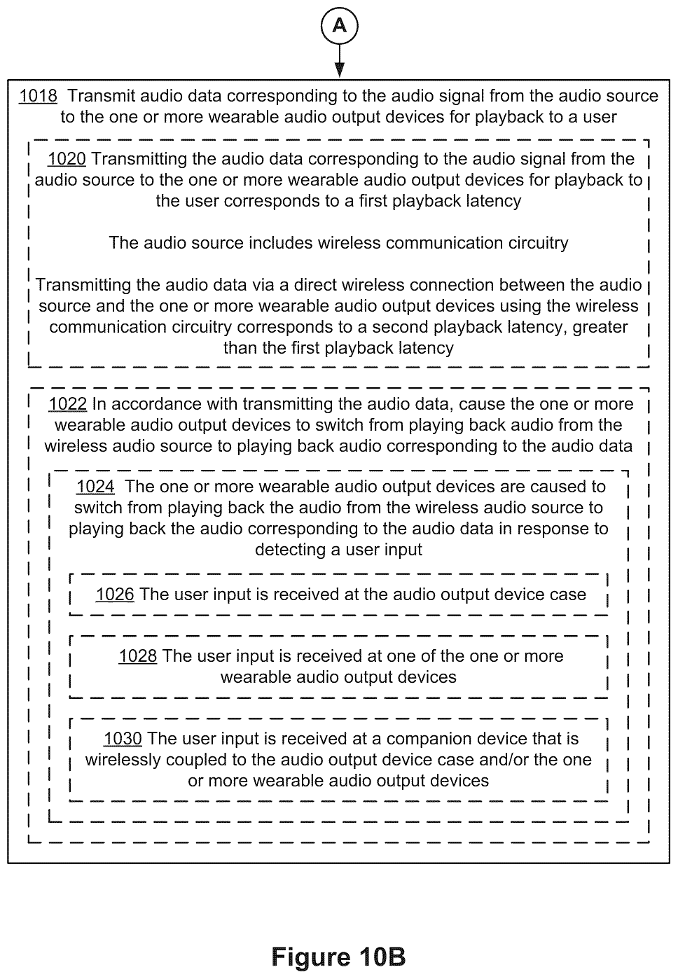

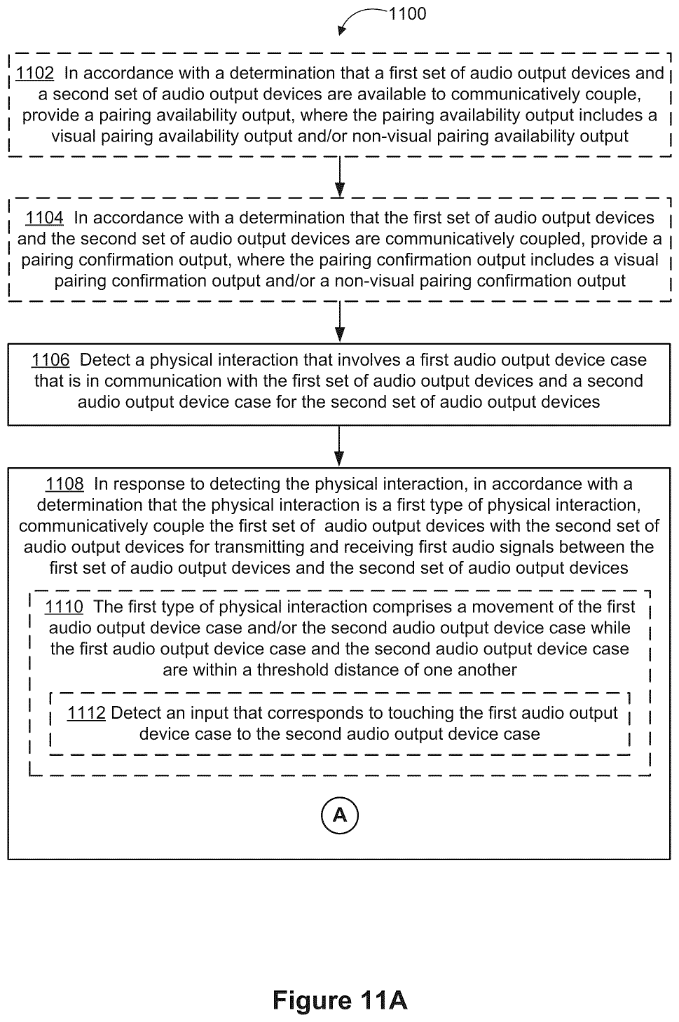

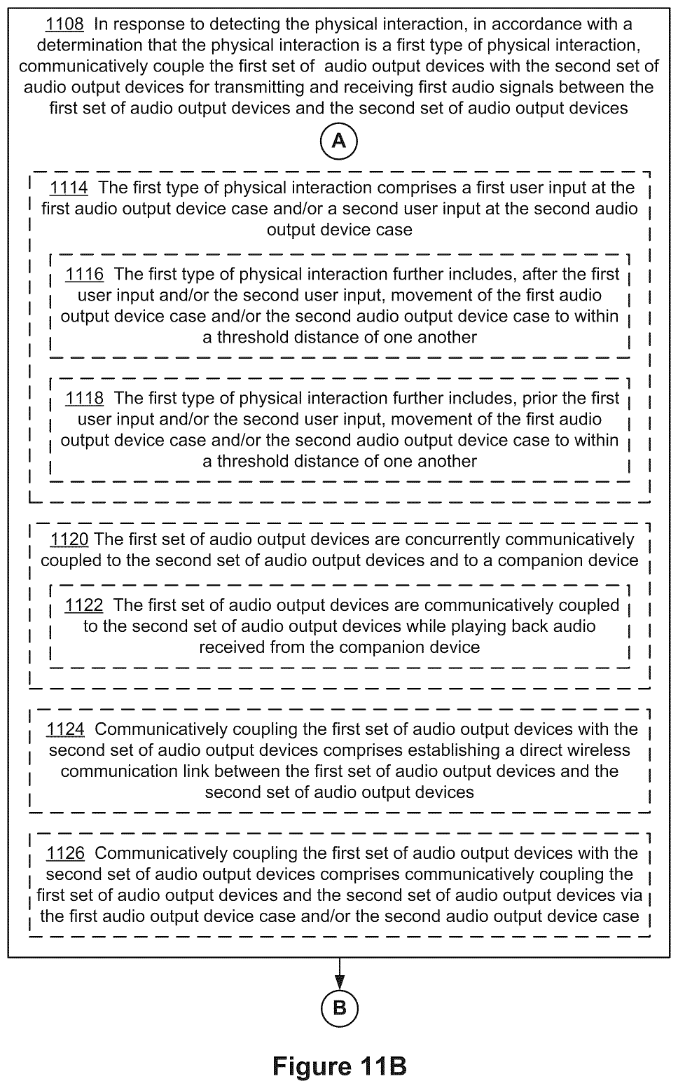

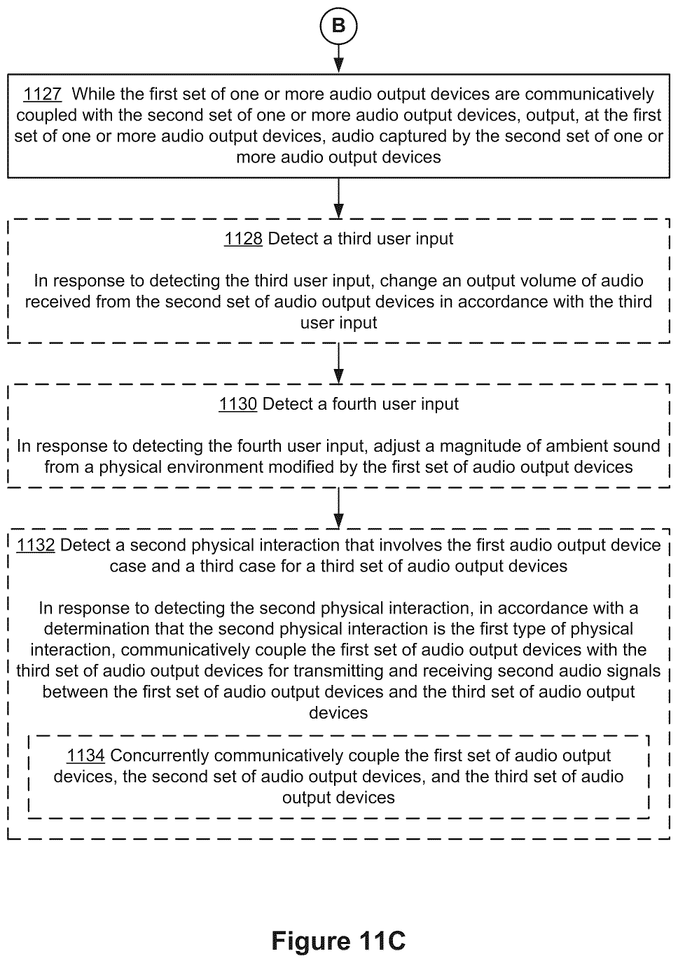

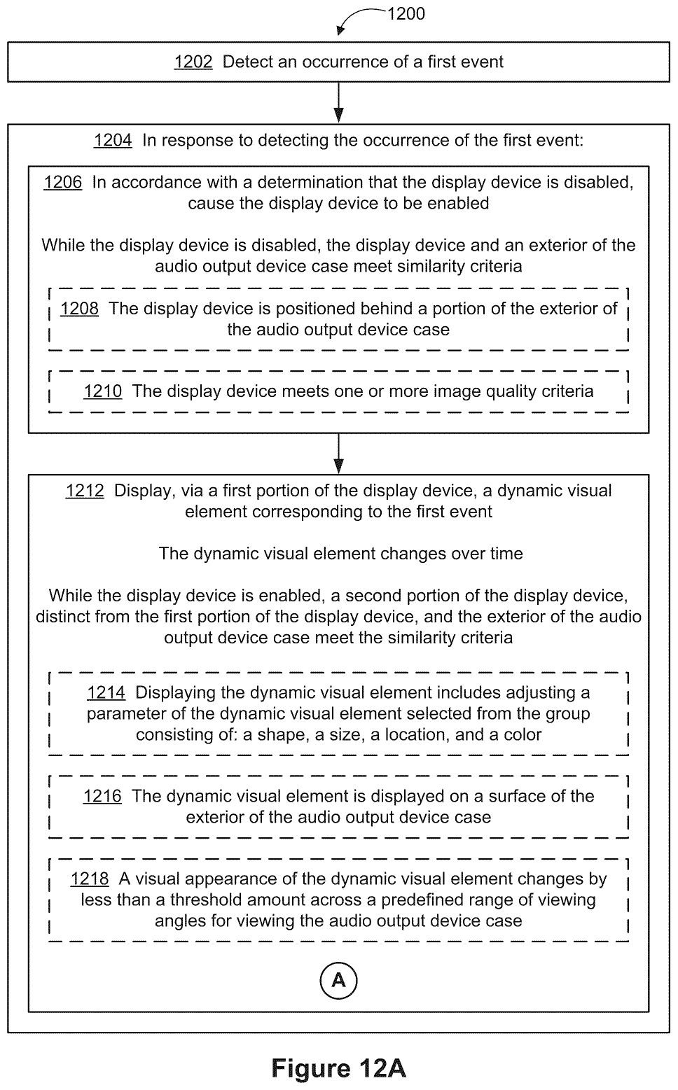

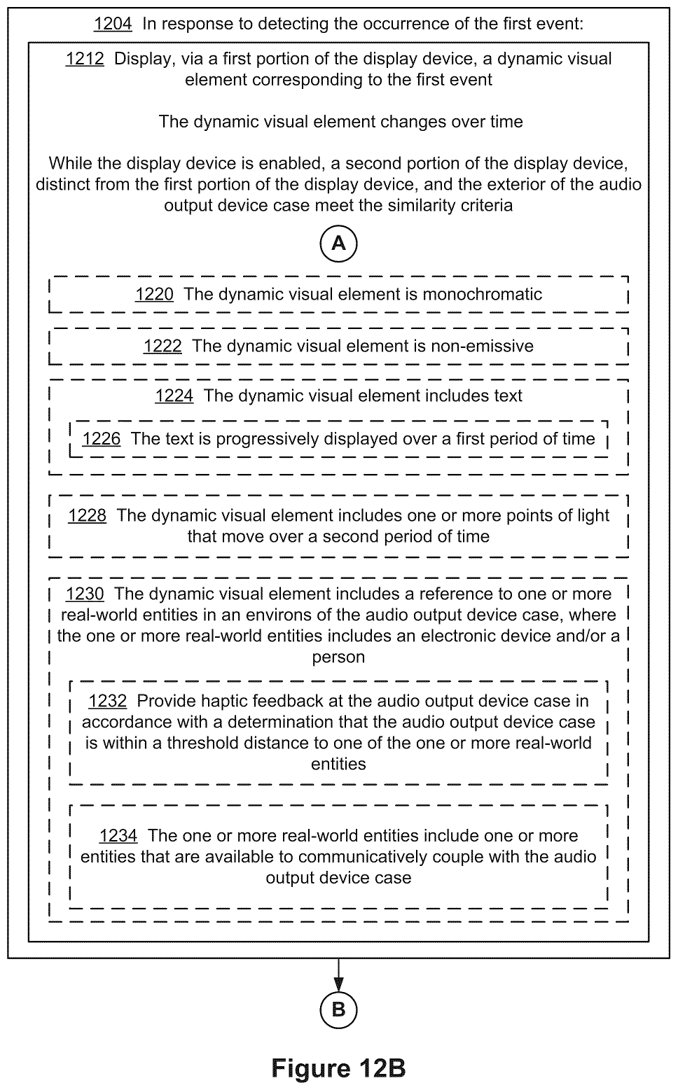

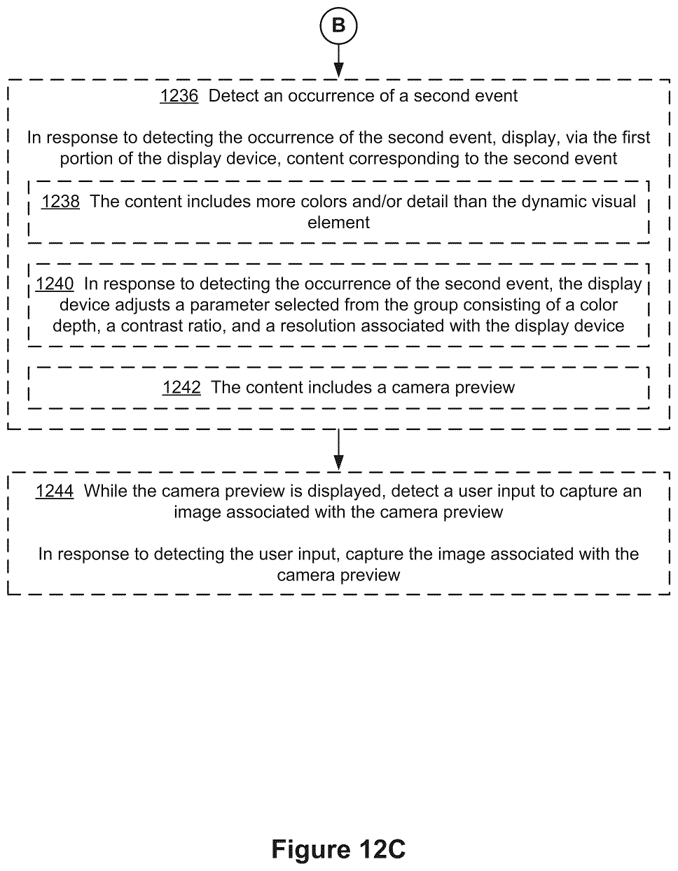

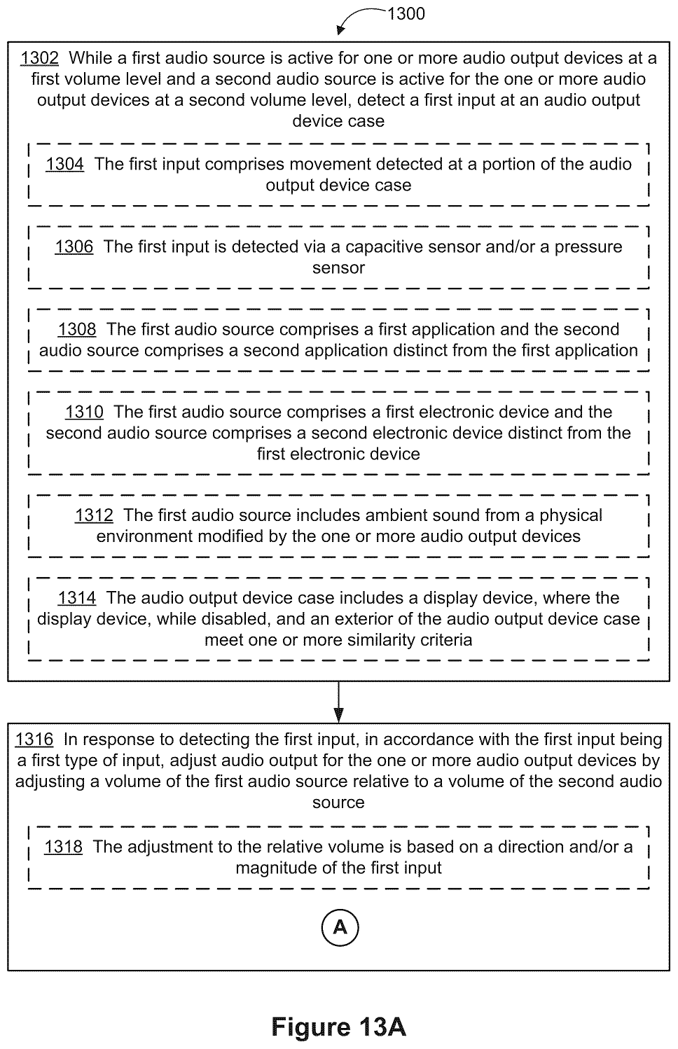

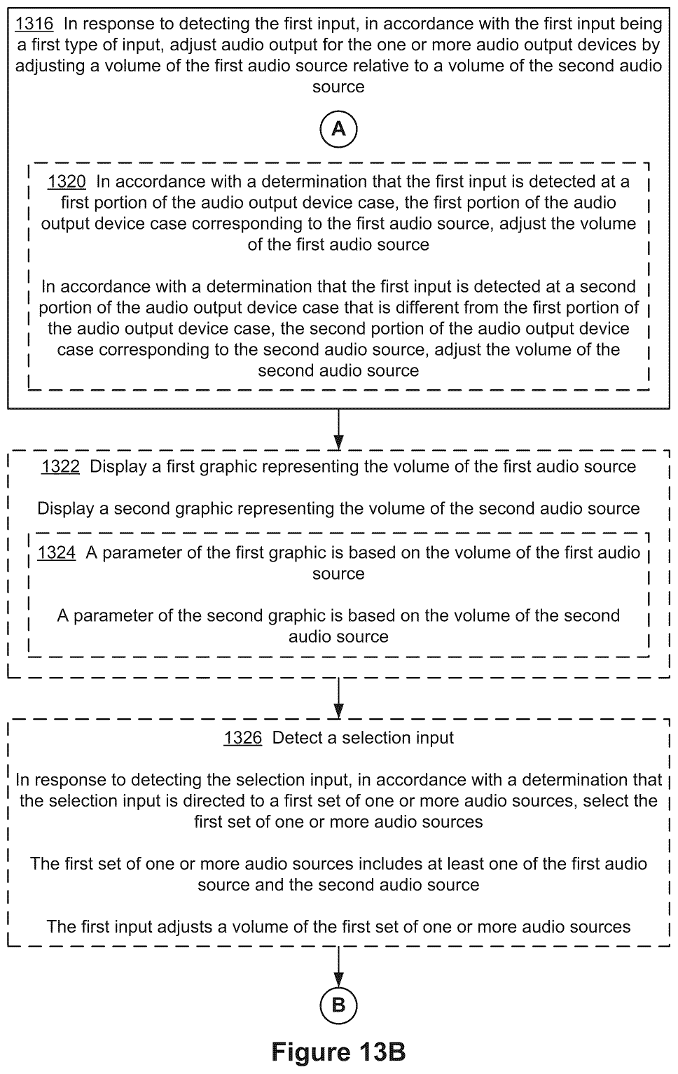

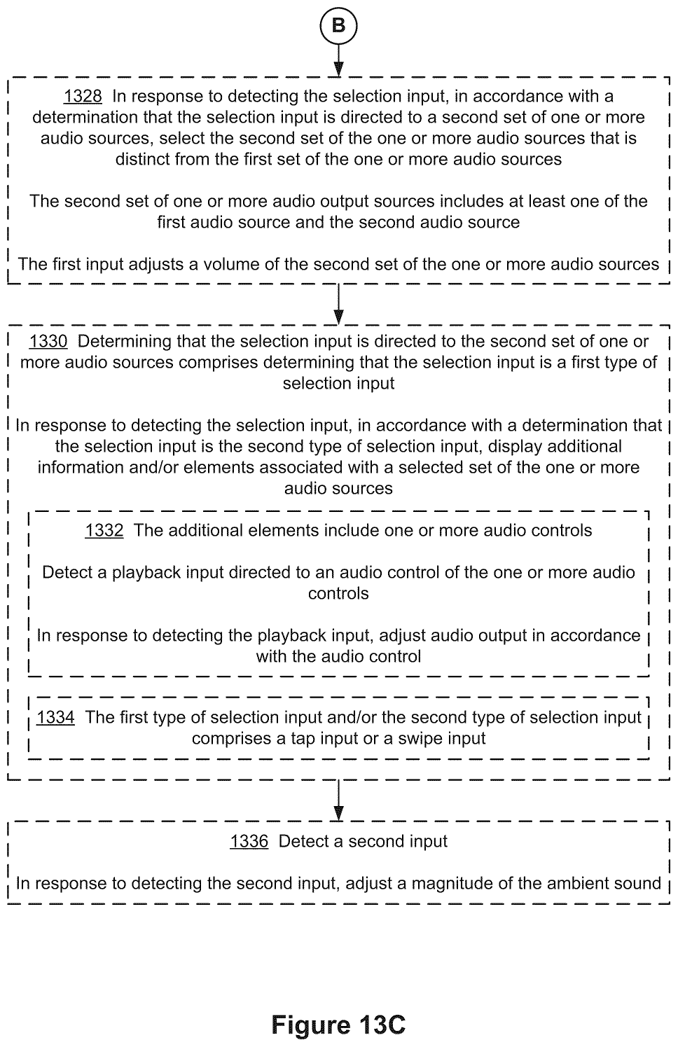

Below, FIGS. 1A-1B, 2, 3A, 3H-3L, and 4A-4B illustrate example devices (e.g., multifunction device 100, device 300, wearable audio output devices 301, and audio output device case 342). FIGS. 3B-3G describe the use of Application Programming Interfaces (APIs) to perform operations. FIGS. 5A-5T illustrate example user interfaces and user interactions involving audio output devices and audio output device cases. FIGS. 6A-6R illustrate example user interfaces and user interactions for communicatively coupling audio output devices. FIGS. 7A-7F illustrate example user interfaces and user interactions with an audio output device case. FIGS. 8A-8D illustrate example user interfaces and user interactions with a camera and an audio output device case. FIGS. 9A-9O illustrate example user interfaces and user interactions with an audio output device case. FIGS. 10A-10B are flow diagrams of a process of transmitting audio data. FIGS. 11A-11C are flow diagrams of a process of communicatively coupling sets of audio output devices. FIGS. 12A-12C are flow diagrams of a process of displaying dynamic visual elements at an audio output device case. FIGS. 13A-13C are flow diagrams of a process of adjusting relative volume levels at an audio output device case. The user interfaces and device interactions in FIGS. 5A-5T, 6A-6R, 7A-7F, 8A-8D, and 9A-9O are used to illustrate the processes in FIGS. 10A-10B, 11A-11C, 12A-12C, and 13A-13C.

### Example Devices

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a note taking application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensities of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user. Using tactile outputs to provide haptic feedback to a user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, a tactile output pattern specifies characteristics of a tactile output, such as the amplitude of the tactile output, the shape of a movement waveform of the tactile output, the frequency of the tactile output, and/or the duration of the tactile output.

When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device. Thus, the waveform, frequency and amplitude can be adjusted to indicate to the user that different operations have been performed. As such, tactile outputs with tactile output patterns that are designed, selected, and/or engineered to simulate characteristics (e.g., size, material, weight, stiffness, smoothness, etc.); behaviors (e.g., oscillation, displacement, acceleration, rotation, expansion, etc.); and/or interactions (e.g., collision, adhesion, repulsion, attraction, friction, etc.) of objects in a given environment (e.g., a user interface that includes graphical features and objects, a simulated physical environment with virtual boundaries and virtual objects, a real physical environment with physical boundaries and physical objects, and/or a combination of any of the above) will, in some circumstances, provide helpful feedback to users that reduces input errors and increases the efficiency of the user's operation of the device. Additionally, tactile outputs are, optionally, generated to correspond to feedback that is unrelated to a simulated physical characteristic, such as an input threshold or a selection of an object. Such tactile outputs will, in some circumstances, provide helpful feedback to users that reduces input errors and increases the efficiency of the user's operation of the device.

In some embodiments, a tactile output with a suitable tactile output pattern serves as a cue for the occurrence of an event of interest in a user interface or behind the scenes in a device. Examples of the events of interest include activation of an affordance (e.g., a real or virtual button, or toggle switch) provided on the device or in a user interface, success or failure of a requested operation, reaching or crossing a boundary in a user interface, entry into a new state, switching of input focus between objects, activation of a new mode, reaching or crossing an input threshold, detection or recognition of a type of input or gesture, etc. In some embodiments, tactile outputs are provided to serve as a warning or an alert for an impending event or outcome that would occur unless a redirection or interruption input is timely detected. Tactile outputs are also used in other contexts to enrich the user experience, improve the accessibility of the device to users with visual or motor difficulties or other accessibility needs, and/or improve efficiency and functionality of the user interface and/or the device. Tactile outputs are optionally accompanied with audio outputs and/or visible user interface changes, which further enhance a user's experience when the user interacts with a user interface and/or the device, and facilitate better conveyance of information regarding the state of the user interface and/or the device, and which reduce input errors and increase the efficiency of the user's operation of the device.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random-access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

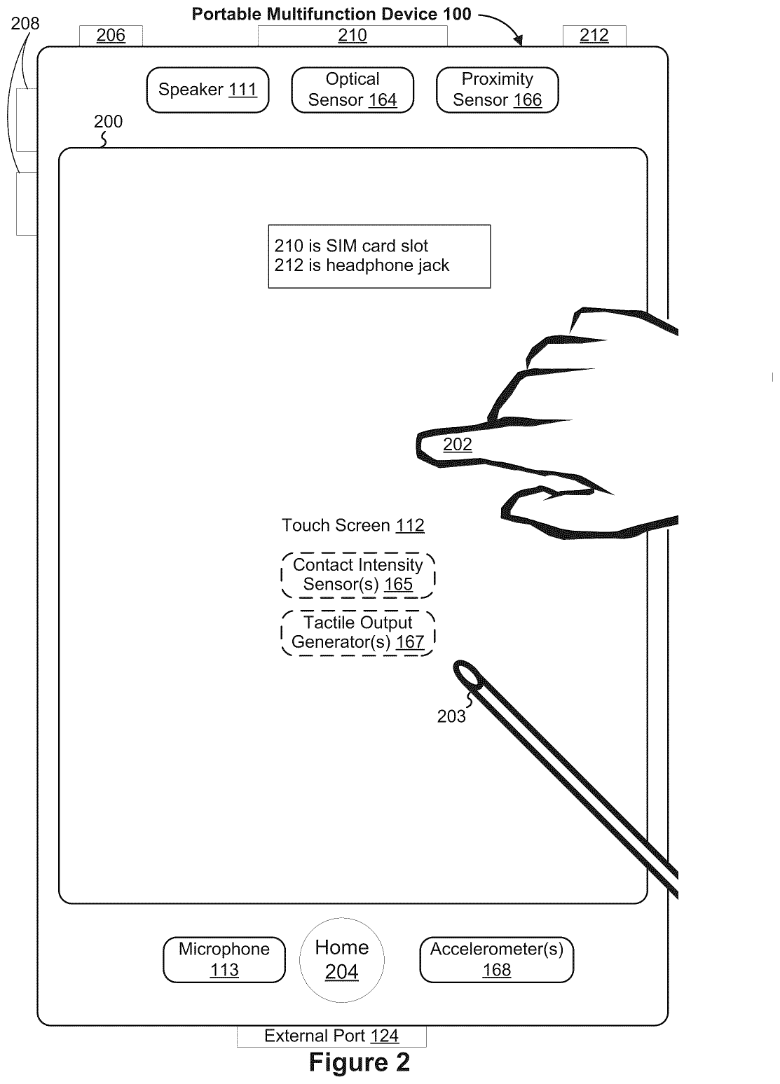

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, California.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164 (e.g., as part of one or more cameras). FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's car (e.g., when the user is making a phone call).

Device 100 optionally also includes one or more tactile output generators 167. FIG. 1A shows a tactile output generator coupled with haptic feedback controller 161 in I/O subsystem 106. In some embodiments, tactile output generator(s) 167 include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3A. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, California. In some embodiments, the external port is a Lightning connector that is the same as, or similar to and/or compatible with the Lightning connector used in some iPhone®, iPod Touch®, and iPad® devices from Apple Inc. of Cupertino, California. In some embodiments, the external port is a USB Type-C connector that is the same as, or similar to and/or compatible with the USB Type-C connector used in some electronic devices from Apple Inc. of Cupertino, California.

Contact/motion module 130 optionally detects contact with touch-sensitive display system 112 (in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

In some embodiments, detecting a finger tap gesture depends on the length of time between detecting the finger-down event and the finger-up event, but is independent of the intensity of the finger contact between detecting the finger-down event and the finger-up event. In some embodiments, a tap gesture is detected in accordance with a determination that the length of time between the finger-down event and the finger-up event is less than a predetermined value (e.g., less than 0.1, 0.2, 0.3, 0.4 or 0.5 seconds), independent of whether the intensity of the finger contact during the tap meets a given intensity threshold (greater than a nominal contact-detection intensity threshold), such as a light press or deep press intensity threshold. Thus, a finger tap gesture can satisfy particular input criteria that do not require that the characteristic intensity of a contact satisfy a given intensity threshold in order for the particular input criteria to be met. For clarity, the finger contact in a tap gesture typically needs to satisfy a nominal contact-detection intensity threshold, below which the contact is not detected, in order for the finger-down event to be detected. A similar analysis applies to detecting a tap gesture by a stylus or other contact. In cases where the device is capable of detecting a finger or stylus contact hovering over a touch sensitive surface, the nominal contact-detection intensity threshold optionally does not correspond to physical contact between the finger or stylus and the touch sensitive surface.

The same concepts apply in an analogous manner to other types of gestures. For example, a swipe gesture, a pinch gesture, a depinch gesture, and/or a long press gesture are optionally detected based on the satisfaction of criteria that are either independent of intensities of contacts included in the gesture, or do not require that contact(s) that perform the gesture reach intensity thresholds in order to be recognized. For example, a swipe gesture is detected based on an amount of movement of one or more contacts; a pinch gesture is detected based on movement of two or more contacts towards each other; a depinch gesture is detected based on movement of two or more contacts away from each other; and a long press gesture is detected based on a duration of the contact on the touch-sensitive surface with less than a threshold amount of movement. As such, the statement that particular gesture recognition criteria do not require that the intensity of the contact(s) meet a respective intensity threshold in order for the particular gesture recognition criteria to be met means that the particular gesture recognition criteria are capable of being satisfied if the contact(s) in the gesture do not reach the respective intensity threshold, and are also capable of being satisfied in circumstances where one or more of the contacts in the gesture do reach or exceed the respective intensity threshold. In some embodiments, a tap gesture is detected based on a determination that the finger-down and finger-up event are detected within a predefined time period, without regard to whether the contact is above or below the respective intensity threshold during the predefined time period, and a swipe gesture is detected based on a determination that the contact movement is greater than a predefined magnitude, even if the contact is above the respective intensity threshold at the end of the contact movement. Even in implementations where detection of a gesture is influenced by the intensity of contacts performing the gesture (e.g., the device detects a long press more quickly when the intensity of the contact is above an intensity threshold or delays detection of a tap input when the intensity of the contact is higher), the detection of those gestures does not require that the contacts reach a particular intensity threshold so long as the criteria for recognizing the gesture can be met in circumstances where the contact does not reach the particular intensity threshold (e.g., even if the amount of time that it takes to recognize the gesture changes).

Contact intensity thresholds, duration thresholds, and movement thresholds are, in some circumstances, combined in a variety of different combinations in order to create heuristics for distinguishing two or more different gestures directed to the same input element or region so that multiple different interactions with the same input element are enabled to provide a richer set of user interactions and responses. The statement that a particular set of gesture recognition criteria do not require that the intensity of the contact(s) meet a respective intensity threshold in order for the particular gesture recognition criteria to be met does not preclude the concurrent evaluation of other intensity-dependent gesture recognition criteria to identify other gestures that do have criteria that are met when a gesture includes a contact with an intensity above the respective intensity threshold. For example, in some circumstances, first gesture recognition criteria for a first gesture—which do not require that the intensity of the contact(s) meet a respective intensity threshold in order for the first gesture recognition criteria to be met—are in competition with second gesture recognition criteria for a second gesture—which are dependent on the contact(s) reaching the respective intensity threshold. In such competitions, the gesture is, optionally, not recognized as meeting the first gesture recognition criteria for the first gesture if the second gesture recognition criteria for the second gesture are met first. For example, if a contact reaches the respective intensity threshold before the contact moves by a predefined amount of movement, a deep press gesture is detected rather than a swipe gesture. Conversely, if the contact moves by the predefined amount of movement before the contact reaches the respective intensity threshold, a swipe gesture is detected rather than a deep press gesture. Even in such circumstances, the first gesture recognition criteria for the first gesture still do not require that the intensity of the contact(s) meet a respective intensity threshold in order for the first gesture recognition criteria to be met because if the contact stayed below the respective intensity threshold until an end of the gesture (e.g., a swipe gesture with a contact that does not increase to an intensity above the respective intensity threshold), the gesture would have been recognized by the first gesture recognition criteria as a swipe gesture. As such, particular gesture recognition criteria that do not require that the intensity of the contact(s) meet a respective intensity threshold in order for the particular gesture recognition criteria to be met will (A) in some circumstances ignore the intensity of the contact with respect to the intensity threshold (e.g. for a tap gesture) and/or (B) in some circumstances still be dependent on the intensity of the contact with respect to the intensity threshold in the sense that the particular gesture recognition criteria (e.g., for a long press gesture) will fail if a competing set of intensity-dependent gesture recognition criteria (e.g., for a deep press gesture) recognize an input as corresponding to an intensity-dependent gesture before the particular gesture recognition criteria recognize a gesture corresponding to the input (e.g., for a long press gesture that is competing with a deep press gesture for recognition).

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions (e.g., instructions used by haptic feedback controller 161) to produce tactile outputs using tactile output generator(s) 167 at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 313), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and video and music player module 152, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (in FIG. 1A) or 313 (FIG. 3A) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (arc) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher-level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event-to-event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 152. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In these embodiments, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display.

In some embodiments, device 100 includes the touch-screen display, menu button 204 (sometimes called home button 204), push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensities of contacts on touch-sensitive display system 112 and/or one or more tactile output generators 167 for generating tactile outputs for a user of device 100.

FIG. 3A is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 302, one or more network or other communications interfaces 312, memory 313, and one or more communication buses 303 for interconnecting these components. Communication buses 303 optionally include circuitry (sometimes called a chipset) that interconnects and controls communications between system components. Device 300 includes input/output (I/O) interface 304 comprising display 305, which is typically a touch-screen display. I/O interface 304 also optionally includes a keyboard and/or mouse (or other pointing device) 306 and touchpad 307, tactile output generator 308 for generating tactile outputs on device 300 (e.g., similar to tactile output generator(s) 167 described above with reference to FIG. 1A), sensors 309 (e.g., optical, acceleration, proximity, touch-sensitive, and/or contact intensity sensors similar to contact intensity sensor(s) 165 described above with reference to FIG. 1A), audio I/O logic 310, and/or wireless interface 311.

Memory 313 includes high-speed random-access memory, such as DRAM, SRAM, DDR RAM or other random-access solid-state memory devices; and optionally includes non-volatile memory, such as one or more magnetic disk storage devices, optical disk storage devices, flash memory devices, or other non-volatile solid state storage devices. Memory 313 optionally includes one or more storage devices remotely located from CPU(s) 302. In some embodiments, memory 313 stores programs, modules, and data structures analogous to the programs, modules, and data structures stored in memory 102 of portable multifunction device 100 (FIG. 1A), or a subset thereof. Furthermore, memory 313 optionally stores additional programs, modules, and data structures not present in memory 102 of portable multifunction device 100. For example, memory 313 of device 300 optionally stores drawing module 314, presentation module 315, word processing module 316, website creation module 317, disk authoring module 318, and/or spreadsheet module 319, while memory 102 of portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 313 optionally stores a subset of the modules and data structures identified above. Furthermore, memory 313 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API calling modules (e.g., including API-calling module 3180) that communicate with implementation module 3100. In some embodiments, API 3190 allows multiple API calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call docs), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 1000 (FIGS. 10A-10B), method 1100 (FIGS. 11A-11C), method 1200 (FIGS. 12A-12C), and/or method 1300 (FIGS. 13A-13C) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, a contact transfer API, a photos API, a camera API, and/or an image processing API.

In some embodiments, at least one API is a software module (e.g., a collection of computer-readable instructions) that provides an interface that allows a different module (e.g., an API calling module) to access and use one or more functions, methods, procedures, data structures, classes, and/or other services provided by an implementation module of the system process. The API can define one or more parameters that are passed between the API calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

FIG. 3H illustrates physical features of an example audio output device case 342 in accordance with some embodiments. In some embodiments, audio output device case 342 includes a lid 321 and a container 322. In some embodiments, audio output device case 342 includes one or more sensors to detect if lid 321 is opened, closed, and/or moving. In some embodiments, audio output device case 342 is configured to house and/or charge one or more electronic accessories, such as headphones and/or earbuds. Although FIG. 3H shows an audio output device case, in some other embodiments, the case is an electronic accessory case for one or more other types of electronic accessories, such as a smartwatch, an electronic stylus, or a fitness tracker. In some embodiments, audio output device case 342 includes display 372, indicator 325 (e.g., a light source (such as an LED indicator) or other type of indicator) and, optionally, one or more audio output devices (such as speaker(s)) (e.g., to provide status and/or event information to a user). In some embodiments, audio output device case 342 includes one or more input device(s), such as affordance 373 and input device 326 (e.g., a physical button, a touch-sensitive surface, or other type of input device). In some embodiments, audio output device case 342 includes one or more buttons, switches, dials, or other types of input devices not shown in FIG. 3H. In some embodiments, affordance 373 is a touch-sensitive surface (e.g., a touchscreen). In some embodiments, affordance 373 is a haptic button or a mechanical button. In some embodiments, audio output device case 342 includes one or more ports, such as wired connection port 323 (e.g., configured to transfer power, control signals, and/or data signals to and/or from audio output device case 342). In some embodiments, display 372 is a hidden display in which display 372 is visual indistinguishable from a housing of audio output device case 342 in certain lighting conditions. In some embodiments, portions of display 372 remain visually indistinguishable while other portions of display 372 display visual elements (e.g., dynamic visual elements).

FIG. 3I is a block diagram illustrating components of an audio output device case 342 in accordance with some embodiments. In some embodiments, audio output device case 342 a headphone case (e.g., a wireless headphone case). In some embodiments, audio output device case 342 an accessory charging case configured to charge one or more accessories while the accessories are positioned (e.g., mounted, inserted, and/or attached) to the accessory charging case. Audio output device case 342 includes memory 337 (which optionally includes one or more computer readable storage mediums), one or more processing units (CPUs) 328, and interface 330. In some embodiments, interface 330 includes display 331, camera 324, one or more output device(s) 332 (e.g., a speaker), one or more input devices 333 (e.g., one or more buttons, switches, and/or levers), one or more tactile output generator(s) 334, and one or more communication components 335 (e.g., a wireless interface) for communicating with devices such as one or more wearable audio output devices 301, and one or more electronic devices such as a smart phone, tablet, computer or the like. In some embodiments, interface 330 includes a set of LEDs and/or display elements (e.g., indicator 325) capable of displaying icons and/or other visual information. In some embodiments, tactile output generators 334 generate tactile outputs (also called haptic feedback), e.g., via an external case (also called a housing) of the audio output device case 342.

In accordance with some embodiments, audio output device case 342 includes an internal rechargeable battery 345 for providing power to the various components of audio output device case 342, as well as for charging the internal battery of one or more wearable audio output devices 301. In some embodiments, audio output device case 342 includes a battery charger 346 for charging internal battery 345 when battery charger 346 is connected to an external power source via a power connect port 347 (e.g., wired connection port 323). In some embodiments, the internal battery 345 and/or battery charger 346 are configured to charge the internal battery of an audio output device (e.g., headphone or earbud) when the audio output device is connected to (e.g., properly positioned in) an accessory charger 348. In some embodiments, audio output device case 342 includes auxiliary connector 349. These components optionally communicate over one or more communication buses or signal lines 329.

In some embodiments, audio output device case 342, when closed, has an extent (e.g., width or height) in a first dimension of between 1.5 and 3 inches, an extent (e.g., height or width) in a second dimension of between 1 and 2.5 inches, and an extent in a third dimension (e.g., depth) of between 0.5 and 1 inch.

In some embodiments, the software components stored in memory 337 include operating system 338 (or a BIOS), communication module (or set of instructions) 339, input module (or set of instructions) 340, graphics module (or set of instructions) 341, haptic feedback module (or set of instructions) 343, and headphone control module(s) 344. Furthermore, in some embodiments, memory 337 stores a device/global internal state 351, which includes one or more of: active application state, indicating which applications, if any, are currently active; and sensor state, including information obtained from the device's various sensors and other input devices 333.

FIG. 3J illustrates example audio control by a wearable audio output device 301 in accordance with some embodiments. While the following example is explained with respect to implementations that include a wearable audio output device having earbuds to which interchangeable eartips (sometimes called silicon eartips or silicon seals) are attached, the methods, devices and user interfaces described herein are equally applicable to implementations in which the wearable audio output devices do not have eartips, and instead each have a portion of the main body shaped for insertion in the user's ears. In some embodiments, when a wearable audio output device having earbuds to which interchangeable eartips may be attached are worn in a user's ears, the earbuds and eartips together act as physical barriers that block at least some ambient sound from the surrounding physical environment from reaching the user's ear. For example, in FIG. 3J, wearable audio output device 301 is worn by a user such that head portion 353 and eartip 356 are in the user's left ear. Eartip 356 extends at least partially into the user's ear canal. Preferably, when head portion 353 and eartip 356 are inserted into the user's ear, a seal is formed between eartip 356 and the user's ear so as to isolate the user's ear canal from the surrounding physical environment. However, in some circumstances, head portion 353 and eartip 356 together block some, but not necessarily all, of the ambient sound in the surrounding physical environment from reaching the user's ear. Accordingly, in some embodiments, a first microphone (or, in some embodiments, a first set of one or more microphones) 352-1 is located on wearable audio output device 301 so as to detect ambient sound, represented by waveform 358, in region 354 of a physical environment surrounding (e.g., outside of) head portion 353. In some embodiments, a second microphone (or, in some embodiments, a second set of one or more microphones) 352-2 is located on wearable audio output device 301 so as to detect any ambient sound, represented by waveform 359, that is not completely blocked by head portion 353 and eartip 356 and that can be heard in region 357 inside the user's ear canal. Accordingly, in some circumstances in which wearable audio output device 301 is not producing a noise-cancelling (also called “antiphase”) audio signal to cancel (e.g., attenuate) ambient sound from the surrounding physical environment, as indicated by waveform 360-1, ambient sound waveform 359 is perceivable by the user, as indicated by waveform 362-1. In some circumstances in which wearable audio output device 301 is producing an antiphase audio signal to cancel ambient sound, as indicated by waveform 360-2, ambient sound waveform 359 is not perceivable by the user, as indicated by waveform 362-2.

In some embodiments, ambient sound waveform 358 is compared to attenuated ambient sound waveform 359 (e.g., by wearable audio output device 301 or a component of wearable audio output device 301, or by an electronic device that is in communication with wearable audio output device 301) to determine the passive attenuation provided by wearable audio output device 301. In some embodiments, the amount of passive attenuation provided by wearable audio output device 301 is taken into account when providing the antiphase audio signal to cancel ambient sound from the surrounding physical environment. For example, antiphase audio signal waveform 360-2 is configured to cancel attenuated ambient sound waveform 359 rather than unattenuated ambient sound waveform 358.

In some embodiments, wearable audio output device 301 is configured to operate in one of a plurality of available audio output modes, such as an active noise control audio output mode, an active pass-through audio output mode, and a bypass audio output mode (also sometimes called a noise control off audio output mode). In the active noise control mode (also called “ANC”), wearable audio output device 301 outputs one or more audio-cancelling audio components (e.g., one or more antiphase audio signals, also called “audio-cancelation audio components”) to at least partially cancel ambient sound from the surrounding physical environment that would otherwise be perceivable to the user. In the active pass-through audio output mode, wearable audio output device 301 outputs one or more pass-through audio components (e.g., plays at least a portion of the ambient sound from outside the user's ear, received by microphone 352-1, for example) so that the user can hear a greater amount of ambient sound from the surrounding physical environment than would otherwise be perceivable to the user (e.g., a greater amount of ambient sound than would be audible with the passive attenuation of wearable audio output device 301 placed in the user's ear). In the bypass mode, active noise management is turned off, such that wearable audio output device 301 outputs neither any audio-cancelling audio components nor any pass-through audio components (e.g., such that any amount of ambient sound that the user perceives is due to physical attenuation by wearable audio output device 301).

FIG. 3K illustrates light interaction with audio output device case 342 in accordance with some embodiments. As shown in FIG. 3K, light 382 incident on a portion 383 of display 372 has a corresponding reflection angle as indicated by reflection arrow 384. FIG. 3K further shows light 385 incident on portion 386 of the housing of audio output device case 342. Light 385 incident on portion 386 has a corresponding reflection angle as indicated by reflection arrow 387. In accordance with some embodiments, the reflection angle at portion 383 is the same as the reflection angle at portion 386 (e.g., making the display 372 substantially indistinguishable from the housing of audio output device case 342).

FIG. 3L illustrates illumination layer 392 separated from exterior 391 of display 372 by diffusion layer 390 in accordance with some embodiments. In some embodiments, display 372 includes illumination layer 392, diffusion layer 390, and, optionally, one or more additional layers. In some embodiments, display 372 includes a bandpass layer that only allows a predefined wavelength to pass through. In some embodiments, display 372 includes a molded fiber plate material which is in contact with exterior 391. In some embodiments, illumination layer 392 is composed of a plurality of light sources (e.g., point light sources). Diffusion layer 390 is an optical diffuser (e.g., adapted to scatter light in a variety of directions). Scattering light in a variety of directions can decrease the perceived sharpness of the display 372. In some embodiments, display 372 is directly behind exterior 391 such that display 372 is in contact exterior 391. In some embodiments, display 372 is configured to display dynamic visual elements, such as music icon 388. In some embodiments, exterior 391 collimates the light emission from illumination layer 392.

Attention is now directed towards embodiments of user interfaces (“UI”) that are, optionally, implemented on portable multifunction device 100.

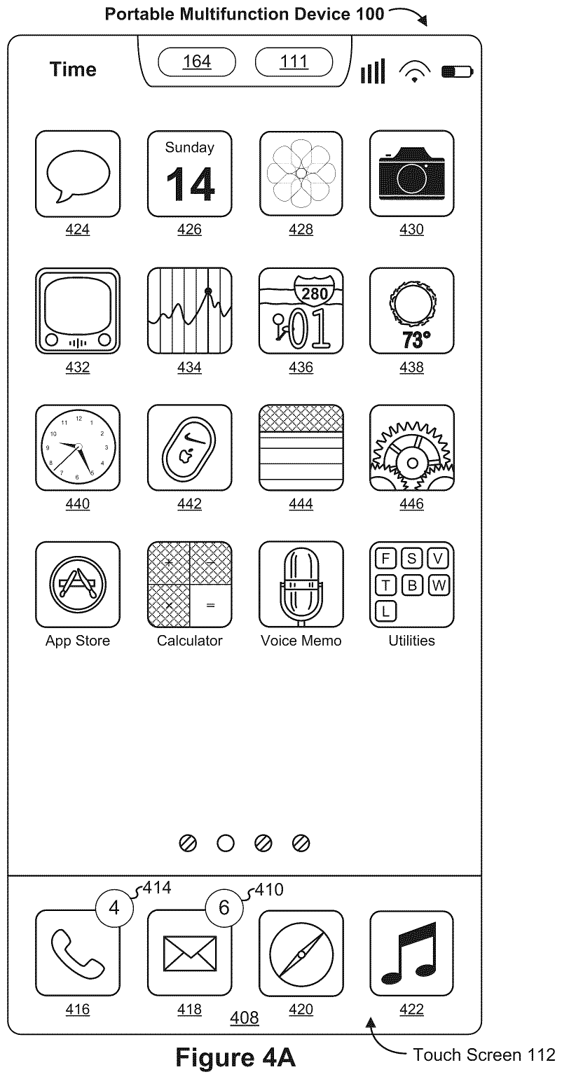

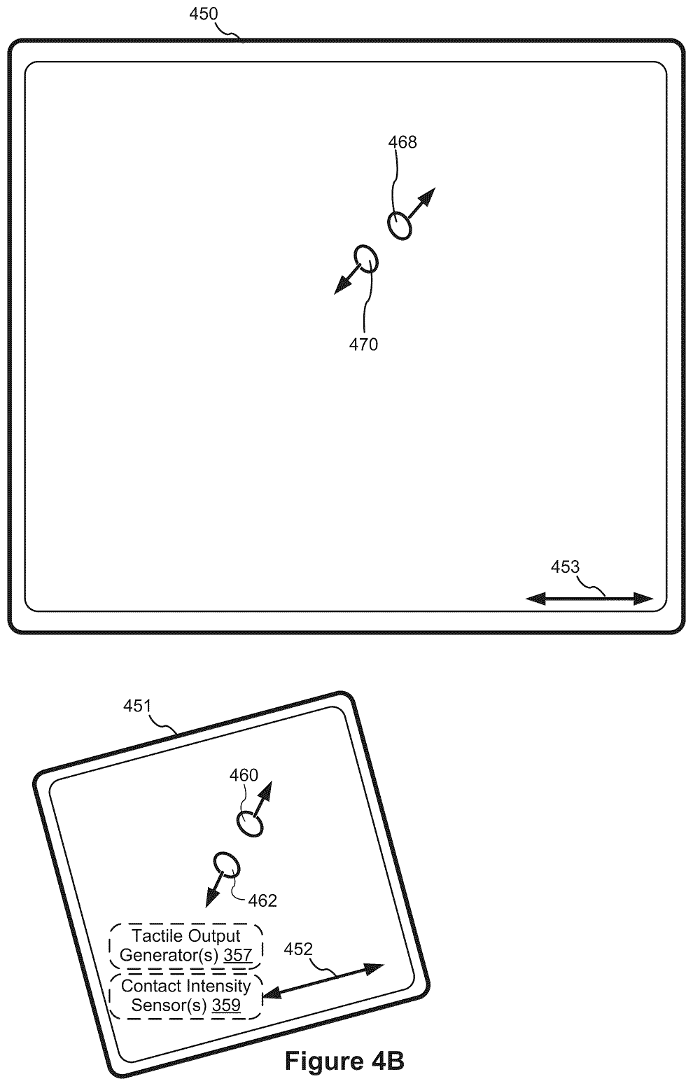

FIG. 4A illustrates an example user interface for a menu of applications on portable multifunction device 100 in accordance with some embodiments. Similar user interfaces are, optionally, implemented on device 300. In some embodiments, the user interface includes the following elements, or a subset or superset thereof:
Signal strength indicator(s) for wireless communication(s), such as cellular and Wi-Fi signals;
Time;
a Bluetooth indicator;
a Battery status indicator;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, labeled “Music”; and
Icons for other applications, such as:
   Icon 424 for IM module 141, labeled “Messages”;
   Icon 426 for calendar module 148, labeled “Calendar”;
   Icon 428 for image management module 144, labeled “Photos”;
   Icon 430 for camera module 143, labeled “Camera”;
   Icon 432 for online video module 155, labeled “Online Video”;
   Icon 434 for stocks widget 149-2, labeled “Stocks”;
   Icon 436 for map module 154, labeled “Maps”;
   Icon 438 for weather widget 149-1, labeled “Weather”;
   Icon 440 for alarm clock widget 149-4, labeled “Clock”;
   Icon 442 for workout support module 142, labeled “Workout Support”;
   Icon 444 for notes module 153, labeled “Notes”; and
   Icon 446 for a settings application or module, which provides access to settings for device 100 and its various applications 136.

It should be noted that the icon labels illustrated in FIG. 4A are merely examples. For example, other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3A) with a touch-sensitive surface 451 (e.g., a tablet or touchpad 355, FIG. 3A) that is separate from the display 450. Although many of the examples that follow will be given with reference to inputs on touch screen displays (e.g., touch screen display 112) (where the touch sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse-based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used in the specification and claims, the term “intensity” of a contact on a touch-sensitive surface refers to the force or pressure (force per unit area) of a contact (e.g., a finger contact or a stylus contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average or a sum) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be readily accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, a value produced by low-pass filtering the intensity of the contact over a predefined period or starting at a predefined time, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds may include a first intensity threshold and a second intensity threshold. In this example, a contact with a characteristic intensity that does not exceed the first intensity threshold results in a first operation, a contact with a characteristic intensity that exceeds the first intensity threshold and does not exceed the second intensity threshold results in a second operation, and a contact with a characteristic intensity that exceeds the second intensity threshold results in a third operation. In some embodiments, a comparison between the characteristic intensity and one or more intensity thresholds is used to determine whether or not to perform one or more operations (e.g., whether to perform a respective option or forgo performing the respective operation) rather than being used to determine whether to perform a first operation or a second operation.

In some embodiments, a portion of a gesture is identified for purposes of determining a characteristic intensity. For example, a touch-sensitive surface may receive a continuous swipe contact transitioning from a start location and reaching an end location (e.g., a drag gesture), at which point the intensity of the contact increases. In this example, the characteristic intensity of the contact at the end location may be based on only a portion of the continuous swipe contact, and not the entire swipe contact (e.g., only the portion of the swipe contact at the end location). In some embodiments, a smoothing algorithm may be applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

In some embodiments, the response of the device to inputs detected by the device depends on criteria based on the contact intensity during the input. For example, for some “light press” inputs, the intensity of a contact exceeding a first intensity threshold during the input triggers a first response. In some embodiments, the response of the device to inputs detected by the device depends on criteria that include both the contact intensity during the input and time-based criteria. For example, for some “deep press” inputs, the intensity of a contact exceeding a second intensity threshold during the input, greater than the first intensity threshold for a light press, triggers a second response only if a delay time has elapsed between meeting the first intensity threshold and meeting the second intensity threshold. This delay time is typically less than 200 ms (milliseconds) in duration (e.g., 40, 100, or 120 ms, depending on the magnitude of the second intensity threshold, with the delay time increasing as the second intensity threshold increases). This delay time helps to avoid accidental recognition of deep press inputs. As another example, for some “deep press” inputs, there is a reduced-sensitivity time period that occurs after the time at which the first intensity threshold is met. During the reduced-sensitivity time period, the second intensity threshold is increased. This temporary increase in the second intensity threshold also helps to avoid accidental deep press inputs. For other deep press inputs, the response to detection of a deep press input does not depend on time-based criteria.

In some embodiments, one or more of the input intensity thresholds and/or the corresponding outputs vary based on one or more factors, such as user settings, contact motion, input timing, application running, rate at which the intensity is applied, number of concurrent inputs, user history, environmental factors (e.g., ambient noise), focus selector position, and the like. Example factors are described in U.S. patent application Ser. Nos. 14/399,606 and 14/624,296, which are incorporated by reference herein in their entireties.

### User Interfaces and Associated Processes

Attention is now directed towards embodiments of user interfaces (“UI”) and associated processes that may be implemented on an electronic device, such as portable multifunction device 100, device 300, wearable audio output devices 301, and/or audio output device case 342.

FIGS. 5A-5T illustrate example user interfaces and user interactions involving audio output devices and audio output device cases in accordance with some embodiments. FIGS. 6A-6R illustrate example user interfaces and user interactions for communicatively coupling audio output devices in accordance with some embodiments. FIGS. 7A-7F illustrate example user interfaces and user interactions with an audio output device case in accordance with some embodiments. FIGS. 8A-8D illustrate example user interfaces and user interactions with a camera and an audio output device case in accordance with some embodiments. FIGS. 9A-9O illustrate example user interfaces and user interactions with an audio output device case in accordance with some embodiments. The user interfaces and user interactions in these figures are used to illustrate the processes described below, including the processes in FIGS. 10A-10B, 11A-11C, 12A-12C, and 13A-13C. For convenience of explanation, some of the embodiments will be discussed with reference to operations performed on a device with a touch-sensitive display system. However, analogous operations are, optionally, performed on a device with a display 450 and a separate touch sensitive surface 451 in response to detecting the contacts on the touch-sensitive surface 451 while displaying the user interfaces shown in the figures on the display 450, along with a focus selector.

FIGS. 5A-5T illustrate example user interfaces and user interactions involving audio output devices 301 and audio output device case 342 in accordance with some embodiments. FIG. 5A shows audio source 502 (e.g., a record player, a television, or other type of audio source). In some embodiments, audio source 502 is an audiovisual source (e.g., includes a display component) configured to playback audiovisual media (e.g., a video or image with corresponding audio). In some embodiments, audio source 502 does not include a speaker or other audio output component. In some embodiments, audio source 502 does not have wireless capabilities (e.g., does not include a wireless radio or antenna) for output audio data, as indicated by element 506. In some embodiments, audio source 502 includes wireless capabilities, but is prohibited from wirelessly connecting to wearable audio output devices 301 (e.g., due to wearable audio output devices 301 having insufficient permissions and/or incompatible wireless capabilities). In accordance with some embodiments, audio source 502 includes port 504, icon 508 (e.g., in state 508-a showing a play symbol in FIG. 5A), and icon 510 (e.g., showing a stop symbol). FIG. 5A further shows audio output device case 342 communicatively coupled to wearable audio output devices 301, as indicated by dotted-dashed lines 512. Although FIG. 5A shows wearable audio output devices 301 being earbuds and audio output device case 342 being an earbud case, in some other embodiments, wearable audio output devices 301 are a headset or headphones and audio output device case 342 is a headset and/or headphone case.

In some embodiments, communicatively coupling a first device (e.g., the audio output device case 342) and a second device (e.g., the wearable audio output devices 301) comprises establishing a wired or wireless connection between the first device case and the second device. In some embodiments, the first device and the second device are communicatively coupled via a direct connection, while in other embodiments, the first device and the second device are communicatively coupled via one or more communication networks (e.g., a public broadcast network). For example, communicatively coupling the first and second devices may include forming a wireless peer-to-peer connection (e.g., a direct Wi-Fi connection). In some embodiments, communicatively coupling the first device and the second device comprises pairing the first device and the second device (e.g., exchanging information between the first device and the second device that enable the first device and the second device to communicate with each other). In some embodiments, communicatively coupling the first device and the second device comprises forming an audio path between the first device and the second device. In some embodiments, communicatively coupling the first device and the second device comprises establishing one or more wireless connections and/or one or more wired connections between the first device and the second device. In some embodiments, the first and second devices are communicatively coupled using one or more communication protocols (e.g., a Wi-Fi protocol, a Bluetooth protocol, and/or other type of communication protocol). In some embodiments, the first and second devices are communicatively coupled using respective radio components (e.g., the RF circuitry 108).

FIG. 5B shows cable 516 connecting to port 504 of audio source 502 and to wired connection port 323 of audio output device case 342. In some embodiments, port 504 is a 3.5 mm connector port or an auxiliary-in connector port. In some embodiments, cable 516 includes one or more electronic components, such as an analog-to-digital converter to convert an analog signal from audio source 502 to a digital signal for audio output device case 342.

FIG. 5C shows cable 516 connecting audio source 502 with audio output device case 342. In the example of FIG. 5C, audio data 520 is transmitted via cable 516 to audio output device case 342. In some embodiments, audio data 520 is transmitted in response to cable 516 connecting audio source 502 with audio output device case 342 (e.g., automatically and without further user input). In some embodiments, audio data 520 is transmitted in accordance with an operating state of audio source 502, an operating state of audio output device case 342, and/or an operating state of wearable audio output devices 301. For example, in accordance with audio source 502 being in a paused state prior to connecting cable 516, audio data is transmitted in response to connecting cable 516. In this example, in accordance with audio source 502 being in an off state prior to connecting cable 516, audio data is not transmitted in response to connecting cable 516. FIG. 5C also shows audio data 522 being transmitted from audio output device case 342 to wearable audio output devices 301, and wearable audio output devices 301 outputting corresponding audio 524. In some embodiments, audio data 522 is the same as audio data 520 (e.g., audio output device case 342 forwards audio data 520 to wearable audio output devices 301 as audio data 522). In some embodiments, audio data 522 is derived from audio data 520 (e.g., one or more filters or modifications are applied to audio data 520 to derive audio data 522). In some embodiments, audio output device case 342 transcodes, filters, and/or otherwise modifies audio data 520 to generate audio data 522. FIG. 5C further shows icon 508 of audio source 502 in a state 508-b showing a pause symbol to indicate that audio is playing at audio source 502, and input 526 being detected at icon 508 (e.g., icon 508 corresponds to a touch-sensitive surface, a physical button with a display, or other type of input device).

FIG. 5D illustrates a transition from FIG. 5C in response to input 526. In FIG. 5D, audio source 502 has ceased to transmit audio data 520 to audio output device case 342 (e.g., playback of audio media at audio source 502 has paused in response to input 526 as indicated by icon 508 being in state 508-a). FIG. 5D shows audio source 502 providing power 528 to audio output device case 342. In accordance with some embodiments, port 504 is capable of transmitting audio data and power to a connected device. In accordance with some embodiments, wired connection port 323 of audio output device case 342 is configured to receive power and/or audio data (e.g., via a cable such as cable 516). FIG. 5D further shows audio output device case 342 displaying icon 530 on display 372 indicating that audio output device case 342 is charging. In some embodiments, icon 530 indicates a current charge level of audio output device case 342. In some embodiments, audio output device case 342 indicating that it is receiving power via one or more output devices other than display 372 (e.g., via indicator 325). Wearable audio output devices 301 may also be charged by (e.g., receive power from) audio source 502, as indicated by power symbols 517 in FIG. 5D. For example, wearable audio output devices 301 are charged while mounted or inserted in audio output device case 342. In some embodiments, power from audio source 502 charges an internal battery (e.g., battery 345) of audio output device case 342 (e.g., and the internal battery of audio output device case 342 is used to charge wearable audio output devices 301).

FIG. 5E shows audio output device case 342 receiving power from audio source 502 via cable 516. FIG. 5E also shows input 532 detected at icon 508 of audio source 502. For example, input 532 may be a tap input, a button press, or other type of input gesture. FIG. 5F shows a transition from FIG. 5E in response to input 532. In FIG. 5F, audio source 502 is providing audio data 520 and power 528 to audio output device case 342. Icon 508 is in state 508-b in FIG. 5F, indicating that audio source 502 is playing back audio content. Audio output device case 342 is charging in FIG. 5F as indicated by icon 530 and is providing audio data 522 to wearable audio output devices 301. FIG. 5F also shows wearable audio output devices 301 outputting audio 524 corresponding to audio data 522. In the example of FIGS. 5D-5F, audio output device case 342 is configured to receive power and/or data (e.g., audio data) via wired connection port 323.

FIG. 5G shows audio source 502 connected to audio output device case 342 via cable 516. FIG. 5G further shows audio source 502 providing audio data 520 (e.g., music, spoken audio, and/or other types of audio data) to audio output device case 342. In the example of FIG. 5G, audio output device case 342 is not transmitting audio data 520 or corresponding audio data (e.g., audio data 522) in response to receiving audio data 520. Audio output device case 342 in FIG. 5G is displaying playback icon 533 on display 372, indicating that audio playback is paused. FIG. 5G further shows input 534 detected at a location that corresponds to playback icon 533. In some embodiments, display 372 is a touch-screen display and icon 533 is an activatable element displayed on display 372. For example, input 534 may be a tap input, a press input, a double tap input, or other type of input.

FIG. 5H shows a transition from FIG. 5G in response to input 534. In FIG. 5H audio output device case 342 is providing audio data 522 corresponding to audio data 520 to wearable audio output devices 301. FIG. 5H shows wearable audio output devices 301 outputting audio 524 corresponding to audio data 522. In FIG. 5H, audio output device case 342 displays icon 536 (e.g., a pause element) on display 372. In this way, audio output device case 342 causes audio playback to begin, or resume, at wearable audio output devices 301 in response to input 534.

FIG. 5I shows audio source 502 connected to audio output device case 342 via cable 516. FIG. 5I further shows audio source 502 providing audio data 520 to audio output device case 342. In the example of FIG. 5I, audio output device case 342 is not transmitting audio data 520 or corresponding audio data (e.g., audio data 522) in response to receiving audio data 520. FIG. 5I also shows device 100 communicatively coupled to audio output device case 342, as indicated by dotted-dashed line 538. In some embodiments, device 100 is communicatively coupled to wearable audio output devices 301 (e.g., in addition to, or alternatively to, being coupled to audio output device case 342). Device 100 in FIG. 5I displays a playback icon 540. FIG. 5I further shows input 542 detected at a location that corresponds to playback icon 540.

FIG. 5J shows a transition from FIG. 5I in response to input 542. In FIG. 5J audio output device case 342 is providing audio data 522 corresponding to audio data 520 to wearable audio output devices 301. FIG. 5J shows wearable audio output devices 301 outputting audio 524 corresponding to audio data 522. In FIG. 5J, device 100 displays icon 544 (e.g., a pause element). In this way, device 100 causes audio playback to begin, or resume, at wearable audio output devices 301 in response to input 542. In some embodiments, device 100 transmits a command directly to audio output device case 342 to begin or resume playback at wearable audio output devices 301. In some embodiments, device 100 transmits a playback command to wearable audio output devices 301 and wearable audio output devices 301 relay the playback command to audio output device case 342.

FIG. 5K shows audio output device case 342 communicatively coupled to wearable audio output devices 301, as indicated by dotted-dashed line 512, and communicatively coupled to audio source 502 via cable 516. FIG. 5K further shows device 300 (e.g., a smartwatch) communicatively coupled to audio output device case 342. Wearable audio output devices 301 in FIG. 5K are communicatively coupled to device 100, as indicated by dotted-dashed line 545, and communicatively coupled to audio output device case 342, as indicated by dotted-dashed line 512. In the example of FIG. 5K, wearable audio output devices 301 are receiving audio data 546 (e.g., music, spoken audio, and/or other types of audio data) from device 100 and are outputting audio 548 corresponding to audio data 546. Thus, in FIG. 5K, wearable audio output devices 301 are concurrently coupled to device 100 and audio output device case 342. Device 300 in FIG. 5K displays icon 562 corresponding to device 100 and icon 564 corresponding to audio source 502. In some embodiments, icon 564 indicates audio output device case 342 (e.g., instead of audio data 522). Device 300 further displays indicator 566 indicating that audio from device 100 is currently being output by wearable audio output devices 301 (e.g., device 100 is the selected audio source for audio playback). FIG. 5K further shows input 568 detected at a location that corresponds to icon 564.

FIG. 5L shows a transition from FIG. 5K in response to input 568. In FIG. 5L audio output device case 342 is providing audio data 522 corresponding to audio data 520 to wearable audio output devices 301. Device 300 in FIG. 5L displays indicator 570 indicating that audio 524 corresponding to audio source 502 is currently being output by wearable audio output devices 301 (e.g., audio source 502 is the selected audio source for audio playback). Device 100 in FIG. 5L displays icon 571 indicating that playback of audio content has stopped. In some embodiments, wearable audio output devices 301 transmit an indication to device 100 to indicate that device 100 is no longer the selected and/or active audio source. In some embodiments, device 300 transmits a playback command to audio output device case 342 in response to input 568.

FIG. 5M shows audio output device case 342 communicatively coupled to wearable audio output devices 301 and communicatively coupled to audio source 502 via cable 516. Wearable audio output devices 301 in FIG. 5M are communicatively coupled to device 100, as indicated by dotted-dashed line 545, and communicatively coupled to audio output device case 342, as indicated by dotted-dashed line 512. In the example of FIG. 5M, wearable audio output devices 301 are receiving audio data 546 from device 100 and are outputting audio 548 corresponding to audio data 546. Thus, in FIG. 5M, wearable audio output devices 301 are concurrently coupled to device 100 and audio output device case 342. Audio output device case 342 in FIG. 5M displays icon 572 corresponding to device 100 and icon 574 corresponding to audio source 502. Audio output device case 342 further displays indicator 576 indicating that audio from device 100 is currently being output by wearable audio output devices 301 (e.g., device 100 is the selected audio source for audio playback). Thus, in the example of FIG. 5M, audio output device case 342 receives audio data 520 from audio source 502, but does not transmit corresponding audio data to wearable audio output devices 301. FIG. 5M further shows input 578 detected at a location that corresponds to icon 574.

FIG. 5N shows a transition from FIG. 5M in response to input 578. In FIG. 5N audio output device case 342 is providing audio data 522 corresponding to audio data 520 to wearable audio output devices 301. Audio output device case 342 in FIG. 5N displays indicator 580 indicating that audio 524 corresponding to audio source 502 is currently being output by wearable audio output devices 301 (e.g., audio source 502 is the selected audio source for audio playback). Device 100 in FIG. 5N displays icon 571 indicating that playback of audio content has stopped.

FIG. 5O shows audio output device case 342 communicatively coupled to wearable audio output devices 301 and communicatively coupled to audio source 502 via cable 516. Wearable audio output devices 301 in FIG. 5O are communicatively coupled to device 100, as indicated by dotted-dashed line 545, and communicatively coupled to audio output device case 342, as indicated by dotted-dashed line 512. In the example of FIG. 5O, wearable audio output devices 301 are receiving audio data 546 from device 100 and are outputting audio 548 corresponding to audio data 546. Device 100 in FIG. 5O is displaying music icon 582, indicating that musical content is being played back. Thus, in FIG. 5O, wearable audio output devices 301 are concurrently coupled to device 100 and audio output device case 342. Audio source 502 in FIG. 5O is not outputting audio data (e.g., audio playback is paused or stopped), as indicated by icon 508 in state 508-a. FIG. 5O further shows input 584 detected at a location that corresponds to icon 508.

FIG. 5P shows a transition from FIG. 5O in response to input 584. In FIG. 5P audio source 502 is providing audio data 520 to audio output device case 342, as indicated by icon 508 being in state 508-b. Audio output device case 342 is providing audio data 522 corresponding to audio data 520 to wearable audio output devices 301. Device 100 in FIG. 5P displays icon 586 indicating that playback of audio content has stopped. Thus, in the example of FIGS. 50 and 5P, input 584 at audio source 502 causes audio 524 corresponding to audio data 522 to be played back at wearable audio output devices 301 (e.g., switching the active audio source from device 100 to audio source 502).

FIG. 5Q shows audio output device case 342 communicatively coupled to wearable audio output devices 301 and communicatively coupled to audio source 502 via cable 516. Wearable audio output devices 301 in FIG. 5Q are communicatively coupled to device 100 and communicatively coupled to audio output device case 342, as indicated by dotted-dashed line 512. In the example of FIG. 5Q, wearable audio output devices 301 are receiving audio data 546 from device 100 and are outputting audio 548 corresponding to audio data 546. Thus, in FIG. 5Q, wearable audio output devices 301 are concurrently coupled to device 100 and audio output device case 342. In the example of FIG. 5Q, audio output device case 342 receives audio data 520 from audio source 502, but does not transmit corresponding audio data to wearable audio output devices 301. FIG. 5Q further shows input 588 detected at wearable audio output devices 301. For example, input 588 may be a tap input, a deep press input, a squeeze input, a double tap input, a swipe input, or other type of input.

FIG. 5R shows a transition from FIG. 5Q in response to input 588. In FIG. 5R audio output device case 342 is providing audio data 522 corresponding to audio data 520 to wearable audio output devices 301. Wearable audio output devices 301 are outputting audio 524 corresponding to audio data 522. Device 100 in FIG. 5R displays icon 586 indicating that playback of audio content has stopped.

FIG. 5S shows wearable audio output devices 301 communicatively coupled to audio source 502, as indicated by dotted-dashed line 594. In the example of FIG. 5S, audio source 502 is configured for wireless communication using a first wireless protocol, as indicated by “wireless connection 1.0” label 590. For example, the first wireless protocol may be an older protocol that has a higher latency than newer protocols such as the second wireless protocol. Audio source 502 is transmitting audio data 596 to wearable audio output devices 301 in FIG. 5S. Example wireless protocols include Wi-Fi (e.g., IEEE 802.11a, IEEE 802.11ac, IEEE 802.11ax, IEEE 802.11b, IEEE 802.11g and/or IEEE 802.11n) and Bluetooth (e.g., IEEE 802.15.1-2002, IEEE 802.15.1-2005, Bluetooth v3.0, Bluetooth Low Energy (BLE), and/or Bluetooth v5.0) protocols. In some embodiments, the first wireless protocol is an earlier version of a same protocol as the second wireless protocol. For example, the first wireless protocol may be IEEE 802.11a and the second wireless protocol may be IEEE 802.11n). Wearable audio output devices 301 are configured for wireless communication using a second wireless protocol, as indicated by “wireless connection 5.0” label 592 (e.g., which is backwards compatible with the first wireless protocol). In the example of FIG. 5S, audio data 596 has a relatively high associated latency, as indicated by latency 5100-a, due to audio source 502 using the first wireless protocol.

FIG. 5T shows cable 516 connecting audio source 502 with audio output device case 342. In the example of FIG. 5T, audio data 520 is transmitted via cable 516 to audio output device case 342. FIG. 5T also shows audio data 522 being transmitted from audio output device case 342 to wearable audio output devices 301, and wearable audio output devices 301 outputting corresponding audio 524. FIG. 5T further shows audio data 520 has a relatively low associated latency, as indicated by latency 5100-b, due to cable 516 having a low transmission delay and audio output device case 342 being communicatively coupled to wearable audio output devices 301 using the second wireless protocol. Thus, FIGS. 5S and 5T illustrate an example in which a wired connection through audio output device case 342 is lower latency than a wireless connection between audio source 502 and wearable audio output devices 301.

FIGS. 6A-6R illustrate example user interfaces and user interactions for communicatively coupling audio output devices in accordance with some embodiments. FIG. 6A shows set of devices 601-1 including device 100, wearable audio output devices 301-1, and audio output device case 342-1 communicatively coupled to one another, as indicated by dotted-dashed lines 602 and 604. FIG. 6A further shows set of devices 601-2 including wearable audio output devices 301-2 and audio output device case 342-2 communicatively coupled to one another, as indicated by dotted-dashed line 610. In the example of FIG. 6A, set of devices 601-1 belong to a user named Austin and set of devices 601-2 belong to a user named Anthony. In FIG. 6A, device 100 is outputting audio data 608 (e.g., musical audio data as indicated by icon 607) to wearable audio output devices 301-1.

FIG. 6A shows audio output device case 342-1 displaying user interface 611-1 (e.g., on display 372 of audio output device case 342-1). Similarly, audio output device case 342-2 is displaying user interface 611-2 (e.g., on display 372 of audio output device case 342-2). User interface 611-1 in FIG. 6A indicates that audio output device case 342-1 is aware of wearable audio output devices 301-2 being in proximity (e.g., within a threshold distance of one another and/or connected to a same local network). In some embodiments, audio output device case 342-1 detects wearable audio output devices 301-2 broadcasting their presence (e.g., via a wireless signal). Similarly, user interface 611-2 in FIG. 6A indicates that audio output device case 342-2 is aware of wearable audio output devices 301-1 being in proximity. FIG. 6A further shows arrows 614 indicating that audio output device cases 342 are moving toward one another (e.g., being brought together). Arrow 614-1 indicates that audio output device case 342-1 is moving toward audio output device case 342-2 and arrow 614-2 indicates that audio output device case 342-2 is moving toward audio output device case 342-1. In some embodiments, only one of audio output device cases 342 moves toward the other.

FIG. 6B shows audio output device cases 342 being brought into contact with one another. For example, audio output device cases 342 are brought together as a result of the movement indicated by arrows 614 in FIG. 6A. In the example of FIG. 6B, in response to audio output device cases 342 being brought together, wearable audio output devices 301-2 are communicatively coupled to wearable audio output devices 301-1. In accordance with some embodiments, wearable audio output devices 301-2 are coupled to wearable audio output devices 301-1 via audio output device cases 342. Audio data 608 from device 100 is transmitted to wearable audio output devices 301-1. Wearable audio output devices 301-1 transmit corresponding audio data 620 to audio output device case 342-1. In some embodiments, audio data 620 is the same as audio data 608 (e.g., wearable audio output device 301-1 forwards audio data 608 to audio output device case 342-1). In some embodiments, audio data 620 is derived from audio data 608 (e.g., is filtered, transcoded, or otherwise derived from audio data 608). Audio output device case 342-1 transmits audio data 622 corresponding to audio data 620 to audio output device case 342-2. In some embodiments, audio data 622 is the same as audio data 620 (e.g., audio output device case 342-1 forwards audio data 620 to audio output device case 342-2). In some embodiments, audio data 622 is derived from audio data 620 (e.g., is filtered, transcoded, or otherwise derived from audio data 620). Audio output device case 342-2 transmits audio data 624 corresponding to audio data 622 to wearable audio output devices 301-2. In some embodiments, audio data 624 is the same as audio data 622 (e.g., audio output device case 342-2 forwards audio data 622 to wearable audio output devices 301-2). In some embodiments, audio data 624 is derived from audio data 622 (e.g., is filtered, transcoded, or otherwise derived from audio data 622). In this way, wearable audio output devices 301-2 are communicatively coupled to wearable audio output devices 301-1 (e.g., to share audio content from device 100).

FIG. 6C shows wearable audio output devices 301-1 communicatively coupled to audio output device case 342-1, as indicated by dotted-dashed line 604, and wearable audio output devices 301-2 communicatively coupled to audio output device case 342-2, as indicated by dotted-dashed line 610. FIG. 6C further shows feedback 626 output by audio output device case 342-1 and feedback 628 output by audio output device case 342-2. In some embodiments, feedback 626 and/or 628 comprises audio feedback and/or haptic feedback. In accordance with some embodiments, feedback 626 and 628 indicate that wearable audio output devices 301-1 and 301-2 are in proximity with one another and/or are available for communicatively coupling with one another. FIG. 6C also shows arrows 630 indicating that audio output device cases 342 are moving toward one another (e.g., being brought together). Arrow 630-1 indicates that audio output device case 342-1 is moving toward audio output device case 342-2 and arrow 630-2 indicates that audio output device case 342-2 is moving toward audio output device case 342-1. In some embodiments, only one of audio output device cases 342 moves toward the other during a communicative coupling gesture.

FIG. 6D shows audio output device cases 342 being close to one another as a result of the movement indicated by arrows 630 in FIG. 6C. In some embodiments, audio output device cases 342 are brought within a threshold distance of one another (e.g., within 1 foot, 6 inches, 2 inches, 1 inch, ½ inch, or direct contact).

FIG. 6E shows movement 632-1 of audio output device case 342-1 and movement 632-2 of audio output device case 342-2. For example, movements 632 comprise shaking, rotating, or otherwise moving the corresponding audio output device case. In accordance with some embodiments, movements 632 in combination with audio output device cases 342 being brought together comprises a communicative coupling gesture (e.g., a gesture mapped to a function for communicatively coupling wearable audio output devices 301-1 and 301-2). In some embodiments, the communicative coupling gesture includes movement of only one audio output device case (e.g., only one of movement 632-1 or movement 632-2).

FIG. 6F shows wearable audio output devices 301-1 communicatively coupled to wearable audio output devices 301-2 as a result of the movements illustrated in FIGS. 6C-6E. FIG. 6F shows audio data 634 being transmitted between wearable audio output devices 301-1 and 301-2. In some embodiments, audio data 634 corresponds to audio received by one of the wearable audio output devices (e.g., from another device such as device 100 or audio output device case 342). In some embodiments, audio data 634 corresponds to audio captured by a microphone of one of the wearable audio output devices. For example, the wearable audio output devices are coupled in a walkie-talkie mode in which users of the wearable audio output devices are able to talk with one another via a direct wireless connection. FIG. 6F further shows feedback 636 output by audio output device case 342-1 and feedback 637 output by audio output device case 342-2. In some embodiments, feedback 636 and/or 637 comprises audio feedback and/or haptic feedback. In accordance with some embodiments, feedback 636 and 637 indicate that wearable audio output devices 301-1 and 301-2 are communicatively coupled to one another (e.g., due to the communicative coupling gesture illustrated in FIGS. 6C-6E).

FIG. 6G shows wearable audio output devices 301-1 communicatively coupled to audio output device case 342-1, as indicated by dotted-dashed line 604, and wearable audio output devices 301-2 communicatively coupled to audio output device case 342-2, as indicated by dotted-dashed line 610. FIG. 6G further shows audio feedback 646-1 output by wearable audio output devices 301-1 and audio feedback 646-2 output by wearable audio output devices 301-2. In some embodiments, audio feedback 646 includes a haptic feedback component. In accordance with some embodiments, audio feedback 646 indicate that wearable audio output devices 301-1 and 301-2 are in proximity with (e.g., nearby) one another (e.g., within 0.5, 1, 2, 5, 10, 15, 25, 50, 100 or 300 feet of each other) and/or are available for communicatively coupling with one another. In some embodiments, the wearable audio output devices 301-1 and 301-2 being in proximity with one another comprises the wearable audio output devices 301-1 and 301-2 being within a communication range of one another (e.g., within a peer-to-peer connection range). In some embodiments, the wearable audio output devices 301-1 and 301-2 being in proximity with one another comprises an antenna of one wearable audio output device detecting a signal from a transmitter of another wearable audio output device. In some embodiments, the wearable audio output devices 301-1 and 301-2 being in proximity with one another comprises the wearable audio output devices 301-1 and 301-2 being connected to a same network (e.g., a same Wi-Fi network). In some embodiments, the wearable audio output devices 301-1 and 301-2 being in proximity with one another comprises the wearable audio output devices 301-1 and 301-2 being within a sensor range of one another. For example, a sensor on one of the wearable audio output devices outputs data indicating the presence of another wearable audio output device. In some embodiments, the wearable audio output devices 301-1 and 301-2 being in proximity with one another comprises the wearable audio output devices 301-1 and 301-2 being in a same room and/or building as one another. In some embodiments, the wearable audio output devices 301-1 and 301-2 being in proximity with one another comprises the wearable audio output devices 301-1 and 301-2 being in a same geolocation (e.g., within a same geofence). In some embodiments, audio feedback 646-1 is provided at only one of wearable audio output devices 301-1. In some embodiments, only one of audio feedback 646-1 and 646-2 is provided (e.g., one set of wearable audio output devices broadcasts its availability to communicatively couple and the other set of wearable audio output devices provides audio feedback in response to receiving the broadcast).

FIG. 6G also shows audio output device case 342-1 displaying user interface 638-1 indicating that wearable audio output devices 301-2 are nearby and audio output device case 342-2 displaying user interface 638-2 indicating that wearable audio output devices 301-1 are in proximity with one another. In some embodiments, a proximity threshold for audio feedback (e.g., the audio feedback 646) is the same as a proximity threshold for visual feedback (e.g., the user interface 638-2). In some embodiments, the proximity threshold for audio feedback is the different than the proximity threshold for visual feedback. For example, audio feedback is provided when the wearable audio output devices (e.g., the wearable audio output devices 301-1 and 301-2) are within a first distance threshold (e.g., within 20 feet, 10 feet, 5 feet, 2 feet, or 1 feet) and visual feedback is provided when the wearable audio output devices are within a second distance threshold (e.g., 15 feet, 7 feet, 4 feet, 18 inches, or 6 inches). In some embodiments, audio feedback is provided based on a first proximity determination (e.g., being in a same geolocation, being coupled to a same network, or other proximity determination) and visual feedback is provided based on a second proximity determination (e.g., being within a sensor range, being within a peer-to-peer connection range, or other proximity determination). In some embodiments, only one of user interfaces 638-1 and 638-2 is displayed (e.g., one set of wearable audio output devices broadcasts its availability to communicatively couple and the audio output device case for the other set of wearable audio output devices provides the user interface in response to receiving the broadcast). User interface 638-1 includes selectable element 640-1 configured to initiate a communicative coupling between wearable audio output devices 301-1 and wearable audio output devices 301-2. Similarly, user interface 638-2 includes selectable element 640-2 configured to initiate a communicative coupling between wearable audio output devices 301-1 and wearable audio output devices 301-2. FIG. 6G further shows input 642 detected at a location corresponding to selectable element 640-1 and input 644 detected at a location corresponding to selectable element 640-2.

FIG. 6H shows a transition from FIG. 6G in response to input 642 and/or input 644. FIG. 6H shows wearable audio output devices 301-1 communicatively coupled to wearable audio output devices 301-2 and audio data 650 being transmitted between wearable audio output devices 301-1 and 301-2. In some embodiments, audio data 650 corresponds to audio received by one of the wearable audio output devices (e.g., from another device such as device 100 or audio output device case 342). In some embodiments, audio data 650 corresponds to audio captured by a microphone of one of the wearable audio output devices. For example, the wearable audio output devices are coupled in a walkie-talkie mode in which users of the wearable audio output devices are able to exchange information via a direct wireless connection. FIG. 6H further shows user interface 648-1 displayed on audio output device case 342-1 and user interface 648-2 displayed on audio output device case 342-2. User interfaces 648-1 and 648-2 indicate that wearable audio output devices 301-1 are communicatively coupled to wearable audio output devices 301-2. FIG. 6H further shows audio feedback 652-1 output by wearable audio output devices 301-1 and audio feedback 652-2 output by wearable audio output devices 301-2. In some embodiments, audio feedback 652 includes a haptic feedback component. In accordance with some embodiments, audio feedback 652 indicate that wearable audio output devices 301-1 and 301-2 are communicatively coupled to one another.

FIG. 6I shows wearable audio output devices 301-1 communicatively coupled to audio output device case 342-1, as indicated by dotted-dashed line 604, and wearable audio output devices 301-2 communicatively coupled to audio output device case 342-2, as indicated by dotted-dashed line 610. FIG. 6I further shows audio feedback 660-1 output by wearable audio output devices 301-1 and audio feedback 660-2 output by wearable audio output devices 301-2. In some embodiments, audio feedback 660 includes a haptic feedback component. In accordance with some embodiments, audio feedback 660 indicate that wearable audio output devices 301-1 and 301-2 are in proximity with one another and are available for communicatively coupling with one another. In some embodiments, audio feedback 660-1 is provided at only one of wearable audio output devices 301-1. In some embodiments, only one of audio feedback 660-1 and 660-2 is provided (e.g., one set of wearable audio output devices broadcasts its availability to communicatively couple and the other set of wearable audio output devices provides audio feedback in response to receiving the broadcast).

FIG. 6I also shows audio output device case 342-1 displaying selectable element 653-1 configured to initiate a communicative coupling between wearable audio output devices 301-1 and wearable audio output devices 301-2. Similarly, audio output device case 342-2 displays selectable element 653-2 configured to initiate a communicative coupling between wearable audio output devices 301-1 and wearable audio output devices 301-2. FIG. 6I further shows arrows 658 indicating that audio output device cases 342 are moving toward one another (e.g., being brought together).

FIG. 6J shows audio output device cases 342 being close to one another as a result of the movement indicated by arrows 658 in FIG. 6I. In accordance with some embodiments, input 654 and/or 656 in combination with audio output device cases 342 being brought together comprises a communicative coupling gesture. In some embodiments, the communicative coupling gesture includes movement of only one audio output device case (e.g., only one of movement 658-1 or movement 658-2). In some embodiments, the communicative coupling gesture includes only one of inputs 654 and 656. FIG. 6J further shows wearable audio output devices 301-1 communicatively coupled to wearable audio output devices 301-2 and audio data 662 being transmitted between wearable audio output devices 301-1 and 301-2. In some embodiments, audio data 662 corresponds to audio received by one of the wearable audio output devices (e.g., from another device such as device 100 or audio output device case 342). In some embodiments, audio data 662 corresponds to audio captured by a microphone of one of the wearable audio output devices. For example, the wearable audio output devices are coupled in a walkie-talkie mode in which users of the wearable audio output devices are able to talk with one another via a direct wireless connection. FIG. 6J further shows audio feedback 664-1 output by wearable audio output devices 301-1 and audio feedback 664-2 output by wearable audio output devices 301-2. In some embodiments, audio feedback 664 includes a haptic feedback component. In accordance with some embodiments, audio feedback 664 indicate that wearable audio output devices 301-1 and 301-2 are communicatively coupled to one another.

FIG. 6K shows wearable audio output devices 301-1 communicatively coupled to audio output device case 342-1, as indicated by dotted-dashed line 604, and wearable audio output devices 301-2 communicatively coupled to audio output device case 342-2, as indicated by dotted-dashed line 610. FIG. 6K further shows input 666 at input device 326-1 of audio output device case 342-1 and input 668 at input device 326-2 of audio output device case 342-2. FIG. 6K also shows arrows 670 indicating that audio output device cases 342 are moving toward one another (e.g., being brought together). In accordance with some embodiments, input 666 and/or 668 in combination with audio output device cases 342 being brought together comprises a communicative coupling gesture. In some embodiments, the communicative coupling gesture includes movement of only one audio output device case (e.g., only one of movement 670-1 or movement 670-2). In some embodiments, the communicative coupling gesture includes only one of inputs 666 and 668. FIG. 6K further shows audio output device case 342-1 including indicator 325-1 and audio output device case 342-2 including indicator 325-2. In some embodiments, indicators 325 are in a first state prior to the communicative coupling gesture (e.g., in an off mode in which no light is emitted).

FIG. 6L shows audio output device cases 342 being close to one another as a result of the movement indicated by arrows 670 in FIG. 6K. FIG. 6L further shows wearable audio output devices 301-1 communicatively coupled to wearable audio output devices 301-2 and audio data 672 being transmitted between wearable audio output devices 301-1 and 301-2. In some embodiments, audio data 672 corresponds to audio received by one of the wearable audio output devices (e.g., from another device such as device 100 or audio output device case 342). In some embodiments, audio data 672 corresponds to audio captured by a microphone of one of the wearable audio output devices. For example, the wearable audio output devices are coupled in a walkie-talkie mode in which users of the wearable audio output devices are able to talk with one another via a direct wireless connection. FIG. 6L further shows indicators 325-1 and 325-2 being in a different state than in FIG. 6K (e.g., indicating that wearable audio output devices 301-1 and 301-2 are communicatively coupled). In some embodiments, indicators 325 are in a second state in accordance with the communicative coupling gesture being performed (e.g., in an on mode in which light is being emitted).

FIG. 6M shows wearable audio output devices 301-1 communicatively coupled to audio output device case 342-1, as indicated by dotted-dashed line 604, and wearable audio output devices 301-2 communicatively coupled to audio output device case 342-2, as indicated by dotted-dashed line 610. FIG. 6M further shows wearable audio output devices 301-1 communicatively coupled to wearable audio output devices 301-2 and audio data 676 being transmitted between wearable audio output devices 301-1 and 301-2. For example, wearable audio output devices 301-1 and 301-2 are communicatively coupled in response to a previously performed communicative coupling gesture.

FIG. 6M also shows a third set of devices 601-3 including wearable audio output devices 301-3 and audio output device case 342-3 communicatively coupled to one another, as indicated by dotted-dashed line 674. In the example of FIG. 6M, set of devices 601-3 belong to a user named Wayne. FIG. 6M shows audio output device case 342-1 displaying user interface 678-1 (e.g., on display 372 of audio output device case 342-1). Similarly, audio output device case 342-2 is displaying user interface 678-2 and audio output device case 342-3 is displaying user interface 678-3. User interface 678-1 in FIG. 6M indicates that audio output device case 342-1 is aware of wearable audio output devices 301-3 being in proximity (e.g., within a threshold distance of one another and/or connected to a same local network). In some embodiments, audio output device case 342-1 detects wearable audio output devices 301-3 broadcasting their presence (e.g., via a wireless signal). Similarly, user interfaces 678-2 and 678-3 in FIG. 6M indicate that the corresponding audio output device case is aware of a potential connection between wearable audio output devices 301-3 and wearable audio output devices 301-1 and 301-2. FIG. 6M further shows arrows 680 indicating that audio output device cases 342-2 and 342-3 are moving toward one another (e.g., being brought together). In some embodiments, only one of audio output device cases 342 moves toward the other. For example, the audio output device case 342-2 moves toward the audio output device case 342-3 while the audio output device case 342-3 remains stationary. As another example, the audio output device case 342-3 moves toward the audio output device case 342-2 at a faster speed than the audio output device case 342-2 moves away from the audio output device case 342-3.

FIG. 6N shows audio output device cases 342-2 and 342-3 being brought into contact with one another. For example, audio output device cases 342-2 and 342-3 are brought together as a result of the movement indicated by arrows 680 in FIG. 6M. In the example of FIG. 6N, in response to audio output device cases 342-2 and 342-3 being brought together, wearable audio output devices 301-2 are communicatively coupled to wearable audio output devices 301-3. In accordance with some embodiments, wearable audio output devices 301-3 are coupled to wearable audio output devices 301-2 and wearable audio output devices 301-1. For example, a 3-way connection (e.g., conference call style) is established between the wearable audio output devices 301 in response to audio output device cases 342-2 and 342-3 being brought into contact with one another in which audio recorded by one or more devices is concurrently provided to multiple other devices (e.g., so that multiple participants in a communication session can hear each other and talk to each other). In some embodiments, in response to audio output device cases 342-2 and 342-3 being brought into contact with one another, wearable audio output devices 301-1 and 301-2 are disconnected (e.g., the communicative coupling between wearable audio output devices 301-1 and 301-2 is ended) and wearable audio output devices 301-2 and 301-3 are communicatively coupled (e.g., the coupling between wearable audio output devices 301-2 and 301-3 replaces the coupling between wearable audio output devices 301-1 and 301-2). FIG. 6N further shows audio data 686 being transmitted between wearable audio output devices 301-1, 301-2, and 301-3. In some embodiments, audio data 686 corresponds to audio received by one of the wearable audio output devices (e.g., from another device such as device 100 or audio output device case 342). In some embodiments, audio data 686 corresponds to audio captured by a microphone of one of the wearable audio output devices.

FIG. 6O shows wearable audio output devices 301-1 communicatively coupled to wearable audio output devices 301-2 (e.g., in response to a communicative coupling gesture). FIG. 6O also shows audio data 688 being transmitted between wearable audio output devices 301-1 and 301-2. In some embodiments, audio data 688 corresponds to audio received by one of the wearable audio output devices (e.g., from another device such as device 100 or audio output device case 342). In some embodiments, audio data 688 corresponds to audio captured by a microphone of one of the wearable audio output devices. FIG. 6O further shows user interface 690-1 displayed on audio output device case 342-1 and user interface 690-2 displayed on audio output device case 342-2. User interfaces 690-1 and 690-2 each include a volume slider indicating a volume level for audio received from the other set of wearable audio output devices. In the example of FIG. 6O, user interface 690-1 includes volume slider 692 at an initial position 692-a (e.g., corresponding to a high volume level). FIG. 6O further shows input 694 (e.g., a swipe gesture in the downward direction) detected at a location corresponding to volume slider 692.

FIG. 6P shows a transition from FIG. 6O in response to input 694. In FIG. 6P, audio output device case 342-1 displays volume slider 692 at a position 692-b (e.g., corresponding to a low volume level). In the example of FIG. 6P, volume slider 692 indicates a volume of audio being output by wearable audio output devices 301-1. Thus, FIGS. 60 and 6P illustrate an example in which an output volume of wearable audio output devices 301-1 is adjusted (e.g., independent of an output volume of wearable audio output devices 301-2) in response to an input detected at audio output device case 342-1. For example, adjusting a position of volume slider 692 causes a corresponding change in a gain of audio received from wearable audio output devices 301-2.

FIG. 6Q shows wearable audio output devices 301-1 communicatively coupled to wearable audio output devices 301-2 (e.g., in response to a communicative coupling gesture). FIG. 6Q also shows audio data 695 being transmitted between wearable audio output devices 301-1 and 301-2. In some embodiments, audio data 695 corresponds to audio received by one of the wearable audio output devices (e.g., from another device such as device 100 or audio output device case 342). In some embodiments, audio data 695 corresponds to audio captured by a microphone of one of the wearable audio output devices. FIG. 6Q further shows user interface 696-1 displayed on audio output device case 342-1 and user interface 696-2 displayed on audio output device case 342-2. User interface 696-1 includes volume slider 698 corresponding to audio from wearable audio output devices 301-2 and volume slider 6100 at an initial position 6100-a and corresponding to an ambient sound modification (e.g., an audio transparency level, a noise cancellation level, or other type of ambient sound modification). Similarly, user interface 696-2 includes volume slider 6106 corresponding to audio from wearable audio output devices 301-1 and volume slider 6108 corresponding to an ambient sound modification at wearable audio output devices 301-2. FIG. 6Q further shows input 6104 (e.g., a swipe gesture in the downward direction) detected at a location corresponding to volume slider 6100.

FIG. 6R shows a transition from FIG. 6Q in response to input 6104. In FIG. 6R, audio output device case 342-1 displays volume slider 6100 at a position 6100-b (e.g., corresponding to a lower volume level than position 6100-a in FIG. 6Q). Thus, FIGS. 6Q and 6R illustrate an example in which an ambient sound modification at wearable audio output devices 301-1 is adjusted (e.g., independent from a volume of audio received from wearable audio output devices 301-2) in response to an input detected at audio output device case 342-1.

FIGS. 7A-7F illustrate example user interfaces and user interactions with an audio output device case in accordance with some embodiments. FIG. 7A shows audio output device case 342 and corresponding wearable audio output devices 301. FIG. 7A further shows audio output device case 342 communicatively coupled to device 100, as indicated by dotted-dashed line 702. Device 100 in FIG. 7A is executing a music application as indicated by icon 704. Audio output device case 342 in FIG. 7A is displaying music icon 706 on display 372 at position 706-a (e.g., centered on the display). In accordance with some embodiments, music icon 706 indicates that the music application executing on device 100 is an active audio source for wearable audio output devices 301 (e.g., device 100 is transmitting audio data corresponding to the music application to audio output device case 342 and/or wearable audio output devices 301).

FIG. 7B shows audio output device case 342 communicatively coupled to device 100, as indicated by dotted-dashed line 702, and audio source 502, as indicated by dotted-dashed line 708. Audio output device case 342 in FIG. 7B is displaying music icon 706 on display 372 at a position 706-b and displaying icon 710 corresponding to audio source 502. Thus, FIGS. 7A and 7B illustrate an example in which audio output device case 342 displays icons corresponding to audio sources for wearable audio output devices 301 (e.g., at dynamic locations).

FIG. 7C shows audio output device case 342 communicatively coupled to audio source 502, as indicated by dotted-dashed line 708, and device 300 (e.g., a smartwatch), as indicated by dotted-dashed line 716. Audio output device case 342 in FIG. 7C is displaying device icon 711 corresponding to audio source 502 and displaying device icon 713 corresponding to device 300. Display 372 of audio output device case 342 in FIG. 7C shows arrow icon 714 indicating a relative direction to device 300 from a current location of audio output device case 342. Display 372 of audio output device case 342 in FIG. 7C also shows arrow icon 712 indicating a relative direction to audio source 502 from a current location of audio output device case 342. In accordance with some embodiments, arrow icons 712 and 714 have a size that indicates a distance between the corresponding device and audio output device case 342, and an orientation that indicates a direction to the corresponding device.

FIG. 7D shows audio output device case 342 communicatively coupled to audio source 502, as indicated by dotted-dashed line 708, and device 300, as indicated by dotted-dashed line 716. In FIG. 7D, device 300 is further away from audio output device case 342 as compared to in FIG. 7C. Arrow icon 714 has size 714-b in FIG. 7D that is smaller than size 714-a in FIG. 7C to indicate that device 300 is further away from audio output device case 342. Arrow icon 712 has size 712-b in FIG. 7D that is larger than size 712-a in FIG. 7C to indicate that audio source 502 is closer to audio output device case 342 in FIG. 7D as compared to FIG. 7C. In some embodiments, arrow icons 712 and 714 have an orientation that indicates a relative direction to the corresponding device, but do not have a size that indicates a distance to the corresponding device. For example, instead of arrow icons 712 and 714 changing in size to indicate distances, display 372 includes display of a distance measurement to each device (e.g., a quantitative or qualitative measurement). In some embodiments, audio output device case 342 displays an arrow icon for a nearest coupled device. In some embodiments, audio output device case 342 displays an arrow icon for a coupled device that a user has indicated is lost. In some embodiments, a display location for arrow icon 712 and/or 714 on display 372 changes based on a relative positioning of the corresponding device. In some embodiments, arrow icons 712 and 714 and/or device icons 711 and 713 have a display characteristic (e.g., a color, a size, a pattern, and/or other type of display characteristic) that indicates a relative distance to the corresponding device.

FIG. 7E shows an example of progressive text 720 being displayed on display 372 of audio output device case 342. At a first time, portion 720-a (e.g., the letter ‘h’) of progressive text 720 is displayed. At a second time, portion 720-b (e.g., the letters ‘hel’) of progressive text 720 is displayed. At a third time, portion 720-c (e.g., the word ‘hello’) of progressive text 720 is displayed. In some embodiments, progressive text 720 is displayed in a manner that resembles or imitates handwriting. In some embodiments, a speed at which progressive text 720 is displayed is based on one or more user preferences and/or one or more device settings. In some embodiments, progressive text 720 is togglable (e.g., based on a setting set at audio output device case 342 or a companion device (e.g., device 100 or device 300) in communication with audio output device case 342).

FIG. 7F shows an example of display 372 of audio output device case 342 having a wide viewing angle. For example, progressive text 720 is viewable across a range of angles on a first axis (e.g., a horizontal axis) from a first value (e.g., 1 degree, 5 degrees, or 10 degrees) to a second value (e.g., 179 degrees, 175 degrees, or 170 degrees). As another example, progressive text 720 is viewable across a range of angles on a second axis (e.g., a vertical axis extending from a top of audio output device case 342 to a bottom) from a first value (e.g., 1 degree, 5 degrees, or 10 degrees) to a second value (e.g., 179 degrees, 175 degrees, or 170 degrees).

FIGS. 8A-8D illustrate example user interfaces and user interactions with a camera and an audio output device case in accordance with some embodiments. FIG. 8A shows audio output device case 342 having camera 324 (e.g., an image sensor) and display 372. Display 372 in FIG. 8A displays camera preview 802 corresponding to a field of view of camera 324. Audio output device case 342 in FIG. 8A includes input device 326 (e.g., a mechanical or capacitive button) and indicator 325 (e.g., an LED or other type of light source). FIG. 8A further shows input 804 detected at a location that corresponds to input device 326. In accordance with some embodiments, input 804 corresponds to an image capture command (e.g., an activation of input device 326 while a camera mode is active causes an image to be captured).

FIG. 8B illustrates a transition from FIG. 8A in response to input 804. FIG. 8B shows audio output device case 342 outputting audio notification 805 indicating that an image corresponding to camera preview 802 has been captured (e.g., stored at audio output device case 342). In some embodiments, audio output device case 342 outputs visual and/or haptic feedback (e.g., in addition to, or alternatively to, audio notification 805) indicating that an image has been captured (e.g., a picture has been taken using camera 324).

FIG. 8C shows audio output device case 342 communicatively coupled to device 100, as indicated by dotted-dashed line 810. Device 100 in FIG. 8C includes camera component 806 (e.g., corresponding to camera module 143). In FIG. 8C, device 100 displays camera preview 808 corresponding to a field of view of camera component 806. Audio output device case 342 in FIG. 8C displays camera preview 809 corresponding to the field of view of camera component 806 of device 100. Audio output device case 342 also displays selectable element 812 configured to initiate an image capture command upon activation. FIG. 8C further shows input 814 (e.g., a tap input, a long press input, or other type of input) detected at a location that corresponds to selectable element 812.

FIG. 8D illustrates a transition from FIG. 8C in response to input 814. FIG. 8D shows audio output device case 342 displaying visual notification 818 indicating that an image has been captured by camera component 806 (e.g., a picture has been taken using camera component 806). Device 100 in FIG. 8D displays visual notification 816 indicating that an image has been captured by camera component 806. Thus, FIGS. 8C and 8D illustrate an example in which a user input at audio output device case 342 causes an image to be captured at device 100 via camera component 806.

FIGS. 9A-9O illustrate example user interfaces and user interactions with an audio output device case in accordance with some embodiments. FIG. 9A shows audio output device case 342 communicatively coupled to wearable audio output devices 301, as indicated by dotted-dashed line 921. In FIG. 9A, audio output device case 342 displays music icon 918 corresponding to a music audio source (e.g., a first active audio source) and phone icon 920 corresponding to a telephony audio source (e.g., a second active audio source). Phone icon 920 in FIG. 9A has size 920-a. Wearable audio output devices 301 in FIG. 9A are outputting audio 924 corresponding to audio from the music audio source and/or the telephony audio source. Audio output device case 342 also includes affordance 373 (e.g., an input device such as a button or touchscreen). In FIG. 9A, a volume for the music audio source and a volume for the telephony audio source are each set to low, as indicated by volume graph 926. FIG. 9A further shows input 922 (e.g., a swipe input) detected at a location that corresponds to phone icon 920.

FIG. 9B illustrates a transition from FIG. 9A in response to input 922. In FIG. 9B, an output volume for the music audio source continues to be at a low level and an output level for the telephony audio source has increased from a low level in FIG. 9A to a medium level in FIG. 9B. Thus, input 922 (e.g., a swipe up input) causes a volume level of the telephony audio source to increase. Phone icon 920 in FIG. 9B has size 920-b (e.g., larger than size 920-a in FIG. 9A) that indicates the output volume of the telephony audio source (e.g., as compared to other active audio sources such as music audio source). FIG. 9B further shows input 923 (e.g., a tap input, a long press input, a deep press input, or other type of input) detected at affordance 373 (e.g., an end of affordance 373 that corresponds to an increase function as indicated by the plus sign). In FIG. 9B, a volume for the music audio source is set to low and a volume for the telephony audio source is set to medium, as indicated by volume graph 928.

FIG. 9C illustrates a transition from FIG. 9B in response to input 923. In FIG. 9C, an output volume for the music audio source continues to be at a low level and an output level for the telephony audio source has increased from a medium level in FIG. 9B to a high level in FIG. 9C. Thus, input 923 causes a volume level of the telephony audio source to increase. Phone icon 920 in FIG. 9C has size 920-c (e.g., larger than size 920-b in FIG. 9B) that indicates the output volume of the telephony audio source (e.g., as compared to other active audio sources such as music audio source). Thus, FIGS. 9A-9C illustrate examples in which an audio output device case displays audio source icons that indicate output volume levels of the audio sources. In accordance with some embodiments, the audio output device case includes input devices (e.g., a touchscreen, button, affordance, or other type of input device) configured to adjust the output volume levels (e.g., independently adjust the volume of different audio sources). In some embodiments, while the audio source icons are displayed, other portions of the display (e.g., display 372) are off (e.g., disabled) and are indistinguishable from a housing of the audio output device case in at least some lighting conditions. In FIG. 9C, a volume for the music audio source is set to low and a volume for the telephony audio source is set to high, as indicated by volume graph 929.

FIG. 9D shows audio output device case 342 communicatively coupled to wearable audio output devices 301, as indicated by dotted-dashed line 921, and communicatively coupled to device 100, as indicated by dotted-dashed line 936. FIG. 9D further shows wearable audio output devices 301 communicatively coupled to device 100, as indicated by dotted-dashed line 932. In FIG. 9D, audio output device case 342 displays music icon 940 corresponding to a music audio source (e.g., a first active audio source), phone icon 944 corresponding to a telephony audio source (e.g., a second active audio source), ambient icon 938 corresponding to an environmental audio source (e.g., a third active audio source), and book icon 942 corresponding to a spoken word audio source (e.g., a fourth active audio source). In some embodiments, the telephony audio source and the spoken word audio source correspond to applications executing on device 100. In some embodiments, the music audio source corresponds to an application executing on audio output device case 342 or a separate audio source coupled to audio output device case 342, such as audio source 502 in FIG. 5C. In some embodiments, the environmental audio source corresponds to a perceived ambient sound for a user of wearable audio output devices 301 (e.g., corresponding to waveform 362 in FIG. 3J). In some embodiments, adjusting an output volume of the environmental audio source comprises adjusting a level of noise cancellation and/or a level of active transparency for wearable audio output devices 301.

The spoken word audio source is paused in FIG. 9D as indicated by user interface 943 displayed on device 100. User interface 943 in FIG. 9D includes selectable element 945 configured to resume playback of audio content from the spoken word audio source. In some embodiments, active audio sources include audio sources that are known to the audio output device case (e.g., a previously identified, paired, and/or coupled audio sources) (e.g., regardless of whether the audio sources are currently transmitting audio content to the audio output device case). Wearable audio output devices 301 in FIG. 9D are outputting audio 934 corresponding to audio from the music audio source, the telephony audio source, and/or the environmental audio source. In FIG. 9D, a volume for the music audio source, a volume for the telephony audio source, and a volume for the environmental audio source are each set to low, as indicated by volume graph 930. Additionally, a volume for the spoken word audio source is set to zero (e.g., the spoken word audio source is muted), as indicated in volume graph 930.

FIG. 9E shows audio output device case 342 communicatively coupled to wearable audio output devices 301, as indicated by dotted-dashed line 921, and communicatively coupled to device 100, as indicated by dotted-dashed line 936. FIG. 9E further shows wearable audio output devices 301 communicatively coupled to device 100, as indicated by dotted-dashed line 932. In FIG. 9E, display 372 of audio output device case 342 displays music icon 940 corresponding to a music audio source, phone icon 944 corresponding to a telephony audio source, ambient icon 938 corresponding to an environmental audio source, and book icon 942 corresponding to a spoken word audio source. FIG. 9E also shows input 950 (e.g., a swipe input, a tap-and-drag input, or other type of input) having starting location 950-a and ending location 950-b.

FIG. 9F illustrates a transition from FIG. 9E in response to input 950. FIG. 9F shows music icon 940, ambient icon 938, and book icon 942 being selected in response to input 950, as indicated by boxes 952-1, 952-2, and 952-3. Phone icon 944 is not selected in FIG. 9F (as indicated by the lack of a corresponding box for phone icon 944). FIG. 9F also shows input 954 (e.g., a swipe input, a tap-and-drag input, or other type of input) detected on display 372 (e.g., an input with an upward direction of movement). In some embodiments, input 950 is a different type of input from input 954. For example, input 950 may be a first type of input corresponding to a selection operation and input 954 may be a second type of input corresponding to a volume adjustment operation.

FIG. 9G illustrates a transition from FIG. 9F in response to input 954. FIG. 9G shows music icon 940, ambient icon 938, and book icon 942 continuing to be selected, as indicated by boxes 952-1, 952-2, and 952-3. In FIG. 9G, a volume for the music audio source, a volume for the spoken word audio source, and a volume for the environmental audio source are each set to high, as indicated by volume graph 956. In FIG. 9G, a volume for the telephony audio source is set to low (e.g., unchanged from FIG. 9F). In some embodiments, a magnitude of volume adjustment for the selected audio sources is based on one or more characteristics of input 954 (e.g., a speed, an amount of movement, an amount of intensity, and/or other characteristics). In accordance with some embodiments, the spoken word audio source in FIG. 9G remains paused, as indicated by user interface 943, but when resumed, the corresponding audio output would have a high volume level as indicated by volume graph 956. FIG. 9G also shows input 958 (e.g., a swipe input, a tap-and-drag input, or other type of input) detected on display 372. In accordance with some embodiments, input 958 has a direction of movement (e.g., downward) that is substantially opposite of a direction of movement of input 954. In some embodiments, inputs 954 and 958 are a same type of input (e.g., with different directions of movement).

FIG. 9H illustrates a transition from FIG. 9G in response to input 958. FIG. 9H shows music icon 940, ambient icon 938, and book icon 942 continuing to be selected, as indicated by boxes 952-1, 952-2, and 952-3. In FIG. 9H, a volume for the music audio source, a volume for the spoken word audio source, and a volume for the environmental audio source are each set to medium, as indicated by volume graph 960. In FIG. 9H, a volume for the telephony audio source is set to low (e.g., unchanged from FIG. 9F). Thus, FIGS. 9F-9H illustrate adjusting the volumes of selected audio sources in response to inputs detected at the audio output device case (e.g., adjusted in accordance with one or more characteristics of the inputs, such as direction and/or magnitude of movement).

FIG. 9I shows audio output device case 342 communicatively coupled to wearable audio output devices 301, as indicated by dotted-dashed line 921, and communicatively coupled to device 100, as indicated by dotted-dashed line 936. FIG. 9I further shows wearable audio output devices 301 communicatively coupled to device 100, as indicated by dotted-dashed line 932. In FIG. 9I, display 372 of audio output device case 342 displays music icon 940 corresponding to a music audio source, phone icon 944 corresponding to a telephony audio source, ambient icon 938 corresponding to an environmental audio source, and book icon 942 corresponding to a spoken word audio source. In FIG. 9I, a volume for the music audio source, a volume for the spoken word audio source, and a volume for the environmental audio source are each set to medium and a volume for the telephony audio source is set to low, as indicated by volume graph 960. FIG. 9I also shows input 964 detected at a location corresponding to phone icon 944, and input 962 detected at a location corresponding to book icon 942. As an example, input 962 and/or input 964 may be a tap input, a long press input, a deep press input, a double tap input, or other type of input. In some embodiments, input 962 and input 964 are a same type of input, while in some other embodiments, input 962 and input 964 are different types of inputs.

FIG. 9J illustrates a transition from FIG. 9I in response to inputs 962 and 964. FIG. 9J shows music icon 940, ambient icon 938, and phone icon 944 being selected, as indicated by boxes 952-1, 952-2, and 952-4. Book icon 942 is not selected in FIG. 9J (as indicated by the lack of box 952-3). Thus, in accordance with some embodiments, input 964 in FIG. 9I causes phone icon 944 to be selected and input 962 in FIG. 9I causes book icon 942 to be deselected. In some embodiments, selection of an icon is toggled in response to a first type of input (e.g., a tap input, a deep press input, or other type of input).

FIG. 9K shows audio output device case 342 communicatively coupled to wearable audio output devices 301, as indicated by dotted-dashed line 921. In FIG. 9K, audio output device case 342 displays music icon 940 corresponding to a music audio source, phone icon 944 corresponding to a telephony audio source, ambient icon 938 corresponding to an environmental audio source, and book icon 942 corresponding to a spoken word audio source. FIG. 9K further shows input 974 (e.g., a tap input, a long press input, a deep press input, a double tap input, or other type of input) detected at a location corresponding to music icon 940. In some embodiments, input 974 is a different type of input than input 962 in FIG. 9I. For example, input 974 may be a deep press input and input 962 may be a tap input.

FIG. 9L illustrates a transition from FIG. 9K in response to input 974. FIG. 9L shows music icon 940 and interface element 976 on display 372. Interface element 976 includes information about media content from the music audio source corresponding to music icon 940 and playback controls 980-1, 980-2, and 980-3. In accordance with some embodiments, selection of playback control 980-1 causes the media content to playback a previous track or section, selection of playback control 980-2 causes playback of the media content to pause, and selection of playback control 980-3 causes the media content to playback a subsequent (e.g., next) track or section. Thus, FIGS. 9K and 9L illustrate an example of replacing display of audio source icons (e.g., phone icon 944) with display of a user interface element for a particular audio source (e.g., with additional information and/or controls for the particular audio source) in response to an input (e.g., a particular type of input) detected at audio output device case. In some embodiments, in response to a subsequent input, interface element 976 ceases to be displayed (e.g., is replaced with display of ambient icon 938, phone icon 944, and book icon 942 as illustrated in FIG. 9K). In some embodiments, the subsequent input is detected at a location that does not correspond to interface element 976 and/or is a type of input mapped to an ‘escape’ or ‘navigate back’ command.

FIG. 9M shows audio output device case 342 communicatively coupled to wearable audio output devices 301. In FIG. 9M, display 372 of audio output device case 342 displays music volume element 988 corresponding to a music audio source (e.g., a first active audio source), ambient volume element 990 corresponding to an environmental audio source (e.g., a second active audio source), and phone volume element 992 corresponding to a telephony audio source (e.g., a third active audio source). In FIG. 9M, music volume element 988 is selected, as indicated by the thicker border on music volume element 988 as compared to ambient volume element 990 and phone volume element 992. In accordance with some embodiments, music volume element 988 includes an icon representing an audio source corresponding to music volume element 988 (e.g., audio source 502), and phone volume element 992 includes an icon representing an audio source corresponding to phone volume element 992 (e.g., device 100). In accordance with some embodiments, music volume element 988, ambient volume element 990, and phone volume element 992 each indicate an output volume of the corresponding audio sources (e.g., indicated by an amount of each element that is patterned in FIG. 9M). Audio output device case 342 in FIG. 9M also includes input devices 984 and 986. For example, input device 984 may be a button, a touch sensor, a dial, or other type of input device. As another example, input device 986 may be a button, a touch sensor, a slider, or other type of input device. FIG. 9M further shows input 993 (e.g., a tap input, a long press input, a deep press input, a double tap input, a twist input, a rotational input, or other type of input) detected at a location corresponding to input device 984.

FIG. 9N illustrates a transition from FIG. 9M in response to input 993. In FIG. 9N, display 372 of audio output device case 342 displays music volume element 988 corresponding to a music audio source, ambient volume element 990 corresponding to an environmental audio source, and phone volume element 992 corresponding to a telephony audio source. Ambient volume element 990 is selected in FIG. 9N, as indicated by the thicker border on ambient volume element 990 as compared to music volume element 988 and phone volume element 992. Thus, FIGS. 9M and 9N illustrate an example of adjusting selection of user interface elements in response to an input at the audio output device case. In some embodiments, selection of the user interface elements is adjusted in accordance with input 993 being a first type of input. In FIG. 9N, ambient volume element 990 has volume level 997-a. FIG. 9N further shows input 995 (e.g., a tap input, a long press input, a deep press input, a double tap input, or other type of input) detected at a location corresponding to input device 986 (e.g., corresponding to a first end of input device 986). In some embodiments, in accordance with input 995 being a second type of input, a different operation is performed (e.g., a user interface is displayed with additional details about the corresponding audio source, or a volume level of the corresponding audio source is adjusted).

FIG. 9O illustrates a transition from FIG. 9N in response to input 995. In FIG. 9O, ambient volume element 990 has volume level 997-b, which is less than volume level 997-a in FIG. 9N. Thus, FIGS. 9N and 9O illustrate an example of adjusting a volume level of an audio source corresponding to a selected volume element in response to an input at the audio output device case. In some embodiments, the volume level of the audio source is adjusted in accordance with input 995 being a first type of input. In some embodiments, in accordance with input 995 being a second type of input, a different operation is performed (e.g., a user interface is displayed with additional details about the corresponding audio source). In some embodiments, volume level 997 is decreased in accordance with input 995 being detected at a first end of input device 986. In some embodiments, volume level 997 is increased in accordance with an input being detected at a second end of input device 986 (e.g., opposite of the first end).

FIGS. 10A-10B are flow diagrams illustrating method 1000 for transmitting the audio data to one or more wearable audio output devices (e.g., wearable audio output devices 301 in FIG. 3H) in accordance with some embodiments. Method 1000 is performed at an audio output device case (e.g., audio output device case 342 in FIG. 3H) that includes a display (e.g., display 372 in FIG. 3H), a wired connection port (e.g., wired connection port 323 in FIG. 3H), and optionally one or more touch-sensitive surfaces (e.g., display 372 may be a touchscreen). The audio output device case optionally includes an illuminable visual indicator (e.g., indicator 325 in FIG. 3H) and/or an input device (e.g., input device 326 in FIG. 3H). In some embodiments, the display is a touch-screen display. In some embodiments, audio output device case includes one or more touch-sensitive surfaces distinct from the display. In some embodiments, the audio output device case is an audio accessory charging case, such as a wireless headphone case, a wireless headset case, an earbud case, and/or other type of storage device for one or more wearable audio output devices. Some operations in method 1000 are, optionally, combined and/or the order of some operations is, optionally, changed.

As described below, method 1000 provides an improved interface for coupling audio sources with audio output devices. Providing a means for wirelessly transmitting audio data from a wired audio source to audio output devices (such as wearable audio output devices 301) enhances the operability of the audio output device case (e.g., providing new functionality) and makes the user-device interface more efficient (e.g., by helping the user to achieve an intended outcome), which, additionally, reduces power usage and improves battery life of the audio output device case and the wearable audio output devices by enabling the user to use the audio output device case and the wearable audio output devices more quickly and efficiently.

While in wireless communication (e.g., wireless communication indicated by dotted-dashed line 512 in FIG. 5A) with one or more wearable audio output devices (e.g., wearable audio output devices 301), the audio output device case (e.g., audio output device case 342) receives (1002) an audio signal (e.g., audio data 520) from an audio source (e.g., audio source 502) via a wired connection port (e.g., wired connection port 323). In some embodiments, the wireless communication includes Bluetooth, Wi-Fi, a low-power audio transmission protocol, and/or other types of wireless communication protocols capable of wirelessly transferring data. In some embodiments, the one or more wearable audio output devices include wireless earbuds, true wireless earbuds (e.g., no wired connection between the left and right earbuds), headphones, headsets (e.g., a single earpiece with an extended microphone or headphones with a boom microphone), and/or other types of wearable audio output devices. In some embodiments, the audio signal from the audio source includes music audio, video audio, speech, MIDI output that is converted into a sound signal, and/or other types of audio signals. In some embodiments, an audio signal can be received from the audio source wirelessly (e.g., as illustrated in FIG. 5S). In some embodiments, the wireless communication uses a wireless transmission protocol, such as Wi-Fi, Bluetooth, radio frequency (RF) transmission, and/or other wireless transmission protocols.

Examples of audio sources include an in-flight entertainment systems, gym equipment (e.g., having a 3.5 mm connector for headphones for listening to a TV on the gym equipment or the TVs placed around the gym), televisions, record player/turntable, professional music equipment (wireless microphone systems, digital musical instruments including drum pads, digital pianos, electric guitars, and electric violins, DJ equipment, and audio mixers, or other audio sources either without wireless transmission capabilities or cannot wirelessly transmit to the one or more wearable audio output devices (e.g., incompatible wireless audio transmission protocols).

In some embodiments, the audio output device case is configured such that the one or more wearable audio output devices can be mounted and/or electrically coupled to the audio output device case (e.g., contained within the case) while not in use. In some embodiments, the one or more wearable audio output devices pair with the audio output device case when mounted and/or electrically coupled to the audio output device case. In some embodiments, the audio output device case and the one or more wearable audio output devices are configured as a set (e.g., the audio output device case and the one or more wearable audio output devices are paired, shown on a setting screen, or otherwise configured as a set). In some embodiments, the audio output device case is configured to pair the one or more wearable audio output devices with one or more wireless sources (e.g., in response to activation of a button at the case).

In some embodiments, the wired connection port (e.g., wired connection port 323 as shown in FIG. 5B) comprises (1004) an auxiliary-in connector of the audio output device case (e.g., auxiliary connector 349 as shown in FIG. 3I). In some embodiments, the wired connection port is, or includes, a Lightning connector, a USB connector (e.g., a USB-C connector) a 3.5 mm audio connector, a magnetic connector capable of data transfer, and/or other types of connectors capable of at least data transfer. In some embodiments, the wired connection port is coupled to a cable (e.g., cable 516 as shown in FIG. 5B) that is coupled to the audio source (e.g., audio source 502 as shown in FIG. 5B). The cable may communicatively couple the audio output device case with the audio source (e.g., data transfer may occur between the audio output device case and the audio source). The cable may include an analog-to-digital converter (e.g., to convert to a digital signal from an analog audio signal received from a 3.5 mm connector, a ¼ inch connector, a 3.5 mm optical mini connector, a banana connector, an RCA connector, a TOSLINK connector, an XLR connector, and/or other types of connectors configured to output an analog signal). Using an auxiliary-in connector allows for connections with audio sources (e.g., conventional audio sources) via conventional cables (e.g., without requiring an adapter). Auxiliary-in connectors also allow for asynchronous serial communications (e.g., allowing an audio source to transmit a stream of audio data without requiring synchronization).

In some embodiments, the audio output device case (e.g., audio output device case 342 as shown in FIG. 5D) is a charging case configured to charge (1006) the one or more wearable audio output devices (e.g., wearable audio output devices 301), while the one or more wearable audio output devices are electrically coupled (e.g., via accessory charger 348 as shown in FIG. 3I) to the charging case. Configuring an audio output device case to provide audio data to the corresponding electronic accessories (e.g., wireless accessories) and provide charging capabilities for the electronic accessories provides improved capabilities and alleviates the need for a user to have to manage multiple devices to provide audio data and charging capabilities.

In some embodiments, the audio source (e.g., audio source 502) is not configured to wirelessly transmit (1008) the audio signal to the audio output device case (e.g., audio output device case 342). In some embodiments, the audio source is not capable of wirelessly transmitting to the case (or the wearable audio output devices) (e.g., because the audio source does not have a wireless radio component). In some embodiments, the audio source is not configured to wireless transmit to the audio output device case because the audio source and the audio output device case do not share a compatible wireless transmission protocol. For example, the audio source is only able to wirelessly transmit and receive signals via a Wi-Fi protocol, and the audio output device case transmits and receives signals via a Bluetooth protocol. In some embodiments, the audio source is not authorized to wirelessly transmit to the audio output device case. For example, a settings page (e.g., a user interface to communicatively couple the audio source with the audio output device case), at the audio source, to wirelessly connect (e.g., communicatively couple) the audio source to the audio output device case is inaccessible to the user (e.g., the settings page is password locked). Configuring the audio output device case to receive (e.g., via a wired connection) and transmit (e.g., wirelessly) audio data from an audio source that is not configured to wirelessly transmit an audio signal provides improved capabilities (e.g., enabling an audio path between a wireless audio output device and the audio source).

In some embodiments, the audio source (e.g., audio source 502) is not configured to wirelessly transmit (1010) the audio signal to the one or more wearable audio output devices (e.g., wearable audio output devices 301). In some embodiments, the audio source is not configured to wirelessly transmit to the one or more wearable audio output devices because the audio source does not have a wireless radio component. In some embodiments, the audio source is not configured to wireless transmit to the one or more wearable audio output devices because the audio source and the one or more wearable audio output devices do not share a compatible wireless transmission protocol. For example, the audio source only wirelessly transmits and receives using a Wi-Fi protocol and the one or more wearable audio output devices are not configured to use the Wi-Fi protocol. In some embodiments, the audio source is not authorized to wirelessly transmit to the one or more wearable audio output devices. For example, a settings page (e.g., a user interface to communicatively couple the audio source with the one or more wearable audio output devices), at the audio source, to wirelessly connect (e.g., communicatively couple) the audio source to the one or more wearable audio output devices may be inaccessible to the user (e.g., the settings page is password locked). Configuring the audio output device case to receive (e.g., via a wired connection) and transmit (e.g., wirelessly) audio data from an audio source that is not configured to wirelessly transmit an audio signal improves functionality of the audio output device case (e.g., providing new capabilities, such as enabling an audio path between a wireless audio output device and the audio source).

In some embodiments, the one or more wearable audio output devices (e.g., wearable audio output devices 301) are configured to wirelessly couple (1012) to a wireless audio source (e.g., portable multifunction device 100 as shown in FIG. 5I, and/or device 300 as shown in FIG. 5K) distinct from the audio output device case. In some embodiments, the one or more wearable audio output devices are configured to directly wirelessly couple to the wireless audio source. In some embodiments, the one or more wearable audio output devices are configured to wirelessly couple to the wireless audio source without connecting via the audio output device case. In some embodiments, the one or more wearable audio output devices (e.g., earbuds) are concurrently in wireless communication with the audio output device case and wireless audio source. In some embodiments, the one or more wearable audio output devices are concurrently in wireless communication with the audio output device case and a wireless audio source. For example, wireless audio sources include a phone (e.g., a smartphone), a computer, a tablet, or other type of device capable of wireless communication with the one or more wearable audio output devices. For example, the wireless audio source may be a companion device (e.g., a phone) that is paired with the one or more wearable audio output devices. In some embodiments, the one or more wearable audio output devices are wirelessly connected with the wireless audio source without connection to the audio source via the wired connection port. For example, the one or more wearable audio output devices are only wirelessly connected to a phone, and not the audio output device case that is connected, via a cable, to an in-flight entertainment system. Configuring the one or more wearable audio output devices to communicatively couple to the audio output device case and to one or more wireless sources improves functionality of the wearable audio output devices (e.g., providing new capabilities) and may reduce the number of inputs needed to output audio from different audio sources.

In some embodiments, the wired connection port (e.g., wired connection port 323) is further configured to receive (1014) power (e.g., power 528 as shown in FIG. 5D) for the audio output device case (e.g., audio output device case 342). For example, the wired connection port is a USB-type port. In some embodiments, power is transmitted from the audio source (e.g., audio source 502 as shown in FIG. 5D) to the audio output device case via a cable (e.g., cable 516 as shown in FIG. 5D). The cable may be coupled to the audio source and also coupled to the audio output device case via the wired connection port. The received power may be used to charge the case. In some embodiments, the received power is used to charge the one or more wearable audio output devices (e.g., wearable audio output devices 301) when the one or more wearable output devices are inside (or otherwise mounted and/or electrically coupled to) the audio output device case. In some embodiments, the received power is used to power the audio output device case without charging the audio output device case or the one or more wearable audio output devices. Configuring the wired connection port to receive power and audio data (e.g., from a same audio source) improves functionality of the audio output device case and may reduce the number of inputs needed to output audio from different audio sources.

In some embodiments, wired connection port (e.g., wired connection port 323) is configured to concurrently receive (1016) the audio signal (e.g., audio data 520, FIG. 5F) and power (e.g., power transmission 528, FIG. 5F) from the audio source (e.g., audio source 502). In some embodiments, the wired connection to the audio source powers the case concurrently with receiving the audio signal from the audio source. The power and the audio signal are both received via the wired connection (e.g., the audio signal is transmitted via a cable and not wirelessly transmitted to the case). In some embodiments, the power received powers the transmission of the audio data to the one or more wearable audio output devices. In some embodiments, the power received powers the processing of the audio signal from the audio source to the audio data that is transmitted to the one or more wearable audio output devices. Configuring the one or more wearable audio output devices to concurrently receive power and audio data improves functionality of the audio output device case (e.g., providing new capabilities) and provides a more efficient user-device interface by reducing the number of inputs and/or actions needed to receive power and audio data.

The audio output device case transmits (1018) audio data (e.g., audio data 522 in FIG. 5C) corresponding to the audio signal (e.g., audio data 520 in FIG. 5C) from the audio source to the one or more wearable audio output devices (e.g., wearable audio output devices 301 in FIG. 5C) for playback (e.g., audio 524 as shown in FIGS. 5C) to a user. Receiving audio signals at the audio output device case, via the wired connection, from the audio source that is otherwise not capable of wirelessly communicating with the wearable audio output devices, and the audio output device case wirelessly transmitting audio to the wearable audio output devices enhances the connectivity of the wearable audio output devices without requiring a wired connection between the wearable audio output devices and the audio source, which preserves the convenience of wireless wearable audio output devices. In some embodiments, the audio data is processed from the audio signal received form the audio source. For example, one or more post-processing effects are applied to the audio signal to generate the audio data. In another example, the audio signal is transcoded or otherwise manipulated at the case before being sent to the earbuds. In some embodiments, the audio signal is received at a phone via a wired connection port. The audio data corresponding to the audio signal is then transmitted (e.g., wirelessly via Bluetooth or Wi-Fi) to the one or more wearable audio output devices for playback to a user. In some embodiments, the audio signal is received at a device that includes a wired connection port and is configured to receive an audio signal and configured to transmit audio data corresponding to the audio signal to one or more wearable audio output devices for playback to a user.

In some embodiments, transmitting the audio data (e.g., audio data 522 as shown in FIG. 5R) corresponding to the audio signal (e.g., audio data 520) from the audio source (e.g., audio source 502) to the one or more wearable audio output devices (e.g., wearable audio output devices 301) via a wired connection to the audio output device case (e.g., audio output device case 342) for playback to the user corresponds (1020) to a first playback latency (e.g., latency 5100-b as shown in FIG. 5T). In some embodiments, the audio source includes wireless communication circuitry (e.g., wireless communication circuitry operating using wireless connection 1.0 in FIG. 5S). In some embodiments, transmitting the audio data (e.g., audio data 596 in FIG. 5S) via a direct wireless connection between the audio source and the one or more wearable audio output devices (e.g., as illustrated in FIG. 5S) using the wireless communication circuitry corresponds to a second playback latency (e.g., latency 5100-a as shown in FIG. 5T), greater than the first playback latency. Configuring wearable audio output device case to provide an audio path with lower latency (e.g., as compared to other audio path options) improves functionality of the audio output device case (e.g., providing new capabilities) and provides an improved system for outputting audio corresponding to audio data from an audio source.

In some embodiments, the first playback latency is based on power characteristics of the case. For example, when a case is above a specified charge threshold, the first playback latency is decreased. In another example, when the case is below a specified charge threshold, the first playback latency is increased to reduce an amount of power required and/or consumed. In some embodiments, the first playback latency is determined based on one or more user requirements (e.g., the one or more user requirements are adjustable by a user). For example, a user requirement associated with professional music production has a predefined latency threshold that is lower (e.g., a lower latency) than that of a user requirement associated with watching a movie.

In some embodiments, an audio path through the audio output device case has a lower latency between the audio source and the output at the one or more wearable audio output devices than an audio path directly from the audio source to the one or more wearable audio output devices. The latency may be lower because the audio output device case includes a more capable (e.g., more powerful, more efficient, more optimized (e.g., produces a cleaner or stronger wireless signal), and/or includes more optimized transmission protocols that introduce less latency into the transmission than other transmission protocols) wireless communication circuitry such as, a radio, a transmitter, and/or a receiver. In some embodiments, the audio path through the audio output device case has a lower latency because the audio output device case has more component space for the more capable wireless communication circuitry as compared to the audio source. The more capable wireless communication circuitry may consume more power. In some embodiments, the audio path through the audio output device case results in lower latency than the audio path directly from the audio source to the one or more wearable audio output devices because the audio output device case has more available power to operate the wireless communication circuitry as compared to the audio source. In some embodiments, the audio output device case includes a wireless transmitter and receiver and a power source (e.g., a battery with a battery capacity, maximum voltage, and/or maximum current), where the wireless transmitter and receiver are configured, based on the power source satisfying a power criteria, such that the latency less than the predefined latency threshold or less than the wireless latency between the audio source and the one or more wearable audio output devices.

In some embodiments the wireless transmitter and receiver are configured to have a lower latency because the wireless transmitter and receiver support a newer wireless transmission protocol than what is available at the audio source. For example, the audio source includes both a 3.5 mm wired output and an older wireless transmission protocol. In this example, the audio signal received from the 3.5 mm wired output and wirelessly transmitted from the audio output device case to the one or more wearable audio output devices with a modern wireless transmission protocol has a lower latency than the wireless transmission directly from the audio source to the one or more wearable audio output device using the older wireless transmission protocol.

In some embodiments, in accordance with transmitting the audio data, the audio output device case causes (1022) the one or more wearable audio output devices (e.g., wearable audio output devices 301 as shown in FIGS. 5K-5L) to switch from playing back audio (e.g., audio 548 as shown in FIG. 5K) from the wireless audio source (e.g., device 100) to playing back audio (e.g., audio 524 as shown in FIG. 5L) corresponding to the audio data (e.g., audio data 522). In some embodiments, while in concurrent communication with the wireless audio source and the audio output device case (e.g., audio output device case 342 as shown in FIGS. 5K-5L), the one or more wearable audio output devices receive the transmitted audio data from the audio output device case, and receive a wireless audio signal from the wireless audio source via the wireless connection. Causing the wearable audio output device(s) to switch from playing back audio from a wireless audio source to playing back audio from the audio source reduces a number of inputs needed to switch audio playback (e.g., by automatically switching rather than requiring one or more user inputs) thereby providing a more efficient user-device interface.

In some embodiments, the one or more wearable audio output devices (e.g., wearable audio output devices 301 as shown in FIG. 5M) are caused to switch (1024) from playing back the audio from the wireless audio source (e.g., audio 548) to playing back the audio corresponding to the audio data in response to detecting a user input (e.g., input 578 in FIG. 5M). In some embodiments, the user input is detected at one of the one or more wearable audio output devices, the audio output device case, the wireless audio source, the audio source, and/or another device (e.g., a phone, a watch, or other type of companion device). In some embodiments, the switch is further based on one or more source switching criteria. In some embodiments, the source switching criteria includes the audio signal (e.g., audio data 520 as shown in FIG. 5P) being received at the case. In some embodiments, in response to the transmitted audio data (e.g., audio data 522 as shown in FIG. 5P) being received at the one or more wearable audio output devices, the one or more wearable audio output devices automatically switch from playing back audio from the wireless audio source (e.g., audio 548 as shown in FIG. 5O) to playing back audio corresponding to the audio data without further user input. Switching audio sources in response to detecting a user input reduces the number of inputs needed to switch audio sources (e.g., simplifying the user-device interface by forgoing the need to navigate multiple menus or other user interfaces).

In some embodiments, the user input is received (1026) at the audio output device case (e.g., audio output device case 342 as shown in FIGS. 5G-5H). In some embodiments, the user input (e.g., input 534 as shown in FIG. 5G) at the audio output device case includes a selection on a touch sensitive display (e.g., display 372 as shown in FIG. 5G) of the audio output device case. For example, the user input comprises activation of a mechanical button and/or other mechanical input device. As another example, the user input comprises a user gesture (e.g., a tap gesture, a double tap gesture, a slide gesture, and/or other type of gesture) detected via a capacitive sensor, a pressure sensor, an image sensor, and/or other type of sensor. In another example, the user input includes a movement of the audio output device case. In some embodiments, the user input includes one or more of an activation of a mechanical input device, a user gesture, and/or a movement of the audio output device case. Switching audio sources in response to detecting a user input at the audio output device case reduces the number of inputs needed to switch audio sources (e.g., simplifying the user-device interface by forgoing the need to navigate multiple menus or other user interfaces and/or allowing a user to avoid having to switch between multiple devices).

In some embodiments, the user input is received (1028) at one of the one or more wearable audio output devices (e.g., wearable audio output devices 301 as shown in FIGS. 5Q-5R). In some embodiments, the user input (e.g., input 588 as shown in FIG. 5Q) at the one or more audio output devices includes a selection on a touch sensitive portion (e.g., via a capacitive sensor or a pressure sensor) of the one or more wearable audio output devices. In some embodiments, the input at the one or more audio output devices includes a selection on a rotatable input mechanism (e.g., crown and/or a knob). In some embodiments, the rotatable input mechanism is activatable by depressing the rotatable input mechanism. Switching audio sources in response to detecting a user input at the wearable audio output devices reduces the number of inputs needed to switch audio sources (e.g., simplifying the user-device interface by forgoing the need to navigate multiple menus or other user interfaces and/or allowing a user to avoid having to switch between multiple devices).

In some embodiments, the user input (e.g., input 568 as shown in FIG. 5K) is received (1030) at a companion device (e.g., device 300) that is wirelessly coupled to the audio output device case and/or the one or more wearable audio output devices. In some embodiments, the companion device is a phone, a tablet, or a watch. Switching audio sources in response to detecting a user input at the companion reduces the number of inputs needed to switch audio sources (e.g., simplifying the user-device interface and/or allowing a user to avoid having to switch between multiple devices).

It should be understood that the particular order in which the operations in FIGS. 10A-10B have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 1100, 1200, and 1300) are also applicable in an analogous manner to method 1000 described above with respect to FIGS. 10A-10B. For example, the devices, ports, audio sources, inputs, and displays described above with reference to method 1000 optionally have one or more of the characteristics of the devices, ports, audio sources, inputs, and displays described herein with reference to other methods described herein (e.g., methods 1100, 1200, and 1300). For brevity, these details are not repeated here.

FIGS. 11A-11C are flow diagrams illustrating method 1100 for communicatively coupling a first set of audio output devices (e.g., wearable audio output devices 301-1 as shown in FIG. 6A) and a second set of audio output devices (e.g., wearable audio output devices 301-2 as shown in FIG. 6A) in accordance with some embodiments. Method 1100 is performed at a first audio output device case (e.g., audio output device case 342-1 as shown in FIG. 6A). The first audio output device case and/or a second audio output device case optionally include a display (e.g., display 372 as shown in FIG. 3H), one or more touch-sensitive surfaces, an inertial measurement unit (IMU), and/or an input device (e.g., input device 326 as shown in FIG. 3H). In some embodiments, the display is a touch-screen display and at least one of the touch-sensitive surfaces is integrated with the display. In some embodiments, the display is separate from the touch-sensitive surfaces. In some embodiments, the audio output device case is an audio accessory charging case, a wireless headphone case, a wireless headset case, and/or other types of storage accessories for one or more wearable audio output devices. Some operations in method 1100 are, optionally, combined and/or the order of some operations is, optionally, changed.

As described below, method 1100 provides an improved interface for coupling audio sources with audio output devices. Providing a means for establishing wireless connections between audio output devices (such as sets of wearable audio output devices 301) using an audio output device case enhances the operability of the audio output device case (e.g., providing new functionality) and makes the user-device interface more efficient (e.g., by helping the user to achieve an intended outcome), which, additionally, reduces power usage and improves battery life of the audio output device case and the wearable audio output devices by enabling the user to use the audio output device case and the wearable audio output devices more quickly and efficiently.

In some embodiments, in accordance with a determination that a first set of audio output devices (e.g., audio output devices 301-1 as shown in FIG. 6A) and a second set of audio output devices (e.g., audio output devices 301-2) are available to communicatively couple, the first audio output device case provides (1102) a pairing availability output, where the pairing availability output includes a visual pairing availability output (e.g., user interface 611-1 as shown in FIG. 6A) and/or non-visual pairing availability output (e.g., feedback 626 as shown in FIG. 6C). The visual pairing availability output may include a color, an illumination pattern, a brightness, a displayed user interface, and/or other visual feedback. For example, one or more white or multi-colored LEDs may be used to provide visual feedback (e.g., using a solid or flashing illumination pattern to indicate availability for pairing) (e.g., a red LED represents not available for pairing and a green LED represents available for pairing) and/or one or more animations (e.g., a graphic). The non-visual pairing confirmation output may include an audio output (e.g., the audio output may include a volume, an output pattern, and/or frequency) and/or haptic feedback (e.g., the haptic feedback may include intensity and/or output pattern). Providing a pairing availability output to the user enhances the operability of the devices and makes the user-device interface more efficient (e.g., by helping the user to achieve an intended outcome and reducing user mistakes when operating/interacting with the devices), which, additionally, reduces power usage and improves battery life of the devices by enabling the user to use the devices more quickly and efficiently.

In some embodiments, the pairing availability output is outputted at the first set of one or more audio output devices (e.g., wearable audio output devices 301-1), the first audio output device case (e.g., audio output device case 342-1), the second set of one or more audio output devices (e.g., wearable audio output devices 301-2), the second audio output device case (e.g., audio output device case 342-2), and/or a companion device (e.g., device 100, device 300, or other type of device).

In some embodiments, a determination that the first set of one or more audio output devices and the second set of one or more audio output devices are available to communicatively couple comprises a determination that the first and/or second set of one or more audio output devices are broadcasting their availability for communicatively coupling. In some embodiments, a determination that the first set of one or more audio output devices and the second set of one or more audio output devices are available to communicatively couple comprises a determination that the first and/or second set of one or more audio output devices have communicated their availability to communicatively couple to the first set of one or more audio output devices.

In some embodiments, in accordance with a determination that the first set of audio output devices (e.g., wearable audio output devices 301-1) and the second set of audio output devices (e.g., wearable audio output devices 301-2) are communicatively coupled, the first audio output device case provides (1104) a pairing confirmation output, where the pairing confirmation output includes a visual pairing confirmation output (e.g., user interface 618-1 as shown in FIG. 6B) and/or a non-visual pairing confirmation output (e.g., feedback 636 as shown in FIG. 6F). The visual pairing availability output may include a color, an illumination pattern, a brightness, a displayed user interface, and/or other visual feedback. For example, one or more white multi-colored LEDs could be used to provide visual feedback (e.g., using a solid or flashing illumination pattern to indicate confirmation of pairing) (e.g., a red LED represents not paired and a green LED represents paired) and/or one or more animations (e.g., a graphic). The non-visual pairing confirmation output may include an audio output (e.g., the audio output may include a volume, an output pattern, and/or frequency) and/or haptic feedback (e.g., the haptic feedback may include intensity and/or output pattern). Providing a pairing confirmation output to the user enhances the operability of the devices and makes the user-device interface more efficient (e.g., by helping the user to achieve an intended outcome and reducing user mistakes when operating/interacting with the devices), which, additionally, reduces power usage and improves battery life of the devices by enabling the user to use the devices more quickly and efficiently.

In some embodiments, the pairing confirmation output is outputted at the first set of one or more audio output devices, the first audio output device case, the second set of one or more audio output devices, the second audio output device case, and/or a companion device (e.g., a phone, tablet, or watch). In some embodiments, the visual pairing availability output is the same as the visual pairing confirmation output. In some embodiments, the visual pairing availability output is different than the visual pairing confirmation output (e.g., has a different color, illumination pattern, brightness, displayed user interface, and/or other visual parameter). In some embodiments, the non-visual pairing availability output is the same as the non-visual pairing confirmation output (e.g., a same haptic vibration, audio tone, and/or other non-visual output). In some embodiments, the non-visual pairing availability output is different than the non-visual pairing confirmation output (e.g., has a different tone, frequency, amplitude, or other parameter). In some embodiments, the non-visual pairing availability output and the non-visual pairing confirmation output are different types of outputs (e.g., one is haptic feedback and the other is audio feedback.

The first audio output device case detects (1106) a physical interaction (e.g., physical contact as shown in FIG. 6B, movement 632-1 as shown in FIG. 6E, input 642 as shown in FIGS. 6G, and/or input 666 as shown in FIG. 6K) that involves the first audio output device case (e.g., audio output device case 342-1) that is in communication with the first set of audio output devices (e.g., wearable audio output devices 301-1) and the second audio output device case (e.g., audio output device case 342-2) for the second set of audio output devices (e.g., wearable audio output devices 301-2). In some embodiments, the first audio output device case includes an audio accessory charging case, a wireless headphone case, and/or other types of storage and/or charging solutions for one or more audio output devices. In some embodiments, the first audio output device and the first set of one or more audio output devices are part of a first predefined set (e.g., set of devices 601-1 as shown in FIG. 6A).

In some embodiments, the physical interaction includes bumping the first audio output device case and the second audio output device case. In some embodiments, the physical interaction includes pressing a button on one or both of the first audio output device case and the second audio output device case when the respective cases are within a predefined distance. In some embodiments, the second audio output device case is in communication with the second set of one or more audio output. In some embodiments, the second audio output device case and the second set of one or more audio output devices are part of a second predefined set (e.g., set of devices 601-2 as shown in FIG. 6A).

In response to detecting the physical interaction, in accordance with a determination that the physical interaction is a first type of physical interaction, the first audio output device case communicatively couples (1108) the first set of audio output devices with the second set of audio output devices for transmitting and receiving first audio signals (e.g., audio data 634 as shown in FIG. 6F) between the first set of audio output devices and the second set of audio output devices. In some embodiments, while the first set of audio output devices are communicatively coupled with the second set of audio output devices, the first set of audio output devices output audio captured by one or more microphones of the second set of audio output devices and the second set of audio output devices output audio captured by one or more microphones of the first set of audio output devices. In some embodiments, the captured audio is modified (e.g., filtered, translated, pitch adjusted, modulated, and/or otherwise processed) prior to being output by an audio output device. In some embodiments, the captured audio is transmitted to the other set of audio output devices without audio modification (e.g., without being filtered, translated, pitch adjusted, or modulated).

In some embodiments, communicatively coupling the first set of one or more audio output devices with the second set of one or more audio output devices is via a direct communication link (e.g., as illustrated in FIG. 6F) and/or a direct audio link between the respective set of one or more audio output devices. In some embodiments, communicatively coupling the first set of one or more audio output devices with the second set of one or more audio output devices is via communicatively coupling the first audio output device case and the second audio output device case (e.g., as illustrated in FIG. 6B). The first set of one or more audio output devices may transmit and receive information from the second set of one or more audio output devices through the first audio output case and the second audio output case. As an example, two users may wish to communicatively couple their respective audio output devices (e.g., earbuds) so that they can talk to each other through their audio output devices (e.g., walkie-talkie style). This may be particularly beneficial when the users are in a noisy environment in which normal conversation would be difficult to hear and/or when the users are moving around independently so that they are not always within talking range of each other. As another example, a user may wish to share their audio playback with another user. By creating the communicative coupling, the user is able to share their audio playback via the audio output devices (e.g., rather than having to lend their audio device to the other user, or get the other user access to, or a copy of, the audio source).

In some embodiments, the first type of physical interaction comprises (1110) a movement (e.g., movement 343-1 and/or 343-2 as shown in FIG. 6E) of the first audio output device case and/or the second audio output device case while the first audio output device case and the second audio output device case are within a threshold distance of one another (e.g., the first audio output device case and the second audio output device case may be moved within a threshold distance as illustrated in FIGS. 6C-6D). In some embodiments, the physical interaction is detected via a set of sensors (e.g., one or more sensors). In some embodiments, at least one of the set of sensors is a component of the first audio output device case, the second audio output device case, the first set of audio output devices, the second set of audio output devices, or a companion device (e.g., portable multifunction device 100 or device 300) (e.g., a phone, a wearable device, or other type of companion device). In some embodiments, the set of sensors comprise sensors from two or more devices. For example, a sensor of a first device detects an indication of the physical interaction and uses information from a sensor of a second device to confirm the physical interaction. Configuring the audio output device case(s) to communicatively couple the first and second sets audio output devices improves functionality of the audio output device case and the audio output devices (e.g., providing new capabilities) and may reduce the number of inputs needed to communicatively couple the sets of audio output devices. In some embodiments, the movement of the first audio output device case and/or the second audio output device case comprises a predefined gesture (e.g., that is mapped to a communicative coupling function). In some embodiments, the predefined gesture is only recognized if the first audio output device case and the second audio output device case are within the threshold distance of one another.

In some embodiments, the determination that the physical interaction is the first type of physical interaction is performed at first audio output device case, the second audio output device case, the first set of audio output devices, the second set of audio output devices, and/or a companion device. For example, the first audio output device case receives sensor data from one or more sensors of the first audio output device case and optionally receives information about the physical interaction from another device (such as the second audio output device case) and performs the determination accordingly.

In some embodiments, the movement of the first audio output device case and/or the second audio output device case includes shaking, flipping, rotating, or tapping on one or both of the audio output device cases. In some embodiments, the determination of movement comprises a “swipe” movement (e.g., where one case is moved in a swiping motion passed the other case). For example, the swipe movement includes one or both of the first audio output device case and the second audio output device case moving past the other audio output device case within a threshold distance.

In some embodiments, the determination of movement comprises a first movement of the first audio output device case towards the second audio output device case and a second movement of the first audio output device case not towards the second audio output device case. For example, the first audio output device case moves towards the second audio output device case and then stops moving towards the second audio output device case. In another example, the first audio output device case moves towards the second audio output device case and then moves away from the second audio output device case.

In some embodiments, the movement of the first audio output device case and/or the second audio output device case includes detecting (1112) an input that corresponds to touching the first audio output device case (e.g., audio output device case 342-1 as shown in FIG. 6B) to the second audio output device case (e.g., audio output device case 342-2 as shown in FIG. 6B). In some embodiments, the input that corresponds to touching the first audio output case to the second audio output device case is detected based on data from a contact sensor. In some embodiments, the input that corresponds to touching the first audio output case to the second audio output device case is detected based on a data from an inertial measurement unit (IMU). For example, the IMU may detect an impact between the first audio output device case and the second audio output device case. In some embodiments, communicatively coupling the respective audio output device cases is further based on a first wireless circuitry associated with the first audio output device case detecting and/or communicatively coupling with a second wireless circuitry associated with the second audio output device case. Configuring the audio output device case(s) to communicatively couple the first and second sets audio output devices in accordance with detecting the first and second audio output device cases touching improves functionality of the audio output device case and the audio output devices (e.g., providing new capabilities) and may reduce the number of inputs needed to communicatively couple the sets of audio output devices.

In some embodiments, the determination of movement is based on a velocity and/or acceleration of the first audio output device case and/or the second audio output device case (e.g., based on data from an IMU). In some embodiments, the movement comprises the first audio output device case impacting with the second audio output device case without making direct contact (e.g., hands holding the cases make contact rather than the cases themselves). In some embodiments, the movement comprises a simulated bump motion where one or both of the first audio output device case and the second audio output device case are moving towards the other audio output device case and abruptly (e.g., within a prescribed period of time) stop moving towards each other (without making physical contact) or start moving away from each other.

In some embodiments, the first type of physical interaction comprises (1114) a first user input (e.g., input 654 as shown in FIG. 6I) at the first audio output device case and/or a second user input (e.g., input 656 as shown in FIG. 6I) at the second audio output device case. In some embodiments, the first user input and/or the second user input include pressing a mechanical button (e.g., input device 326 as shown in FIG. 6K), pressing a virtual button or icon (e.g., selectable element 653-1 as shown in FIG. 6I) on a touch-sensitive display, and tapping on an exterior of the respective audio output device case. The tapping input may be determined by an accelerometer of the respective audio output device case. In some embodiments, the first user input and/or the second user input include opening and closing a portion of the respective audio output device case. The portion of the respective audio output device that opens and closes may be used to place the one or more audio output devices within audio output device case. Configuring the audio output device case(s) to communicatively couple the first and second sets audio output devices in accordance with detecting an input at an audio output device case improves functionality of the audio output device case and the audio output devices (e.g., providing new capabilities) and may reduce the number of inputs needed to communicatively couple the sets of audio output devices (e.g., allowing the user to perform the operation without needing to handle and/or switch between multiple devices).

In some embodiments, the first user input and/or the second user input at the first and second audio output device cases, respectively, satisfy pairing criteria. The pairing criteria may include a duration of the input (e.g., a button is held down for a predefined number of seconds), a location of the input, a type of input, and/or a number of inputs (e.g., a double or triple tap on a button or the exterior of the respective audio output device case.)

In some embodiments, the first type of physical interaction further includes (1116), after the first user input (e.g., input 654 as shown in FIG. 6I) and/or the second user input (e.g., input 656 as shown in FIG. 6I), movement (e.g., movement corresponding to arrows 658 as shown in FIG. 6I) of the first audio output device case and/or the second audio output device case to within a threshold distance of one another. In some embodiments, the determination of the movement of the first audio output device case towards the second audio output device case occurs after a user input (e.g., tap on a respective touch screen associated with the respective audio output device case or a button press of a respective button associated with the respective audio output device case. In some embodiments, the movement of the first or second audio output device cases occurs within a predefined amount of time (e.g., 1 second, 2 seconds, 10 seconds, or 30 seconds) after the first and/or second user input. Configuring the audio output device case(s) to communicatively couple the first and second sets audio output devices in accordance with detecting movement and then an input at the audio output device case improves functionality of the audio output device case (e.g., providing a new capability) and reduces user mistakes when operating/interacting with the devices, which, additionally, reduces power usage and improves battery life of the devices by enabling the user to use the devices more quickly and efficiently.

In some embodiments, the first type of physical interaction further includes (1118), prior the first user input (e.g., input 666 as shown in FIG. 6K) and/or the second user input (e.g., input 668 as shown in FIG. 6K), movement (e.g., movement corresponding to arrows 670 in FIG. 6K) of the first audio output device case and/or the second audio output device case to within a threshold distance of one another. In some embodiments, the determination of the movement of the first audio output device case towards the second audio output device case occurs before a user input (e.g., tap on a respective touch screen associated with the respective audio output device case or a button press of a respective button associated with the respective audio output device case. In some embodiments, the first and/or second user input occurs within a predefined amount of time (e.g., 1 second, 2 seconds, 10 seconds, or 30 seconds) after the movement. Configuring the audio output device case(s) to communicatively couple the first and second sets audio output devices in accordance with detecting an input and then specific movement at the audio output device case improves functionality of the audio output device case (e.g., providing a new capability) and reduces user mistakes when operating/interacting with the devices, which, additionally, reduces power usage and improves battery life of the devices by enabling the user to use the devices more quickly and efficiently.

In some embodiments, the first set of audio output devices (e.g., wearable audio output devices 301-1 as shown in FIG. 6B) are concurrently communicatively coupled (1120) to the second set of audio output devices (e.g., wearable audio output devices 301-2) and to a companion device (e.g., device 100). The companion device may include a smartphone, a smartwatch, and/or a tablet. Configuring the first set of audio output devices to concurrently communicatively couple with the second set of audio output devices and with a companion device improves functionality of the first set of audio output devices (e.g., providing new capabilities) and may reduce the number of inputs needed to establish and/or maintain multiple audio paths.

In some embodiments, the first set of audio output devices are communicatively coupled to the second set of audio output devices while playing (1122) back audio (e.g., audio data 608 as shown in FIG. 6B) received from the companion device. In some embodiments, the first set of one or more audio output devices concurrently playback the audio received from the other set of one or more audio output devices and the audio received from the companion device. Configuring the first set of audio output devices to playback audio from a companion device while communicatively coupled to a second set of audio output devices improves functionality of the first set of audio output devices (e.g., providing new capabilities) and may reduce the number of inputs needed to playback and route audio data.

In some embodiments, communicatively coupling the first set of audio output devices with the second set of audio output devices comprises establishing (1124) a direct wireless communication link (e.g., the connection to transmit and receive audio data 634 as shown in FIG. 6F) between the first set of audio output devices and the second set of audio output devices. In some embodiments, the direct wireless communication link is a wireless connection between the first set of one or more audio output devices with the second set of one or more audio output devices. For example, the first set of one or more audio output devices is connected to the second set of one or more audio output devices such that the first audio signals are only transmitted and received between the first set of one or more audio output devices and the second set of one or more audio output devices. In another example, the audio signals are not transmitted and/or received through a third device (e.g., the audio output device case or a companion device). In some embodiments, communicatively coupling the first set of one or more audio output devices with the second set of one or more audio output devices comprises coupling the sets pursuant to a wireless protocol (e.g., a pairing protocol). Establishing and using a direct communication link between the first and second sets of audio output devices improves functionality of the audio output devices, may reduce latency in the connection between the devices, and allows the devices to communicatively couple without reliance on external networks.

In some embodiments, communicatively coupling the first set of audio output devices with the second set of audio output devices comprises communicatively coupling (1126) the first set of audio output devices and the second set of audio output devices via the first audio output device case (e.g., audio output device case 342-1 as shown in FIG. 6B) and/or the second audio output device case (e.g., audio output device case 342-2 as shown in FIG. 6B). For example, audio is routed from the first set of one or more audio output devices to the first audio output device case (e.g., audio data 620 as shown in FIG. 6B). In this example, the first audio output device case is communicatively coupled to the second audio output device case and the audio is routed from the first audio output device case to the second audio output device case (e.g., audio data 622 in FIG. 6B). Finally, in this example, the audio is routed from the second audio output device case to the second set of one or more audio output devices (e.g., audio data 624 in FIG. 6B). Communicatively coupling the first and second sets of audio output devices via one or more audio output device cases allows for processing to be performed at the device case(s) thereby allowing the audio output devices to be smaller and/or lighter (e.g., less processing components needed at the audio output devices), which, additionally, reduces power usage and improves battery life of the audio output devices.

While the first set of one or more audio output devices are communicatively coupled with the second set of one or more audio output devices, first set of one or more audio output devices output (1127) audio captured by the second set of one or more audio output devices.

In some embodiments, the first audio output device case detects (1128) a third user input (e.g., input 694 as shown in FIG. 6O) and in response to detecting the third user input, changes an output volume (e.g., adjusting volume in accordance with volume slider 692 as shown in FIGS. 6O-6P) of audio received from the second set of audio output devices in accordance with the third user input. For example, the volume change occurs at the first set of one or more audio output devices only. In another example, the user input does not change a capture volume or output volume at the second set of one or more audio output devices. In some embodiments, the magnitude of the user input correlates with the magnitude of the volume change. For example, the audio received from the second set of one or more audio output devices comprises audio captured by one or more microphones of the second set of one or more audio output devices. In some embodiments, the output volume change affects the audio from the second set of one or more audio output devices without affecting the audio from other audio output devices. For example, the output volume changes increases or decreases the audio from the second set of one or more audio output devices, but does not change an output volume of audio content received from a companion device. In some embodiments, the output volume change affects a set of audio sources that includes the second set of one or more audio output devices. For example, a selected set of audio sources that includes the second set of one or more audio output devices, but excludes at least one other active audio source that is not in the selected set. Adjusting output volume at audio output device(s) in response to detecting a user input at the audio output device case improves functionality of the audio output device case (e.g., providing a new capability to adjust output volume(s) of audio source(s)) and reduces the number of inputs needed to adjust volume levels (e.g., simplifying the user-device interface by forgoing the need to navigate multiple menus or other user interfaces and/or allowing a user to avoid having to switch between multiple devices).

In some embodiments, the first audio output device case detects (1130) a fourth user input (e.g., input 6104 as shown in FIG. 6Q) and in response to detecting the fourth user input, adjust a magnitude of ambient sound (e.g., adjusting a modification of ambient sound in accordance with volume slider 6100 as shown in FIGS. 6Q-6R) from a physical environment modified by the first set of audio output devices. For example, adjusting the magnitude of ambient sound from the physical environment includes adjusting a level of transparency and/or noise cancellation. In some embodiments, the fourth user input is detected at the first audio output device case, one of the first set of one or more audio output devices (e.g., wearable audio output devices 301-1), or a companion device (e.g., a phone, a watch, or other type of companion device). In some embodiments, changing a magnitude of ambient sound from the physical environment modified by the first set of one or more audio output devices includes switching from an active noise cancellation (ANC) mode to an active transparency mode. In some embodiments, changing a magnitude of ambient sound includes changing a relative amount of ambient sound blocked by the ANC mode and the amount passed-through by the active transparency mode. In some embodiments, changing the magnitude of ambient sound from the physical environment includes disabling the ANC mode. In some embodiments, changing the degree of ANC comprises reducing the ANC from above a threshold percentage (e.g., 90%, 80%, 75%, or 50%) to below the threshold percentage. In some embodiments, changing the degree of active transparency comprises enabling an active transparency mode. In some embodiments, changing the degree of active transparency comprises increasing the active transparency from below a threshold percentage (e.g., 15%, 20%, 30%, or 50%) to above the threshold percentage. In some embodiments, the first set of one or more audio output devices changes the one or more properties of the first set of one or more audio output devices to modify the magnitude of ambient sound from the physical environment in accordance with a determination that the wearable audio output device is operating in a first state (e.g., with ANC enabled). In some embodiments, the first set of one or more audio output devices forgoes changing the one or more properties of the wearable audio output device in accordance with a determination that the wearable audio output device is operating in a second state (e.g., with ANC disabled). Adjusting a magnitude of ambient sound at audio output device(s) in response to detecting a user input at the audio output device case improves functionality of the audio output device case (e.g., providing a new capability to adjust ambient sound levels) and reduces the number of inputs needed to adjust the magnitude of ambient sound (e.g., simplifying the user-device interface by forgoing the need to navigate multiple menus or other user interfaces and/or allowing a user to avoid having to switch between multiple devices).

In some embodiments, the first audio output device case detects (1132) a second physical interaction that involves the first audio output device case and a third audio output device case (e.g., as illustrated in FIG. 6N) for a third set of audio output devices (e.g., wearable audio output devices 301-3 as shown in FIG. 6N) and in response to detecting the second physical interaction, in accordance with a determination that the second physical interaction is the first type of physical interaction, communicatively couples the first set of audio output devices with the third set of audio output devices for transmitting and receiving second audio signals between the first set of audio output devices and the third set of audio output devices (e.g., transmitting and receiving audio data 686 as shown in FIG. 6N). In some embodiments, the second physical interaction is the same as the first physical interaction. In some embodiments, the second physical interaction comprises a movement of the first audio output device case and/or the second audio output device case while the first audio output device case and the second audio output device case are within a threshold distance of one another. In some embodiments, the second physical interaction comprises an input that corresponds to touching the first audio output device case to the second audio output device case. In some embodiments, the second physical interaction comprises a first user input at the first audio output device case and/or a second user input at the second audio output device case. In some embodiments, the second physical interaction is detected via a set of sensors (e.g., one or more sensors). In some embodiments, at least one of the set of sensors is a component of the first audio output device case, the second audio output device case, the first set of audio output devices, the second set of audio output devices, or a companion device (e.g., a phone, a wearable device, or other type of companion device). In some embodiments, the third set of one or more audio output devices is distinct from the first set of one or more audio output devices and distinct from the second set of one or more audio output devices. Providing a means for establishing wireless connections between sets of audio output devices using an audio output device case enhances the operability of the audio output device case (e.g., providing new functionality) and makes the user-device interface more efficient (e.g., by helping the user to achieve an intended outcome).

In some embodiments, the first audio output device case concurrently communicatively couples (1134) the first set of audio output devices, the second set of audio output devices, and the third set of audio output devices (or causes the first, second, and third sets of audio output devices to be concurrently communicatively coupled). For example, the users may wish to concurrently communicatively couple the three sets of audio output devices so that they can talk to one another through their audio output devices (e.g., walkie-talkie style). This communication allows the users to move through noisy environments and to move independently without disrupting the conversation. In some embodiments, communicatively coupling the first set of one or more audio output devices with the third set of one or more audio output devices causes the second set of one or more audio output devices to be communicatively coupled to the third set of one or more audio output devices. For example, audio captured at the second set of one or more audio output devices is directly transmitted to both the first set of one or more audio output devices and the third set of one or more audio output devices. The second set of one or more audio output devices may be communicatively coupled to the third set of one or more audio output devices through the first set of one or more audio output devices. For example, audio captured at the second set of one or more audio output devices is transmitted to the first set of one or more audio output devices, which is then re-transmitted to the third set of one or more audio output devices. Configuring the first set of audio output devices to concurrently communicatively couple with the second and third sets of audio output devices improves functionality of the first set of audio output devices (e.g., providing new capabilities) and may reduce the number of inputs needed to establish and/or maintain multiple audio paths.

In some embodiments, communicatively coupling the first set of one or more audio output devices with the third set of one or more audio output devices causes the first set of one or more audio output devices to cease to be communicatively coupled. In some embodiments, in accordance with a determination that the second physical interaction is the first type of physical interaction, concurrently communicatively coupling the first set of one or more audio output devices, the second set of one or more audio output devices, and the third set of one or more audio output devices; and in accordance with a determination that the second physical interaction is a second type of physical interaction, coupling the first set of one or more audio output devices with the third set of one or more audio output devices and ceasing to communicatively couple the first set of one or more audio output devices and the second set of one or more audio output device. For example, in response to the second type of physical interaction, the connection between the first and third sets replaces the previous connection between the first and second sets.

It should be understood that the particular order in which the operations in FIGS. 11A-11C have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 1000, 1200, and 1300) are also applicable in an analogous manner to method 1100 described above with respect to FIGS. 11A-11C. For example, the devices, user interfaces, inputs, and functions described above with reference to method 1100 optionally have one or more of the characteristics of the devices, user interfaces, inputs, and functions described herein with reference to other methods described herein (e.g., methods 1000, 1200, and 1300). For brevity, these details are not repeated here.

FIGS. 12A-12C are flow diagrams illustrating method 1200 for displaying a dynamic visual element in accordance with some embodiments. Method 1200 is performed at an audio output device case (e.g., audio output device case 342). The audio output device case includes a display device (e.g., display 372 as shown in FIG. 3H). The audio output device case can optionally include an illuminable visual indicator (e.g., indicator 325 as shown in FIG. 3H), a camera (e.g., camera 324 as shown in FIG. 3H), and/or an input device (e.g., input device 326 as shown in FIG. 3H). In some embodiments, the display is a touch-screen display with a touch-sensitive surface integrated with the display. In some embodiments, the display is separate from one or more touch-sensitive surfaces. In some embodiments, the audio output device case is an audio accessory charging case, a wireless headphone case, a wireless headset case, and/or other types of storage accessories for one or more wearable audio output devices. Some operations in method 1200 are, optionally, combined and/or the order of some operations is, optionally, changed.

As described below, method 1200 provides an improved interface for receiving feedback from and controlling an audio output device case and/or corresponding audio output devices by providing dynamic visual elements on a display that meets similarity criteria with an exterior of the audio output device case. Providing dynamic visual feedback makes the user-device interface more intuitive and efficient and allows for a user to not have to switch between multiple devices to interact with the audio output device case and/or associated accessories (e.g., the user need not find/switch to other electronic devices (e.g., a smartphone or tablet) to receive the status notifications and/or issue commands), which, additionally, reduces power usage and improves battery life of the audio output device case by enabling the user to use the audio output device case more quickly and efficiently.

The audio output device case detects (1202) an occurrence of a first event. For example, the first event can occur at the case and/or at a device communicatively coupled to the case (e.g., at an electronic accessory corresponding to the audio output device case). The first event can include a first-time setup (e.g., “hello” as shown in FIG. 7E). The first event can also include receiving a notification from a smartphone and/or other type of companion device.

In response to detecting (1204) the occurrence of the first event, in accordance with a determination that the display device (e.g., display 372) is disabled, the audio output device case causes (1206) the display device to be enabled (e.g., at least a portion of display 372 is enabled when displaying music icon 706 in FIG. 7A). While the display device is disabled, the display device and an exterior of the audio output device case (e.g., excluding the display device) meet similarity criteria (e.g., as described previously with reference to FIGS. 3K and 3L). In some embodiments, the audio output device case is in communication with a display device (e.g., the display device is separate and distinct from the audio output device case). In some embodiments, a display device that is disabled includes an unlit display, an inactive display, and/or a blank display. For example, a display device is disabled when it is not displaying anything (e.g., black screen or off) or when a backlight (e.g., illumination layer 392 in FIG. 3L) of the display device is off. In some embodiments, a display device is enabled when it is lit or active. For example, a display device is enabled while it is displaying something.

In some embodiments, the display device is a hidden display. A hidden display is indistinguishable (e.g., indiscernible or imperceptible) from a portion of an exterior of the audio output device case that does not include the display device. In some embodiments, the display device meets similarity criteria when the screen is indistinguishable (e.g., visually or texturally) as a separate component of the audio output case in at least some lighting conditions. In some embodiments, the lighting conditions include a predefined amount of light, an angle of the light relative to the audio output case, a color (e.g., a wavelength) of the light. In some embodiments, a hidden display is a “dead front” display. In some embodiments, traditional implementations result in a display that appears behind the surface by some depth. Traditional implementations that reduce the depth are low resolution.

In some embodiments, the display device is positioned (1208) behind a portion of the exterior (e.g., exterior 391 as shown in FIG. 3L) of the audio output device case. In some embodiments, the portion of the exterior of the audio output device case acts as an optical diffuser (e.g., scatters light in all directions) (e.g., diffusion layer 390 as shown in FIG. 3L). Scattering light in all directions can decrease the perceived sharpness of the hidden display. In some embodiments, the display device is directly behind the portion of the exterior such that the display device is in contact with the portion of the exterior. A zero distance between the display device and the portion of the exterior may be desirable to increase the perceived sharpness of the display device. The perceived sharpness of the display device may decrease when the distance is non-zero because the light emission from the display device may increase in size, relative to the original size of the pixel's geometry, as a function of distance from the display device. The increase in size of the light emission may be dependent on the light source of the display device. In some embodiments, the display device is directly behind the portion of the exterior such that the display device is in contact with a molded fiber plate material which is in contact with the portion of the exterior. The molded fiber plate material may replace a traditional cover glass of the display device. The molded fiber plate can provide additional mechanical stiffness to the display device. The molded fiber plate may be optically inert (e.g., does not impact the light emission as the light emission passes through the molded fiber plate). In some embodiments, the molded fiber plate material is integrated with the display device. Positioning the display device behind a portion of the case exterior provides additional protection for the display device (e.g., protection from being impacted or pierced).

In some embodiments, the portion of the exterior collimates the light emission from the display device. Collimating the light reduces its expansion (e.g., increase in size) through the portion of the exterior (e.g., a layer of the portion of the exterior that acts as the optical diffuser, or the color layer of the portion of the exterior). In some embodiments, the display device does not have a black matrix structure around the emission areas for each pixel. In some embodiments, the display device has a colored matrix structure that matches the color of the exterior of the audio output device case.

In some embodiments, the similarity criteria include a surface reflectance similarity criterion. For example, the display device and the exterior of the audio output device case meet the surface reflectance criteria when the surface reflectance of the display device and the portion of the exterior of the audio output case is within a specified threshold of the surface reflectance of the exterior of the audio output device case that is distinct from the portion of the exterior of the audio output case.

In some embodiments the display device and/or the portion of the exterior of the audio output device case includes slanted louvers. The slanted louvers can be positioned over the display device. The slanted louvers can be color matched to the color of the exterior of the audio output device. The slanted louvers can be slanted such that the user sees the side of the louvers. In some embodiments, when the display is disabled, the user sees the color of the louvers. In some embodiments, there are gaps between the slanted louvers that act as wave guides for photons emitted by the display device. In some embodiments, the photons are diffused at a diffusion layer above the slanted louvers.

In some embodiments, the display device and/or the portion of the exterior of the audio output device case includes a bandpass layer that only allows a predefined wavelength to pass through. The predefined wavelength can be non-visible. Light that is not in the predefined wavelength are reflected broadly. The light that is reflected can be tuned to reflect a predefined color (e.g., white). A clear structure with phosphor nano-particles can be positioned above the bandpass layer. The phosphor nano-particles can be activated by the predefined wavelength that passes through the bandpass layer. The activated phosphor nano-particles can create visible and emissive displays.

In some embodiments, the display device and/or the portion of the exterior of the audio output device case includes an array of micro-lenses. The area between the micro-lenses can be opaque and match the color of the exterior of the audio output device case. The micro-lenses can reflect ambient light and transmit photons through the micro-lenses.

In some embodiments, the display device meets (1210) one or more image quality criteria. In some embodiments, the image quality criteria include image contrast criteria. For example, the image contrast is at least 2:1 for a user to see the content displayed using the display device. The image contrast ratio can be measured relative to the exterior of the audio output device. The measurement can be taken when the exterior of the audio output device case is under high ambient illumination (e.g., outdoor daylight on a clear day). High ambient illumination can be around 70,000 to 100,000 lux. In some embodiments, the image quality criteria include sharpness criteria. The sharpness criteria can be measured using the modulation transfer function or the contrast transfer function. Providing a display device that meets image quality criteria allows for more detailed and legible notifications and feedback about a state of the audio output device case (and/or states of companion devices).

The audio output device case displays (1212), via a first portion of the display device, a dynamic visual element (e.g., music icon 706 as shown in FIG. 7A) corresponding to the first event (e.g., initiation of audio playback by an audio source corresponding to music icon 706). In some embodiments, the first portion of the display device includes the portion of the display that has a dynamic visual element. For example, dynamic visual element includes audio effects, audio playback controls (e.g., play, pause, fast forward, and rewind), Find My (e.g., arrow towards the missing device), available audio output devices (e.g., speakers, headphones, headset, earbuds), and/or a viewfinder (e.g., for a camera built into the case or for as a viewfinder for a smartphone camera).

The dynamic visual element changes over time (e.g., progressively displaying “hello” as shown in FIG. 7E). For example, the dynamic visual element can change from a first dynamic visual element to a second dynamic visual element. In another example, the dynamic visual element can change from a first version to a second version. Additionally, the dynamic visual element can be a hello graphic that is drawn over a period of time.

While the display device is enabled, a second portion of the display device, distinct from the first portion of the display device, and the exterior of the audio output device case meet the similarity criteria. In some embodiments, the second portion of the display device is visually similar to the display device when disabled. In some embodiments, the second portion of the display is indistinguishable from a portion of an exterior of the audio output device case that does not include the display device. In some embodiments, the similarity criteria include a surface reflectance similarity criterion. For example, the display device and the exterior of the audio output device case meet the surface reflectance criteria when the surface reflectance of the display device is within a specified threshold of the surface reflectance of the exterior of the audio output device case.

In some embodiments, displaying the dynamic visual element (e.g., music icon 706 as shown in FIG. 7B) includes (1214) adjusting a parameter of the dynamic visual element selected from the group consisting of: a shape, a size, a location, and a color. For example, a shape, size, location, and/or color of the dynamic visual element changes over time (e.g., to cause an animation to be displayed). Configuring the audio output device case to display dynamic visual elements with adjusted parameter(s) allows for providing improved feedback about the state of the audio output device case (e.g., display of additional details and/or displayed with attributes that are configured for different settings).

In some embodiments, the dynamic visual element (e.g., music icon 388 as shown in FIG. 3L) is displayed (1216) on a surface of the exterior (e.g., exterior 391 as shown in 3L) of the audio output device case. In some embodiments, the dynamic visual element appears at zero depth relative to the surface of the exterior of the audio output device case. For example, the dynamic visual element appears to be projected onto the exterior of the audio output device case. Displaying visual elements on a surface of the exterior of the audio output device case improves feedback (e.g., improving visibility of the visual elements) about a state of the audio output device case.

In some embodiments, a visual appearance of the dynamic visual element changes (1218) by less than a threshold amount across a predefined range of viewing angles for viewing the audio output device case (e.g., different viewing angles of the audio output device case 342 as shown in FIG. 7F). In some embodiments, the color of the dynamic visual element shifts by a threshold amount across the predefined range of viewing angles. In some embodiments, the color of the dynamic visual element desaturates by a threshold amount across the predefined range of viewing angles. In some embodiments, respective parameters associated with the visual appearance of the dynamic visual element have respective threshold amounts across the respective range of viewing angles. Providing dynamic visual elements with a visual appearance that is substantially the same across a wide range of viewing angles improves feedback (e.g., improving visibility of the visual elements) about a state of the audio output device case.

In some embodiments, the dynamic visual element is (1220) monochromatic. In some embodiments, a brightness of the monochromatic dynamic visual element is variable (e.g., based on lighting conditions and/or user preferences). Providing monochromatic visual elements improves feedback (e.g., improving visibility of the visual elements) about a state of the audio output device case.

In some embodiments, the dynamic visual element is (1222) non-emissive. In some embodiments, the dynamic visual element is displayed based on the ambient brightness such that the dynamic visual element does not appear to be brighter than the exterior of the audio output device case. In some embodiments, the audio output device captures information regarding the ambient brightness (e.g., via a brightness sensor, an image sensor, and/or other type of sensor) and uses the captured information to adjust a brightness of the dynamic visual element. Providing non-emissive dynamic visual elements improves feedback (e.g., improving visibility of the visual elements) about a state of the audio output device case, and may also reduce power consumption of the audio output device case.

In some embodiments, the dynamic visual element includes (1224) text (e.g., “hello” graphic 720 as shown in FIG. 7E). For example, the text may be a “hello” welcome animation when the user first turns on the audio output device case. In some embodiments, the text includes information associated with the audio output device case (e.g., battery level). In some embodiments, the text includes information associated with one or more audio output devices that are in communication with the audio output device case (e.g., battery level or volume). In some embodiments, the text includes information associated with currently outputted audio at the one or more audio output devices. In some embodiments, the displayed text varies based on time and/or context. For example, the text may indicate the current date/time and/or may indicate appointments/tasks that a user has scheduled for a given time. As another example, the text may have an appearance (e.g., a size, color, or other visual parameter) that changes based on time of day and/or context information for the audio output device case. The context information for the audio output device case may include information indicating whether the audio output device case is in a private or public setting, information about an orientation of the audio output device case (e.g., lying face-up, face-down, or standing on edge), environmental information (e.g., current light levels and/or other visibility conditions), information about the audio output device case (e.g., charge levels, device settings, and/or other device information), information about a user of the device, and/or other context information. As an example, the text may have a smaller size in accordance with a determination that the audio output device case is in a public setting as opposed to a private setting. As another example, the text may have a higher brightness in accordance with a determination that the audio output device case is in a high light environment as opposed to a low light environment. Providing textual visual elements improves feedback about a state of the audio output device case.

In some embodiments, the text is progressively displayed (1226) over a first period of time (e.g., progressive display of “hello” graphic as illustrated in FIG. 7E). In some embodiments, the animation to display the text is progressive over a first period of time. For example, the animation to display the text simulates handwriting the text over the first period of time. Providing progressively displayed textual visual elements improves feedback about a state of the audio output device case.

In some embodiments, the dynamic visual element includes (1228) one or more points of light that move over a second period of time (e.g., the portions of illumination layer 392 (and/or individual light sources) can turn on or off such that the music icon 388 appears to move around the display). In some embodiments, the one or more points of light correspond to one or more point light sources. In some embodiments, the one or more point light sources are one or more LEDs. For example, the points of light appear to move as different LEDs are turned on and off. In some embodiments, the one or more point light sources operate in sequence to form animations. For example, a number of point light sources represent the battery level of the audio output device case. Displaying dynamic visual elements using one or more points of lights improves feedback about a state of the audio output device case and may also reduce power consumption of the audio output device case.

In some embodiments, the dynamic visual element includes (1230) a reference (e.g., arrow icons 712 and 714 as shown in FIGS. 7C and 7D) to one or more real-world entities (e.g., audio source 502 and device 300 as shown in FIG. 7C) in an environment of the audio output device case, where the one or more real-world entities includes an electronic device and/or a person. In some embodiments, the reference includes an arrow and/or pointer. In some embodiments, the arrow and/or pointer is directed towards the location of the real-world entity. In some embodiments, the electronic device is communicatively coupled to the audio output device case (e.g., the electronic device is transmitting location information (e.g., a relative distance and/or position) to the audio output device case. In some embodiments, the electronic device is broadcasting location information, such as when a Bluetooth device is searching for a connection). In some embodiments, the person is in possession of the electronic device. Providing reference to real-world entities via the dynamic visual element improves functionality of the audio output device case (e.g., new capabilities) and provides feedback about the real-world entities and the audio output device case.

In some embodiments, the audio output device case provides (1232) haptic feedback at the audio output device case in accordance with a determination that the audio output device case is within a threshold distance to one of the one or more real-world entities. For example, with reference to FIG. 7D, haptic feedback can be provided when the audio output device case 342 is within a threshold distance of audio source 502. In some embodiments, the audio output device case forgoes providing the haptic feedback at the audio output device case in accordance with a determination that the audio output device case is not within the threshold distance to one of the one or more real-world entities. In some embodiments, the haptic feedback is provided only when the audio output device case is within a threshold distance to an object of interest selected from the one or more real-world entities. In some embodiments, haptic feedback is based on user-preference. In some embodiments, the threshold distance to the one or more objects is based on whether the object is an electronic device or a person. In some embodiments, the rate of haptic feedback increases as the distance between the audio output device case and the one or more real-world entities decreases. Generating haptic feedback regarding a distance to one of the one or more real-world entities provides improved feedback about a state of the audio output device case.

In some embodiments, the one or more real-world entities include (1234) one or more entities that are available to communicatively couple with the audio output device case (e.g., audio source 502 as shown in FIG. 7C). In some embodiments, the audio output device case displays respective visual elements (e.g., device icons 711 and 713 as shown in FIG. 7C) for each of the one or more entities that are available to communicatively couple with the audio output device case. In some embodiments, the one or more entities that are available to communicatively couple with the audio output device case comprise entities that are broadcasting their availability for communicatively coupling. In some embodiments, the one or more entities that are available to communicatively couple with the audio output device case comprise entities that have communicated their availability to the audio output device case. In some embodiments, the entities include audio output devices such as earbuds, headphones, speakers, or other audio sources that are available to communicatively couple. In some embodiments, the entities include real-world entities that are able to communicatively couple to the audio output device. These entities may require additional steps to be configured to be available to communicatively couple to the audio output device. Providing information about one or more entities that are available to communicatively couple with the audio output device improves feedback about a state of the audio output device case.

In some embodiments, the audio output device case detects (1236) an occurrence of a second event (e.g., launching a viewfinder (e.g., a camera preview) for a camera of an audio output device case or a companion device) and in response to detecting the occurrence of the second event, displays, via the first portion of the display device, content (e.g., camera preview 802 as shown in FIG. 8A) corresponding to the second event. In some embodiments, the content includes content that is distinct from the dynamic visual element. In some embodiments, the content requires additional contrast. In some embodiments, the content includes a second dynamic visual element. In some embodiments, in response to detecting the occurrence of the second event, the content is displayed via a second portion of the display device. In some embodiments, the second event comprises an electronic communication event (e.g., the audio output device case detects an incoming communication from another device or system (e.g., via a wired or wireless connection)). In some embodiments, the second event comprises a change in state of the audio output device case and/or a set of audio output devices corresponding to the audio output device case. In some embodiments, the second event comprises a user input (e.g., detected at the audio output device case, the set of audio output devices, or a companion device coupled to the audio output device case. Displaying content about an event at the audio output device case improves feedback about a state of the audio output device case.

In some embodiments, the content (e.g., camera preview 802 as shown in FIG. 8A) includes (1238) more colors and/or detail than the dynamic visual element. In some embodiments, content includes more detail when the content is a higher resolution than the dynamic visual element. The content may also include more detail when a higher resolution at the display device is necessary to resolve details within the content. For example, the dynamic visual element is 50 pixels by 50 pixels and the content is 200 pixels by 200 pixels. Providing content with varying levels of detail and/or colors improves feedback about a state of the audio output device case and may reduce power consumption of the audio output device case.

In some embodiments, in response to detecting the occurrence of the second event (e.g., launching a viewfinder for a camera of an audio output device case or a companion device), the display device adjusts (1240) a parameter selected from the group consisting of a color depth, a contrast ratio, and a resolution associated with the display device. In some embodiments, the parameters are changed based on the content. For example, content that is a monochromatic black and white image causes the contrast ratio parameter to increase. Providing content with adjusted parameters improves feedback about a state of the audio output device case and may reduce power consumption of the audio output device case.

In some embodiments, the content includes (1242) a camera preview (e.g., camera preview 809 as shown in FIG. 8C). In some embodiments, the camera preview is a viewfinder or a live video feed. In some embodiments, the camera preview is from a camera of the audio output device case. In some embodiments, the camera preview is from a camera associated with a companion device (e.g., smartphone). In some embodiments, the camera preview is from a standalone camera that is in communication with the audio output device case. In some embodiments, the camera preview displays all capturable image data. In some embodiments, the camera preview displays a cropped or zoomed-in version of the capturable image data. For example, the camera preview displays all capturable image data for the user to frame the image. In another example, the camera preview shows the cropped or zoomed-in version for the user to more easily see that the subject matter (e.g., people) are captured well. Displaying camera previews improves feedback about a state of the audio output device case.

In some embodiments, while the camera preview (e.g., camera preview 809 as shown in FIG. 8C) is displayed, the audio output device case detects (1244) a user input (e.g., input 814 as shown in FIG. 8C) to capture an image associated with the camera preview and in response to detecting the user input, captures (1244) the image associated with the camera preview. In some embodiments, the image captured is what is displayed by the camera preview. For example, the camera preview displays all the capturable image data, and in response to detecting the user input, captures all the capturable image data. In another example, the camera preview displays the cropped or zoomed-in version of the capturable image data, and in response to detecting the user input, captures only the cropped or zoomed-in version of the capturable image data. In some embodiments, the image captured is what is detected by a camera sensor. For example, regardless of what the camera preview is displaying, in response to the user input, the camera captures all the capturable image data. In some embodiments, the user input is detected at the audio output device case (e.g., detected via a touch sensor (e.g., a capacitive sensor, a force sensor, or other type of touch sensor), a mechanical button, and/or other type of input device). In some embodiments, the user input is detected at a set of audio output devices coupled to the audio output device case. In some embodiments, the user input is detected at a companion device (e.g., a phone, watch, or other type of companion device) that is communicatively coupled to the audio output device case. Capturing images associated with camera previews in response to inputs at the audio output device case improves functionality of the audio output device case (e.g., new capabilities) and may reduce the number of inputs needed to capture the images (e.g., allowing the user to capture images without needing to handle and/or switch between multiple devices).

It should be understood that the particular order in which the operations in FIGS. 12A-12C have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 1000, 1100, and 1300) are also applicable in an analogous manner to method 1200 described above with respect to FIGS. 12A-12C. For example, the devices, user interfaces, inputs, and functions described above with reference to method 1200 optionally have one or more of the characteristics of the devices, user interfaces, inputs, and functions described herein with reference to other methods described herein (e.g., methods 1000, 1100, and 1300). For brevity, these details are not repeated here.

FIGS. 13A-13C are flow diagrams illustrating method 1300 for adjusting a volume level of an audio source in accordance with some embodiments. Method 1300 is performed at an audio output device case (e.g., audio output device case 342 as shown in FIG. 3H). The audio output device case optionally includes a display device (e.g., display 372 as shown in FIG. 3H), one or more touch-sensitive surfaces, and/or an input device (e.g., input device 326 as shown in FIG. 3H). The audio output device case optionally includes an illuminable visual indicator (e.g., indicator 325 as shown in FIG. 3H). In some embodiments, the display is a touch-screen display and at least one of the touch-sensitive surfaces are on or integrated with the display. In some embodiments, the display is separate from the touch-sensitive surfaces. In some embodiments, the audio output device case is an audio accessory charging case, a wireless headphone case, a wireless headset case, and/or other types of storage accessories for one or more wearable audio output devices. Some operations in method 1300 are, optionally, combined and/or the order of some operations is, optionally, changed.

As described below, method 1300 provides an improved interface for adjusting volume levels of different audio sources. Providing a means for adjusting volume levels for individual audio sources (or groups of audio sources) using an audio output device case enhances the operability of the audio output device case (e.g., providing new functionality) and makes the user-device interface more efficient (e.g., by helping the user to achieve an intended outcome), which, additionally, reduces power usage and improves battery life of the audio output device case and the corresponding audio output devices by enabling the user to use the audio output device case and the audio output devices more quickly and efficiently.

While a first audio source is active (e.g., the audio source corresponding to music icon 918 in FIG. 9A) for one or more audio output devices (e.g., wearable audio output devices 301) at a first volume level (e.g., as illustrated in volume graph 926 in FIG. 9A) and a second audio source (e.g., the audio source corresponding to phone icon 920 as shown in FIG. 9A) is active for the one or more audio output devices at a second volume level, the audio output device case detects (1302) a first input (e.g., input 922 in FIG. 9A) at an audio output device case. In some embodiments, the audio output device case is an audio accessory charging case and/or a wireless headphone case. In some embodiments, the one or more audio output devices include speakers, headphones, a headset, and/or earbuds. In some embodiments, the audio output device case includes one or more input devices (e.g., a touch screen, a gyroscope, an accelerometer, an IMU). In some embodiments, the second audio source is distinct from the first audio source.

In some embodiments, an active source includes a source whose volume level is assigned and adjustable, such as for an application that is running (e.g., “Now Playing”), an external audio source, or a second set of one or more audio output devices. In some embodiments, the first audio source includes ambient noise (e.g., transparency or noise cancellation). In some embodiments, the application is running on the audio output device case. In some embodiments, the application is running on a companion device (e.g., smartphone, watch, or tablet). In some embodiments, the second set of one or more audio output devices are connected to form a voice link between a set of one or more audio output devices and the second set of one or more audio output devices.

In some embodiments, the first input (e.g., input 922 in FIG. 9A) comprises (1304) movement detected at a portion of the audio output device case (e.g., the first input is a swipe gesture as illustrated in FIG. 9A). In some embodiments, the portion of the audio output device case includes a capacitive sensor, a pressure sensitive sensor, and/or other type of sensor. For example, a movement includes a swipe motion, a drag-and-drop motion, a rotation motion, and/or any other input that includes motion at the audio output device case (e.g., after initial contact with the audio output device case). In some embodiments, the movement is detected on a display of the audio output device case (e.g., a portion of the display that includes a representation of the first audio source (e.g., an icon or other user interface element)). In some embodiments, the movement is detected at a touch-sensitive portion (e.g., affordance 373 as shown in FIG. 9A) of the audio output device case (e.g., a portion designated for touch inputs and optionally denoted with grooves and/or protrusions). In some embodiments, the movement is detected along an edge and/or peripheral of the audio output device case. Adjusting relative volume levels of audio sources in response to movement inputs at the audio output device case enables the volume adjustment operation to be performed without displaying additional controls.

In some embodiments, the first input is detected via (1306) a capacitive sensor and/or a pressure sensor. In some embodiments, the capacitive sensor and/or the pressure sensor is part of the display device (e.g., a touch screen) (e.g., display 372). In some embodiments, the capacitive sensor and/or pressure sensor is not part of the display device (e.g., a touch pad) (e.g., affordance 373). In some embodiments, the capacitive sensor and/or the pressure sensor cover more area of the audio output device than the display device. For example, the first input can be detected beyond the edges of the display device to provide a more seamless user experience. An additional advantage may be to allow the user to see the display device when interacting with elements displayed on the display device. Adjusting relative volume levels of audio sources in response to inputs detected via capacitive/pressure sensor(s) enables the volume adjustment operation to be performed without displaying additional controls.

In some embodiments, the first audio source comprises (1308) a first application (e.g., music application corresponding to music icon 918 in FIG. 9A) and the second audio source comprises a second application (e.g., a telephony application corresponding to phone icon 920 in FIG. 9A) distinct from the first application. In some embodiments, the applications are running on the audio output device case or the companion device (e.g., a smartphone, smartwatch, or other type of device). In some embodiments, the first and second applications are executing on different devices. For example, the first application is an application executing at the audio output device case and the second application is an application executing on the companion device. In some embodiments, the first and second applications are executing on the same device (e.g., on the companion device). Adjusting relative volume levels of audio sources corresponding to different applications improves functionality of the audio output device case (e.g., new functionality) and may reduce the number of inputs needed to adjust volume levels (e.g., allowing the user to adjust volume levels without needing to handle and/or switch between multiple devices).

In some embodiments, the first audio source comprises (1310) a first electronic device (e.g., audio output device case 342 in FIG. 9D) and the second audio source comprises a second electronic device (e.g., portable multifunction device 100 in FIG. 9D) distinct from the first electronic device. In some embodiments, the electronic devices include a record player, a CD player, and an internet connected device configured to play internet media. In some embodiments, the first application is executing at the first electronic device and the second application is executing at the second electronic device. Adjusting relative volume levels of audio sources corresponding to different source devices improves functionality of the audio output device case (e.g., new functionality) and may reduce the number of inputs needed to adjust volume levels (e.g., allowing the user to adjust volume levels without needing to handle and/or switch between multiple devices).

In some embodiments, the first audio source includes (1312) ambient sound (e.g., ambient sound corresponding to ambient icon 938 in FIG. 9D) from a physical environment modified by the one or more audio output devices (e.g., wearable audio output devices 301). For example, transparency or noise cancellation (see details described previously with respect to adjusting a level of transparency or noise cancellation, as described previously with respect to operation 1130). In some embodiments, the ambient sounds are captured, at least in part, by the audio device case (e.g., audio output device case 342) and/or the companion device (e.g., device 100, device 300, or another companion device). Adjusting a magnitude of ambient sound at audio output device(s) in response to detecting a user input at the audio output device case improves functionality of the audio output device case (e.g., providing a new capability to adjust ambient sound levels) and reduces the number of inputs needed to adjust the magnitude of ambient sound (e.g., simplifying the user-device interface by forgoing the need to navigate multiple menus or other user interfaces and/or allowing a user to avoid having to switch between multiple devices).

In some embodiments, the audio output device case includes (1314) a display device (e.g., display 372 in FIG. 9A), where the display device, while disabled, and an exterior of the audio output device case meet one or more similarity criteria (e.g., as described previously with respect to operations 1206 and 1208). Configuring the audio output device case with a display device that meets similarity criteria provides improved feedback about a state of the audio output device case.

In response to detecting the first input, in accordance with the first input being a first type of input, the audio output device case adjusts (1316) audio output for the one or more audio output devices by adjusting a volume (e.g., adjusting the volume of a telephony source corresponding to phone icon 920 as shown in FIGS. 9A and 9B) of the first audio source relative to a volume of the second audio source (e.g., music source corresponding to music icon 918). For example, adjusting a volume of the first audio source relative to a volume of a second audio source includes increasing a volume of the first audio source relative to a volume of the second audio source or decreasing a volume of the first audio source relative to a volume of the second audio source.

In some embodiments, changing the relative volume of the first audio source and the second audio source is performed without changing the audio source (e.g., without changing which audio sources are active and/or which audio sources are currently outputting audio). In some embodiments, changing the relative volume is performed without changing a currently outputting audio from a respective audio source. For example, during playback of audio from the first audio source, the relative volume is changed without stopping or changing the playback of audio from the first audio source.

In some embodiments, the adjustment to the relative volume is based on (1318) a direction and/or a magnitude of the first input (e.g., input 954 as shown in FIG. 9F). For example, a swipe motion in a first direction (e.g., in an upwards direction relative to the audio output device case) increases a volume of the first audio source (e.g., based on a magnitude of a distance, speed, and/or acceleration of the swipe motion), and a swipe motion in a second direction (e.g., opposite of the first direction) (e.g., in a downwards direction relative to the audio output device case 342 as illustrated in FIG. 9G) decreases the volume of the first audio source (e.g., based on magnitude of a distance, speed, and/or acceleration of the swipe motion). As another example, a greater magnitude of the first input (e.g., a further distance of the swipe motion) causes a larger amount of change in the adjustment to the relative volume, and a lesser magnitude of the first input causes a smaller amount of change in the adjustment of the relative volume. As another example, a pressing motion increases or decreases the volume of the first audio source more quickly based on the pressing motion having a higher magnitude (e.g., more force) and more slowly based on the pressing motion having a lower magnitude (e.g., less force). Adjusting relative volumes based on direction and/or magnitude of inputs detected at an audio output device case reduces the number of inputs needed to adjust the volume levels and enables to the adjustment to be performed without displaying additional controls.

In some embodiments, in accordance with a determination that the first input is detected at a first portion (e.g., a portion that includes the music icon 918 as shown in FIG. 9A) of the audio output device case, the first portion of the audio output device case corresponding to the first audio source, the audio output device case adjusts (1320) the volume of the first audio source. For example, a representation of the first audio source is displayed at the first portion of the audio output device case. Adjusting relative volumes based on inputs detected at particular portions of the audio output device case reduces the number of inputs needed to adjust the volume levels and enables to the adjustment to be performed without displaying additional controls.

In some embodiments, in accordance with a determination that the first input is detected at a second portion of the audio output device case that is different from the first portion of the audio output device case, the second portion of the audio output device case corresponding to the second audio source, the audio output device case adjusts (1320) the volume of the second audio source. For example, a representation of the second audio source is displayed at the second portion of the audio output device case. In some embodiments, the audio output device case concurrently displays a representation of a plurality of different active audio sources. In some embodiments, the representations of the active audio sources are displayed on a touch-sensitive surface (e.g., that is part of the audio output device case), and the first input is detected via the touch-sensitive surface. Adjusting relative volumes based on inputs detected at particular portions of the audio output device case reduces the number of inputs needed to adjust the volume levels and enables to the adjustment to be performed without displaying additional controls.

In some embodiments, the audio output device case displays (1322) a first graphic (e.g., music volume element 988 in FIG. 9N) representing the volume of the first audio source and display a second graphic (e.g., ambient volume element 990 in FIG. 9N) representing the volume of the second audio source. In some embodiments, the first and second graphics are displayed concurrently. In some embodiments, the first and/or the second graphic include a dynamic visual element. The first and/or the second graphic can include text (e.g., 50% volume), point light sources (e.g., the point light source moves up or down to represent the current volume level), and/or other content that represents volume information. In some embodiments, the first and second graphics are displayed on a display device of the audio output device case. In some embodiments, the first and second graphics are displayed on separate displays of the audio output device case. In some embodiments, the first graphic is displayed on along a same axis (e.g., are arranged along a horizontal plane or a vertical plane). In some embodiments, a position of the first graphic is based on a relative position of the first audio source to the audio output device case, and/or a position of the second graphic is based on a relative position of the second audio source to the audio output device case. In some embodiments, the first and second graphics are displayed on a display device in communication with the audio output device case. For example, the first and second graphics are displayed at a companion device (e.g., a phone, a wearable device, or other type of companion device) that is in communication with the audio output device case. Displaying graphics corresponding to different audio sources provides improved feedback about a state of the audio output device case and/or the audio output device(s).

In some embodiments, a parameter of the first graphic (e.g., music volume element 988 in FIG. 9N) is based on (1324) the volume of the first audio source and a parameter of the second graphic (e.g., ambient volume element 990 in FIG. 9N) is based on the volume of the second audio source. In some embodiments, the parameter includes a size or a saturation/opacity of the respective graphic. For example, the size of the respective graphic increases in size when the volume is increased. In another example, the opacity of the respective graphic increases (e.g., becomes more opaque) when the volume is increased. In another example, the parameter is a pattern, fill, or dividing line of the first graphic. Displaying graphics with parameters that are based on the corresponding volumes of the audio sources provides improved feedback about a state of the audio output device case and/or the audio output device(s).

In some embodiments, the audio output device case detects (1326) a selection input (e.g., input 950 in FIG. 9E) and in response to detecting the selection input, in accordance with a determination that the selection input is directed to a first set of one or more audio sources, selects the first set of one or more audio sources (e.g., the selected sources indicated by boxes 952-1, 952-2, and 952-3 in FIG. 9F). In some embodiments, the first set of one or more audio sources includes at least one of the first audio source and the second audio source. In some embodiments, detecting the selection input is prior to detecting the first input. Selecting audio sources based on selection inputs at the audio output device case reduces the number of inputs needed to adjust the volume and enables the adjustment to be performed without displaying additional controls.

In some embodiments, the selection input is detected at the audio output device case (e.g., detected via a touch sensor, a capacitive sensor, a force sensor, a mechanical button, and/or other type of input device). In some embodiments, the selection input is detected at a companion device (e.g., a phone, watch, or other type of companion device) that is communicatively coupled to the audio output device case. In some embodiments, the selection input comprises a touch input at a location that corresponds to one or more user interface elements for the first set of one or more audio sources. In some embodiments, the selection input comprises a swipe motion over a portion of the audio output device case on which user interface element(s) for the first set of one or more audio sources are displayed.

In some embodiments, different types of selection inputs cause selection of different audio sources (e.g., different sets of audio sources). For example, a tap input at a first location may cause selection of a first audio source and a tap-and-hold input at the first location may cause selection of a set of audio sources that includes the first audio source and one or more additional audio sources. In some embodiments, a location of the selection input causes selection of a corresponding audio source. For example, a tap input at the first location may cause selection of the first audio source and a tap input at a second location may cause selection of a second audio source.

In some embodiments, one or both of the first audio source and the second audio source are selected as the selected audio source. In some embodiments, which audio sources are selected is based on both a location of the selection input and a type (e.g., gesture type) of the selection input. In some embodiments, respective volumes for all the selected audio sources are adjusted concurrently. For example, the increase may preserve the relative volume of the selected audio sources (e.g., the first audio source starts at 25% and ends at 30%, and the second audio source starts at 50% and ends at 60%). As another example, the increase may add a flat amount of volume level to each of the selected audio sources (e.g., the first audio source starts at 20% and ends at 30%, and the second audio source starts at 70% and ends at 80%). In some embodiments, the first type of selection input comprises a drag input, a press-and-hold input, or other type of input. In some embodiments, the first input only adjusts the volume of the first set of one or more audio sources.

In some embodiments, in response to detecting the selection input (e.g., input 964 in FIG. 9I), in accordance with a determination that the selection input is directed to a second set of one or more audio sources, the audio output device case selects (1328) the second set of the one or more audio sources (e.g., the selected sources indicated by boxes 952-1, 952-2, and 952-4 in FIG. 9J) that is distinct from the first set of the one or more audio sources. In some embodiments, the second set of one or more audio output sources includes at least one of the first audio source and the second audio source. In some embodiments, the first input adjusts a volume of the second set of the one or more audio sources. Selecting audio sources based on selection inputs at the audio output device case reduces the number of inputs needed to adjust the volume and enables the adjustment to be performed without displaying additional controls.

In some embodiments, the selection input is determined to be directed to the second set of one or more audio sources based on a location of the selection input and/or a type of the selection input. For example, the selection input is detected at a location that corresponds to the second set of one or more audio sources. As another example, the selection input has an input type that corresponds to the second set of one or more audio sources (e.g., a tap-and-hold gesture, a swipe gesture, and/or other type of input causes selection of the second set of one or more audio sources). In some embodiments, the first type of selection input corresponds to a first portion of the audio output device case and the second type of selection input corresponds to a second portion of the audio output device case. For example, the same type of gesture detected at different locations corresponds to different selection input types. In some embodiments, the second type of selection input comprises a drag input, a press-and-hold input, or other type of input. In some embodiments, the second set of one or more audio sources includes a same audio source as the first set of one or more audio sources. In some embodiments, the selection of the second set of one or more audio sources causes a deselection of the first set of one or more audio sources. In some embodiments, the selection of the second set of one or more audio sources does not cause deselection of the first set of one or more audio sources (e.g., the first and second sets are concurrently selected).

In some embodiments, determining that the selection input is directed to the second set of one or more audio sources comprises determining (1330) that the selection input is a first type of selection input. In some embodiments, in response to detecting the selection input, in accordance with a determination that the selection input is the second type of selection input, display additional information and/or elements (e.g., interface element 976 in FIG. 9L) associated with a selected set of the one or more audio sources. In some embodiments, the additional elements include one or more audio controls (e.g., playback controls 980 in FIG. 9L). Selecting audio sources based on types of selection inputs at the audio output device case reduces the number of inputs needed to adjust the volume and enables the adjustment to be performed without displaying additional controls.

In some embodiments, the second type of selection input is a long press or a press and hold. In some embodiments, the second type of selection input is at a portion of the audio output device case or a dynamic visual element that represents the audio source. In some embodiments, the additional information includes information such as manufacturer, model, playback state, connection state, and room assignment.

In some embodiments, the audio output device case detects a playback input directed to an audio control of the one or more audio controls and in response to detecting the playback input, adjusts (1332) audio output in accordance with the audio control. For example, the audio control is a playback control and, in response to detecting the playback input, playback of the audio content is toggled (e.g., audio content being played is stopped and audio content that is paused is resumed). As another example, the audio control is a skip control and in response to detecting the playback input, playback of the audio content is skipped to a new position (e.g., skipped forward or skipped backwards). In some embodiments, the audio controls include play/pause, skip forward, skip backward, fast forward, and rewind. Adjusting audio outputs based on playback inputs detected at the audio output device case reduces the number of inputs needed to adjust audio outputs and enables the adjustments to be performed without displaying additional controls.

In some embodiments, the first type of selection input and/or the second type of selection input comprises (1334) a tap input (e.g., input 964 in FIG. 9I) or a swipe input (e.g., input 950 in FIG. 9E). In some embodiments, the tap input and the swipe input are directed to the representation of the audio source. The tap input and the swipe input may change the volume up or down. Configuring the audio output device case to be responsive to different types of inputs reduces the number of inputs needed to perform the audio adjustments and enables the adjustments to be performed without displaying additional displays.

In some embodiments, the audio output device case detects a second input (e.g., input 995 in FIG. 9N) and in response to detecting the second input, adjusts (1336) a magnitude of the ambient sound (see details described previously with respect to adjusting a level of transparency or noise cancellation, as described previously with respect to operation 1130). Adjusting a magnitude of ambient sound in response to inputs detected at the audio output device case improves functionality of the audio output device case and reduces the number of inputs needed to adjust the magnitude of ambient sound.

In some embodiments, the second user input is detected at the audio output device case, one of the one or more audio output devices, or a companion device (e.g., a phone, a watch, or other type of companion device) that is in communication with the audio output device case. In some embodiments, an ambient sound user interface element is displayed (e.g., on a display of the audio output device case, the companion device, or other display device), and the second input is detected at a location that corresponds to the ambient sound user interface element.

It should be understood that the particular order in which the operations in FIGS. 13A-13C have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 1000, 1100, and 1200) are also applicable in an analogous manner to method 1300 described above with respect to FIGS. 13A-13C. For example, the devices, user interfaces, inputs, and functions described above with reference to method 1300 optionally have one or more of the characteristics of the devices, user interfaces, inputs, and functions described herein with reference to other methods described herein (e.g., methods 1000, 1100, and 1200). For brevity, these details are not repeated here.

The operations described above with reference to FIGS. 10A-10B, 11A-11C, 12A-12C, and 13A-13C are, optionally, implemented by components depicted in FIGS. 1A-1B and/or 3A-3I. In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method, comprising:
at an audio output device case that includes a display device:
detecting an occurrence of a first event; and
in response to detecting the occurrence of the first event:
in accordance with a determination that the display device is disabled, causing the display device to be enabled, wherein while the display device is disabled, the display device and an exterior of the audio output device case meet similarity criteria; and
displaying, via a first portion of the display device, a dynamic visual element corresponding to the first event, wherein:
the dynamic visual element changes over time, and
while the display device is enabled, a second portion of the display device, distinct from the first portion of the display device, and the exterior of the audio output device case meet the similarity criteria.

2. The method of claim 1, wherein the display device is positioned behind a portion of the exterior of the audio output device case.

3. The method of claim 1, wherein the display device meets one or more image quality criteria.

4. The method of claim 1, wherein displaying the dynamic visual element includes adjusting a parameter of the dynamic visual element selected from the group consisting of: a shape, a size, a location, and a color.

5. The method of claim 1, wherein the dynamic visual element is displayed on a surface of the exterior of the audio output device case.

6. The method of claim 1, wherein a visual appearance of the dynamic visual element changes by less than a threshold amount across a predefined range of viewing angles for viewing the audio output device case.

7. The method of claim 1, wherein the dynamic visual element is monochromatic.

8. The method of claim 1, wherein the dynamic visual element is non-emissive.

9. The method of claim 1, wherein the dynamic visual element includes text.

10. The method of claim 9, wherein the text is progressively displayed over a first period of time.

11. The method of claim 1, wherein the dynamic visual element includes one or more points of light that move over a second period of time.

12. The method of claim 1, wherein the dynamic visual element includes a reference to one or more real-world entities in an environs of the audio output device case, wherein the one or more real-world entities includes an electronic device and/or a person.

13. The method of claim 12, further comprising providing haptic feedback at the audio output device case in accordance with a determination that the audio output device case is within a threshold distance to one of the one or more real-world entities.

14. The method of claim 12, wherein the one or more real-world entities include one or more entities that are available to communicatively couple with the audio output device case.

15. The method of claim 1, further comprising:
detecting an occurrence of a second event; and
in response to detecting the occurrence of the second event, displaying, via the first portion of the display device, content corresponding to the second event.

16. The method of claim 15, wherein the content includes more colors and/or detail than the dynamic visual element.

17. The method of claim 15, wherein, in response to detecting the occurrence of the second event, the display device adjusts a parameter selected from the group consisting of a color depth, a contrast ratio, and a resolution associated with the display device.

18. The method of claim 15, wherein the content includes a camera preview.

19. The method of claim 18, further comprising:
while the camera preview is displayed, detecting a user input to capture an image associated with the camera preview; and
in response to detecting the user input, capturing the image associated with the camera preview.

20. An audio output device case, comprising:
a display device;
one or more processors; and
memory storing one or more programs, wherein the one or more programs are configured to be executed by the one or more processors, the one or more programs including instructions for:
detecting an occurrence of a first event; and
in response to detecting the occurrence of the first event:
in accordance with a determination that the display device is disabled, causing the display device to be enabled, wherein while the display device is disabled, the display device and an exterior of the audio output device case meet similarity criteria; and
displaying, via a first portion of the display device, a dynamic visual element corresponding to the first event, wherein:
the dynamic visual element changes over time, and
while the display device is enabled, a second portion of the display device, distinct from the first portion of the display device, and the exterior of the audio output device case meet the similarity criteria.

21. A computer-readable storage medium storing one or more programs, the one or more programs comprising instructions that, when executed by an audio output device case that includes a display device, cause the audio output device case to:
detect an occurrence of a first event; and
in response to detecting the occurrence of the first event:
in accordance with a determination that the display device is disabled, cause the display device to be enabled, wherein while the display device is disabled, the display device and an exterior of the audio output device case meet similarity criteria; and
display, via a first portion of the display device, a dynamic visual element corresponding to the first event, wherein:
the dynamic visual element changes over time, and
while the display device is enabled, a second portion of the display device, distinct from the first portion of the display device, and the exterior of the audio output device case meet the similarity criteria.

22-37. (canceled)
